(19) United States
(12) Patent Application Publication
(10) Pub. No.: US 2024/0390769 A1
(43) Pub. Date: Nov. 28, 2024

(54) SKATE

(71) Applicant: BAUER HOCKEY LTD., Blainville (CA)

(72) Inventors: Jean-Francois Corbeil, Prevost (CA); Edouard Rouzier, Montreal (CA); Philippe Jean, Terrebonne (CA); Jason Bird, Ottawa (CA)

(21) Appl. No.: 18/286,907

(22) PCT Filed: Dec. 30, 2022
(86) PCT No.: PCT/CA2022/051907

§ 371 Date: Oct. 13, 2023

Related U.S. Application Data
(60) Provisional application No. 63/297,164, filed on Jan. 6, 2022.
(60) Provisional application No. 63/319,749, filed on Mar. 14, 2022.

(51) Int. Cl. A63C 1/02; A63C 1/30; A63C 1/32; A63C 1/42

(52) U.S. Cl. CPC A63C 1/02; A63C 1/303; A63C 1/32; A63C 1/42

(57) ABSTRACT

A skate for skating on ice, in which a blade holder and/or a blade of the skate may be designed to: improve skating, including speed, power, agility (e.g., turning), and/or other performance aspects of a user while skating, such as by providing enhanced stiffness characteristics of the blade holder (e.g., an improved stiffness profile in a longitudinal direction of the blade holder, better torsional stiffness of the blade holder, etc.); facilitate replacement or other installation and/or removal of the blade (e.g., by allowing toolless installation and removal of the blade from the blade holder while protecting against accidental release of the blade from the blade holder upon the blade holder and/or the blade being impacted in use); enhance retention of the blade by the blade holder; improve an appearance of the blade and/or the blade holder (e.g., at an interface of the blade with the blade holder); and/or otherwise enhance the skate.

### CROSS-REFERENCE TO RELATED APPLICATIONS

This application claims priority from U.S. Provisional Patent Application 63/297,164 filed on Jan. 6, 2022 and U.S. Provisional Patent Application 63/319,749 filed on Mar. 14, 2022, all of which are incorporated by reference herein.

### FIELD

This disclosure generally relates to skates such as for playing hockey and/or other skating activities and, more particularly, to blade holders and blades of such skates.

### BACKGROUND

Skates are used by skaters in various sports such as hockey, roller hockey, etc. and other skating activities.

Ice skates, such as those used to play ice hockey, comprise a skate boot, a blade for engaging ice, and a blade holder disposed between their skate boot and their blade and holding their blade.

A skate's blade holder and/or blade may significantly affect skating, such as speed, power, agility (e.g., turns), and/or other performance aspects of a user while skating. The blade holder and/or blade may also affect ease of use of the skate (e.g., when the blade is to be replaced or otherwise changed). There are often trade-offs and conflicting requirements that are difficult to address in this regard.

For these and/or other reasons, there is a need for improvements directed to skates, including their blade holder and/or blade.

### SUMMARY

In accordance with various aspects of this disclosure, there is provided a skate for skating on ice, in which a blade holder and/or a blade of the skate may be designed to: improve skating, including speed, power, agility (e.g., turning), and/or other performance aspects of a user while skating, such as by providing enhanced stiffness characteristics of the blade holder (e.g., an improved stiffness profile in a longitudinal direction of the blade holder, better torsional stiffness of the blade holder, etc.); facilitate replacement or other installation and/or removal of the blade (e.g., by allowing toolless installation and removal of the blade from the blade holder while protecting against accidental release of the blade from the blade holder upon the blade holder and/or the blade being impacted in use); enhance retention of the blade by the blade holder; improve an appearance of the blade and/or the blade holder (e.g., at an interface of the blade with the blade holder); and/or otherwise enhance the skate.

For example, in accordance with an aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a support extending upwardly from the blade-retaining base. The blade holder comprises a front portion configured to be beneath a forefoot of the user, a rear portion configured to be beneath a hindfoot of the user, and an intermediate portion between the front portion of the blade holder and the rear portion of the blade holder in a longitudinal direction of the blade holder. The blade holder is stiffer in a lateral direction of the blade holder at each of the front portion of the blade holder and the rear portion of the blade holder than at the intermediate portion of the blade holder.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a front pillar and a rear pillar that are spaced from one another in a longitudinal direction of the blade holder and extend upwardly from the blade-retaining base. The blade holder comprises a front portion including the front pillar, a rear portion including the rear pillar, and an intermediate portion between the front portion of the blade holder and the rear portion of the blade holder in the longitudinal direction of the blade holder. The blade holder is stiffer in a lateral direction of the blade holder at each of the front portion of the blade holder and the rear portion of the blade holder than at the intermediate portion of the blade holder.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a front pillar and a rear pillar that are spaced from one another in a longitudinal direction of the blade holder and extend upwardly from the blade-retaining base. The blade holder comprises a front portion including the front pillar, a rear portion including the rear pillar, and an intermediate portion between the front portion of the blade holder and the rear portion of the blade holder in the longitudinal direction of the blade holder. A lateral rigidity of the blade holder varies in the longitudinal direction of the blade holder. The lateral rigidity of the blade holder at the intermediate portion of the blade holder is lower than the lateral rigidity of the blade holder at the front portion of the blade holder and lower than the lateral rigidity of the blade holder at the rear portion of the blade holder.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a front pillar and a rear pillar that are spaced from one another in a longitudinal direction of the blade holder and extend upwardly from the blade-retaining base. The blade holder comprises a front portion including the front pillar, a rear portion including the rear pillar, and an intermediate portion between the front portion of the blade holder and the rear portion of the blade holder in the longitudinal direction of the blade holder. The blade holder is configured such that a lateral rigidity of the blade holder holding the blade varies in the longitudinal direction of the blade holder. The lateral rigidity of the blade holder holding the blade at the intermediate portion of the blade holder holding the blade is lower than the lateral rigidity of the blade holder holding the blade at the front portion of the blade holder holding the blade and lower than the lateral rigidity of the blade holder holding the blade at the rear portion of the blade holder.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a front pillar and a rear pillar that are spaced from one another in a longitudinal direction of the blade holder and extend upwardly from the blade-retaining base. A torsional rigidity of the blade holder holding the blade is at least twice a torsional rigidity of the blade holder without the blade.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a front pillar and a rear pillar that are spaced from one another in a longitudinal direction of the blade holder and extend upwardly from the blade-retaining base. A torsional rigidity of the blade holder without the blade is at least 1 N/mm.

In accordance with another aspect of this disclosure, there is provided a blade holder for a skate for skating on ice, the skate comprising a skate boot configured to receive a foot of a user above the blade holder, the blade holder being configured to hold a blade for engaging the ice, the blade holder comprising: a blade-retaining base configured to retain the blade; and a front pillar and a rear pillar that are spaced from one another in a longitudinal direction of the blade holder and extend upwardly from the blade-retaining base. A torsional rigidity of the blade holder holding the blade is at least 2 N/mm.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a front pillar and a rear pillar that are spaced from one another in a longitudinal direction of the blade holder and extend upwardly from the blade-retaining base. The blade holder comprises a bridge interconnecting the front pillar and the rear pillar. The bridge comprises an upper longitudinal member extending from the front pillar to the rear pillar, a lower longitudinal member extending from the front pillar to the rear pillar, and a cross member extending from the upper longitudinal member of the bridge to the lower longitudinal member of the bridge. The cross member of the bridge is elongated. The blade holder is free of any structure extending from the upper longitudinal member of the bridge to the lower longitudinal member of the bridge between the front pillar and the rear pillar other than the cross member of the bridge.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; a support extending upwardly from the blade-retaining base; and a connection system configured to be manually operated to attach the blade to and detach the blade from the blade holder. The connection system comprises: an actuator manually actuatable to release the blade from the blade holder; and a lock manually movable between a locked position in which the actuator is precluded from releasing the blade from the blade holder and an unlocked position in which the actuator is operable to release the blade from the blade holder.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade, a support extending upwardly from the blade-retaining base; and a connection system comprising a plurality of manual controls configured to be manually operated to attach the blade to and detach the blade from the blade holder.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; a support extending upwardly from the blade-retaining base; and a connection system comprising a plurality of manual controls configured to be manually operated to attach the blade to and detach the blade from the blade holder. Respective ones of the manual controls are configured to be manually moved differently relative to a body of the blade holder.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; a support extending upwardly from the blade-retaining base; and a connection system comprising a plurality of manual controls configured to be manually operated to attach the blade to and detach the blade from the blade holder.

A first one of the manual controls is configured to be manually moved in a first direction relative to a body of the blade holder and a second one of the manual controls is configured to be manually moved in a second direction relative to the body of the blade holder that is transverse to the first direction.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; a support extending upwardly from the blade-retaining base; and a connection system comprising a plurality of manual controls configured to be manually operated to attach the blade to and detach the blade from the blade holder. A first one of the manual controls is configured to be manually translated relative to a body of the blade holder and a second one of the manual controls is configured to be manually rotated relative to the body of the blade holder.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; a support extending upwardly from the blade-retaining base; and a connection system configured to be manually operated to attach the blade to and detach the blade from the blade holder. The connection system is configured to protect against accidental release of the blade from the blade-retaining base when the blade-retaining base is impacted.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; a support extending upwardly from the blade-retaining base; and a connection system configured to be manually operated to attach the blade to and detach the blade from the blade holder. The connection system is configured to prevent accidental release of the blade from the blade-retaining base when the blade-retaining base is impacted.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a support extending upwardly from the blade-retaining base. The blade comprises an interlocking part. The blade-retaining base of the blade holder comprises an interlocking part. The interlocking part of the blade and the interlocking part of the blade-retaining base of the blade holder are configured to interlock when the blade holder holds the blade.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a support extending upwardly from the blade-retaining base. The blade comprises an interlocking part extending from at least one of side surfaces of the blade. The blade-retaining base of the blade holder comprises an interlocking part extending from at least one of internal surfaces of the blade holder that define a blade-receiving slot to receive the blade. The interlocking part of the blade and the interlocking part of the blade-retaining base of the blade holder are configured to interlock when the blade holder holds the blade.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a support extending upwardly from the blade-retaining base. The blade comprises a recess. The blade-retaining base of the blade holder comprises a projection configured to extend into the recess of the blade.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a support extending upwardly from the blade-retaining base. The blade comprises a recess extending laterally from a side surface of the blade. The blade-retaining base of the blade holder comprises a projection configured to extend into the recess of the blade.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a support extending upwardly from the blade-retaining base. The blade comprises a recess extending laterally from a side surface of the blade. The blade-retaining base of the blade holder comprises a projection configured to extend into the recess of the blade and projecting laterally from an internal surface of the blade holder that defines a blade-receiving slot to receive the blade.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a support extending upwardly from the blade-retaining base. The blade comprises a recess extending laterally from a side surface of the blade and extending below a bottom surface of the blade holder when the blade holder holds the blade. The blade-retaining base of the blade holder comprises a projection configured to extend into the recess of the blade.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a support extending upwardly from the blade-retaining base. The blade comprises recesses. The blade-retaining base of the blade holder comprises projections configured to extend into corresponding ones of the recesses of the blade.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a support extending upwardly from the blade-retaining base. The blade comprises recesses extending laterally from at least one of side surfaces of the blade. The blade-retaining base of the blade holder comprises projections configured to extend into corresponding ones of the recesses of the blade.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a support extending upwardly from the blade-retaining base. The blade comprises recesses extending laterally from at least one of side surfaces of the blade. The blade-retaining base of the blade holder comprises projections configured to extend into corresponding ones of the recesses of the blade and projecting laterally from at least one of internal surfaces of the blade holder that define a blade-receiving slot to receive the blade.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a support extending upwardly from the blade-retaining base. The blade comprises recesses extending laterally from at least one of side surfaces of the blade and extending below a bottom surface of the blade holder when the blade holder holds the blade. The blade-retaining base of the blade holder comprises projections configured to extend into corresponding ones of the recesses of the blade.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a support extending upwardly from the blade-retaining base. The blade comprises a recess extending laterally from a side surface of the blade and spaced apart from a top surface of the blade. The blade-retaining base of the blade holder comprises a downward extension extending downwardly from a bottom surface of the blade holder. The blade-receiving base of the blade holder comprises a projection projecting laterally from the downward extension and configured to extend into the recess of the blade.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a support extending upwardly from the blade-retaining base. The blade comprises a visible part. The blade-retaining base comprises a visible part configured to align with the visible part of the blade in at least one of a longitudinal direction of the blade holder and a lateral direction of the blade holder. The visible part of the blade and the visible part of the blade holder are visible when the blade holder holds the blade and is viewed in at least one of the lateral direction of the blade holder and the longitudinal direction of the blade holder.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a support extending upwardly from the blade-retaining base. The blade comprises a plurality of visible elements spaced from one another in a longitudinal direction of the blade. The blade-retaining base comprises a plurality of visible elements spaced from one another in a longitudinal direction of the blade holder and configured to align with corresponding ones of the visible elements of the blade in the longitudinal direction of the blade holder. The visible elements of the blade and the visible elements of the blade holder are visible when the blade holder holds the blade and is viewed in a lateral direction of the blade holder.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a support extending upwardly from the blade-retaining base. The blade comprises an interlocking part; the blade-retaining base comprises an interlocking part configured to interlock with the interlocking part of the blade. The interlocking part of the blade and the interlocking part of the blade holder are visible when the blade holder holds the blade and is viewed in at least one of a lateral direction of the blade holder and a longitudinal direction of the blade holder.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a support extending upwardly from the blade-retaining base. The blade comprises a plurality of interlocking elements spaced from one another in a longitudinal direction of the blade. The blade-retaining base comprises a plurality of interlocking elements spaced from one another in a longitudinal direction of the blade holder and configured to interlock with corresponding ones of the interlocking elements of the blade in the longitudinal direction of the blade holder. The interlocking elements of the blade and the interlocking elements of the blade holder are visible when the blade holder holds the blade and is viewed in a lateral direction of the blade holder.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a support extending upwardly from the blade-retaining base. The blade comprises a recess. The blade-retaining base comprises a projection configured to fit in the recess of the blade. The recess of the blade and the projection of the blade holder are visible when the blade holder holds the blade and is viewed in at least one of a lateral direction of the blade holder and a longitudinal direction of the blade holder.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade holder comprises: a blade-retaining base configured to retain the blade; and a support extending upwardly from the blade-retaining base. The blade comprises a plurality of recesses spaced from one another in a longitudinal direction of the blade. The blade-retaining base comprises a plurality of projections spaced from one another in a longitudinal direction of the blade holder and configured to fit in corresponding ones the recesses of the blade. The recesses of the blade and the projections of the blade holder are visible when the blade holder holds the blade and is viewed in a lateral direction of the blade holder.

In accordance with another aspect of this disclosure, there is provided a blade for a skate for skating on ice. The skate comprises a skate boot configured to receive a foot of a user. The skate comprises a blade holder disposed below the skate boot and configured to hold the blade. The blade holder comprises a projection. The blade comprises: an ice-contacting surface configured to engage the ice; and a void configured to receive the projection of the blade holder.

In accordance with another aspect of this disclosure, there is provided a blade for a skate for skating on ice. The skate comprises a skate boot configured to receive a foot of a user. The skate comprises a blade holder disposed below the skate boot and configured to hold the blade. The blade holder comprises a projection. The blade comprises: an ice-contacting surface configured to engage the ice; side surfaces opposite one another; and a recess extending from a given one of the side surfaces of the blade and configured to receive the projection of the blade holder.

In accordance with another aspect of this disclosure, there is provided a blade for a skate for skating on ice. The skate comprises a skate boot configured to receive a foot of a user. The skate comprises a blade holder disposed below the skate boot and configured to hold the blade. The blade holder comprises projections. The blade comprises: an ice-contacting surface configured to engage the ice; side surfaces opposite one another; and recesses extending from at least one of the side surfaces of the blade and configured to receive corresponding ones of the projections of the blade holder.

In accordance with another aspect of this disclosure, there is provided a blade for a skate for skating on ice. The skate comprises a skate boot configured to receive a foot of a user. The skate comprises a blade holder disposed below the skate boot and configured to hold the blade. The blade holder comprises a projection. The blade comprises: an ice-contacting surface configured to engage the ice; a top surface opposite the ice-contacting surface of the blade; and a recess extending from the top surface of the blade and configured to receive the projection of the blade holder.

In accordance with another aspect of this disclosure, there is provided a blade for a skate for skating on ice. The skate comprises a skate boot configured to receive a foot of a user. The skate comprises a blade holder disposed below the skate boot and configured to hold the blade. The blade holder comprises projections. The blade comprises: an ice-contacting surface configured to engage the ice; a top surface opposite the ice-contacting surface of the blade; and recesses extending from the top surface of the blade and configured to receive corresponding ones of the projections of the blade holder.

In accordance with another aspect of this disclosure, there is provided a blade for a skate for skating on ice. The skate comprises a skate boot configured to receive a foot of a user. The skate comprises a blade holder disposed below the skate boot and configured to hold the blade. The blade comprises: an ice-contacting surface configured to engage the ice; side surfaces opposite one another; and a recess extending from a given one of the side surfaces of the blade.

In accordance with another aspect of this disclosure, there is provided a blade for a skate for skating on ice. The skate comprises a skate boot configured to receive a foot of a user. The skate comprises a blade holder disposed below the skate boot and configured to hold the blade. The blade comprises: an ice-contacting surface configured to engage the ice; side surfaces opposite one another; and recesses extending from respective ones of the side surfaces of the blade.

In accordance with another aspect of this disclosure, there is provided a blade for a skate for skating on ice. The skate comprises a skate boot configured to receive a foot of a user. The skate comprises a blade holder disposed below the skate boot and configured to hold the blade. The blade holder comprises a visible part. The blade comprises: an ice-contacting surface configured to engage the ice; and a visible part configured to align with the visible part of the blade holder in at least one of a longitudinal direction of the blade holder and a lateral direction of the blade holder. The visible part of the blade and the visible part of the blade holder are visible when the blade holder holds the blade and is viewed in at least one of the lateral direction of the blade holder and the longitudinal direction of the blade holder.

In accordance with another aspect of this disclosure, there is provided a blade for a skate for skating on ice. The skate comprises a skate boot configured to receive a foot of a user. The skate comprises a blade holder disposed below the skate boot and configured to hold the blade. The blade holder comprises a plurality of visible elements spaced from one another in a longitudinal direction of the blade holder. The blade comprises: an ice-contacting surface configured to engage the ice; and a plurality of visible elements spaced from one another in a longitudinal direction of the blade and configured to align with corresponding ones of the visible elements of the blade holder in the longitudinal direction of the blade holder. The visible elements of the blade and the visible elements of the blade holder are visible when the blade holder holds the blade and is viewed in a lateral direction of the blade holder.

In accordance with another aspect of this disclosure, there is provided a blade for a skate for skating on ice. The skate comprises a skate boot configured to receive a foot of a user. The skate comprises a blade holder disposed below the skate boot and configured to hold the blade. The blade holder comprises an interlocking part. The blade comprises: an ice-contacting surface configured to engage the ice; and an interlocking part configured to interlock with the interlocking part of the blade holder. The interlocking part of the blade and the interlocking part of the blade holder are visible when the blade holder holds the blade and is viewed in at least one of a lateral direction of the blade holder and a longitudinal direction of the blade holder.

In accordance with another aspect of this disclosure, there is provided a blade for a skate for skating on ice. The skate comprises a skate boot configured to receive a foot of a user. The skate comprises a blade holder disposed below the skate boot and configured to hold the blade. The blade holder comprises a plurality of interlocking elements spaced from one another in a longitudinal direction of the blade holder. The blade comprises: an ice-contacting surface configured to engage the ice; and a plurality of interlocking elements spaced from one another in a longitudinal direction of the blade and configured to interlock with corresponding ones of the interlocking elements of the blade holder in the longitudinal direction of the blade holder. The interlocking elements of the blade and the interlocking elements of the blade holder are visible when the blade holder holds the blade and is viewed in a lateral direction of the blade holder.

In accordance with another aspect of this disclosure, there is provided a blade for a skate for skating on ice. The skate comprises a skate boot configured to receive a foot of a user. The skate comprises a blade holder disposed below the skate boot and configured to hold the blade. The blade holder comprises a projection. The blade comprises: an ice-contacting surface configured to engage the ice; and a recess configured to receive the projection of the blade holder. The recess of the blade and the projection of the blade holder are visible when the blade holder holds the blade and is viewed in at least one of a lateral direction of the blade holder and a longitudinal direction of the blade holder.

In accordance with another aspect of this disclosure, there is provided a blade for a skate for skating on ice. The skate comprises a skate boot configured to receive a foot of a user. The skate comprises a blade holder disposed below the skate boot and configured to hold the blade. The blade holder comprises a plurality of projections. The blade comprises: an ice-contacting surface configured to engage the ice; and a plurality of recesses configured to receive corresponding ones of the projections of the blade holder. The recesses of the blade and the projections of the blade holder are visible when the blade holder holds the blade and is viewed in a lateral direction of the blade holder.

In accordance with another aspect of this disclosure, there is provided a blade for a skate for skating on ice. The skate comprises a skate boot configured to receive a foot of a user. The skate comprises a blade holder disposed below the skate boot and configured to hold the blade. The blade comprises: an ice-contacting surface configured to engage the ice; and a recess that is visible when the blade holder holds the blade and is viewed in at least one of a lateral direction of the blade holder and a longitudinal direction of the blade holder.

In accordance with another aspect of this disclosure, there is provided a blade for a skate for skating on ice. The skate comprises a skate boot configured to receive a foot of a user. The skate comprises a blade holder disposed below the skate boot and configured to hold the blade. The blade comprises: an ice-contacting surface configured to engage the ice; and a plurality of recesses that are visible when the blade holder holds the blade and is viewed in a lateral direction of the blade holder.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade and a support extending upwardly from the blade-retaining base. The blade holder comprises a front portion configured to be beneath a forefoot of the user, a rear portion configured to be beneath a hindfoot of the user, and an intermediate portion between the front portion of the blade holder and the rear portion of the blade holder in a longitudinal direction of the blade holder. The blade holder is stiffer in a lateral direction of the blade holder at each of the front portion of the blade holder and the rear portion of the blade holder than at the intermediate portion of the blade holder.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade and a support extending upwardly from the blade-retaining base. The blade holder comprises a blade-retaining base configured to retain the blade; and a front pillar and a rear pillar that are spaced from one another in a longitudinal direction of the blade holder and extend upwardly from the blade-retaining base. The blade holder comprises a front portion including the front pillar, a rear portion including the rear pillar, and an intermediate portion between the front portion of the blade holder and the rear portion of the blade holder in the longitudinal direction of the blade holder. The blade holder is stiffer in a lateral direction of the blade holder at each of the front portion of the blade holder and the rear portion of the blade holder than at the intermediate portion of the blade holder.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; and a front pillar and a rear pillar that are spaced from one another in a longitudinal direction of the blade holder and extend upwardly from the blade-retaining base. The blade holder comprises a front portion including the front pillar, a rear portion including the rear pillar, and an intermediate portion between the front portion of the blade holder and the rear portion of the blade holder in the longitudinal direction of the blade holder; a lateral rigidity of the blade holder varies in the longitudinal direction of the blade holder. The lateral rigidity of the blade holder at the intermediate portion of the blade holder is lower than the lateral rigidity of the blade holder at the front portion of the blade holder and lower than the lateral rigidity of the blade holder at the rear portion of the blade holder.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; and a front pillar and a rear pillar that are spaced from one another in a longitudinal direction of the blade holder and extend upwardly from the blade-retaining base. The blade holder comprises a front portion including the front pillar, a rear portion including the rear pillar, and an intermediate portion between the front portion of the blade holder and the rear portion of the blade holder in the longitudinal direction of the blade holder. The blade holder is configured such that a lateral rigidity of the blade holder holding the blade varies in the longitudinal direction of the blade holder. The lateral rigidity of the blade holder holding the blade at the intermediate portion of the blade holder holding the blade is lower than the lateral rigidity of the blade holder holding the blade at the front portion of the blade holder holding the blade and lower than the lateral rigidity of the blade holder holding the blade at the rear portion of the blade holder.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; and a front pillar and a rear pillar that are spaced from one another in a longitudinal direction of the blade holder and extend upwardly from the blade-retaining base. A torsional rigidity of the blade holder holding the blade is at least twice a torsional rigidity of the blade holder without the blade.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; and a front pillar and a rear pillar that are spaced from one another in a longitudinal direction of the blade holder and extend upwardly from the blade-retaining base. A torsional rigidity of the blade holder without the blade is at least 1 N/mm.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; and a front pillar and a rear pillar that are spaced from one another in a longitudinal direction of the blade holder and extend upwardly from the blade-retaining base. A torsional rigidity of the blade holder holding the blade is at least 2 N/mm.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; and a front pillar and a rear pillar that are spaced from one another in a longitudinal direction of the blade holder and extend upwardly from the blade-retaining base. The blade holder comprises a bridge interconnecting the front pillar and the rear pillar; the bridge comprises an upper longitudinal member extending from the front pillar to the rear pillar, a lower longitudinal member extending from the front pillar to the rear pillar, and a cross member extending from the upper longitudinal member of the bridge to the lower longitudinal member of the bridge. The cross member of the bridge is elongated. The blade holder is free of any structure extending from the upper longitudinal member of the bridge to the lower longitudinal member of the bridge between the front pillar and the rear pillar other than the cross member of the bridge.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; a support extending upwardly from the blade-retaining base; and a connection system configured to be manually operated to attach the blade to and detach the blade from the blade holder. The connection system comprises: an actuator manually actuatable to release the blade from the blade holder; and a lock manually movable between a locked position in which the actuator is precluded from releasing the blade from the blade holder and an unlocked position in which the actuator is operable to release the blade from the blade holder.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; a support extending upwardly from the blade-retaining base; and a connection system comprising a plurality of manual controls configured to be manually operated to attach the blade to and detach the blade from the blade holder.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; a support extending upwardly from the blade-retaining base; and a connection system comprising a plurality of manual controls configured to be manually operated to attach the blade to and detach the blade from the blade holder. Respective ones of the manual controls are configured to be manually moved differently relative to a body of the blade holder.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; a support extending upwardly from the blade-retaining base; and a connection system comprising a plurality of manual controls configured to be manually operated to attach the blade to and detach the blade from the blade holder A first one of the manual controls is configured to be manually moved in a first direction relative to a body of the blade holder and a second one of the manual controls is configured to be manually moved in a second direction relative to the body of the blade holder that is transverse to the first direction.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; a support extending upwardly from the blade-retaining base; and a connection system comprising a plurality of manual controls configured to be manually operated to attach the blade to and detach the blade from the blade holder. A first one of the manual controls is configured to be manually translated relative to a body of the blade holder and a second one of the manual controls is configured to be manually rotated relative to the body of the blade holder.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; a support extending upwardly from the blade-retaining base; and a connection system configured to be manually operated to attach the blade to and detach the blade from the blade holder. A connection system is configured to protect against accidental release of the blade from the blade-retaining base when the blade-retaining base is impacted.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; a support extending upwardly from the blade-retaining base; and a connection system configured to be manually operated to attach the blade to and detach the blade from the blade holder. The connection system is configured to prevent accidental release of the blade from the blade-retaining base when the blade-retaining base is impacted.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; and a support extending upwardly from the blade-retaining base. The blade comprises a visible part; the blade-retaining base comprises a visible part configured to align with the visible part of the blade in at least one of a longitudinal direction of the blade holder and a lateral direction of the blade holder. The visible part of the blade and the visible part of the blade holder are visible when the blade holder holds the blade and is viewed in at least one of the lateral direction of the blade holder and the longitudinal direction of the blade holder.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; and a support extending upwardly from the blade-retaining base. The blade comprises a plurality of visible elements spaced from one another in a longitudinal direction of the blade. The blade-retaining base comprises a plurality of visible elements spaced from one another in a longitudinal direction of the blade holder and configured to align with corresponding ones of the visible elements of the blade in the longitudinal direction of the blade holder. The visible elements of the blade and the visible elements of the blade holder are visible when the blade holder holds the blade and is viewed in a lateral direction of the blade holder.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; and a support extending upwardly from the blade-retaining base. The blade comprises an interlocking part. The blade-retaining base comprises an interlocking part configured to interlock with the interlocking part of the blade. The interlocking part of the blade and the interlocking part of the blade holder are visible when the blade holder holds the blade and is viewed in at least one of a lateral direction of the blade holder and a longitudinal direction of the blade holder.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; and a support extending upwardly from the blade-retaining base. The blade comprises a plurality of interlocking elements spaced from one another in a longitudinal direction of the blade. The blade-retaining base comprises a plurality of interlocking elements spaced from one another in a longitudinal direction of the blade holder and configured to interlock with corresponding ones of the interlocking elements of the blade in the longitudinal direction of the blade holder. The interlocking elements of the blade and the interlocking elements of the blade holder are visible when the blade holder holds the blade and is viewed in a lateral direction of the blade holder.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; and a support extending upwardly from the blade-retaining base. The blade comprises a recess. The blade-retaining base comprises a projection configured to fit in the recess of the blade. The recess of the blade and the projection of the blade holder are visible when the blade holder holds the blade and is viewed in at least one of a lateral direction of the blade holder and a longitudinal direction of the blade holder.

In accordance with another aspect of this disclosure, there is provided a skate for skating on ice. The skate comprises: a skate boot configured to receive a foot of a user; a blade for engaging the ice; and a blade holder below the skate boot and holding the blade. The blade holder comprises a blade-retaining base configured to retain the blade; and a support extending upwardly from the blade-retaining base. The blade comprises a plurality of recesses spaced from one another in a longitudinal direction of the blade. The blade-retaining base comprises a plurality of projections spaced from one another in a longitudinal direction of the blade holder and configured to fit in corresponding ones the recesses of the blade. The recesses of the blade and the projections of the blade holder are visible when the blade holder holds the blade and is viewed in a lateral direction of the blade holder.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade comprises a connector to connect the blade to the blade holder. The blade holder comprises a blade-retaining base configured to retain the blade, a support extending upwardly from the blade-retaining base, and a connection system configured to be manually operated to attach the blade to and detach the blade from the blade holder and comprising a connector to engage the connector of the blade. The connection system is configured to protect against accidental release of the blade from the blade holder when the blade-retaining base is impacted.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade comprises a connector to connect the blade to the blade holder. The blade holder comprises a blade-retaining base configured to retain the blade, a support extending upwardly from the blade-retaining base, and a connection system configured to be manually operated to attach the blade to and detach the blade from the blade holder and comprising a connector to engage the connector of the blade. The connector of the blade holder is configured to avoid pushing downward on the connector of the blade while the connector of the blade holder moves relative to the blade when the blade-retaining base is impacted.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade comprises a connector to connect the blade to the blade holder. The blade holder comprises a blade-retaining base configured to retain the blade, a support extending upwardly from the blade-retaining base, and a connection system configured to be manually operated to attach the blade to and detach the blade from the blade holder and comprising a connector to engage the connector of the blade. The connector of the blade holder comprises walls that face one another and define a void to receive the connector of the blade. A given one of the walls of the connector of the blade holder remains spaced from the connector of the blade while the connector of the blade holder moves relative to the blade when the blade-retaining base is impacted.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade comprises a connector to connect the blade to the blade holder. The blade holder comprises a blade-retaining base configured to retain the blade, a support extending upwardly from the blade-retaining base, and a connection system configured to be manually operated to attach the blade to and detach the blade from the blade holder and comprising a connector to engage the connector of the blade. The connector of the blade holder is configured to exert an upward force on the connector of the blade while the connector of the blade holder moves relative to the blade toward a front end of the blade holder when the blade-retaining base is impacted.

In accordance with another aspect of this disclosure, there is provided a skate for skating on ice. The skate comprises a skate boot configured to receive a foot of a user, a blade for engaging the ice, and a blade holder below the skate boot and holding the blade. The blade comprises a connector to connect the blade to the blade holder. The blade holder comprises a blade-retaining base configured to retain the blade, a support extending upwardly from the blade-retaining base, and a connection system configured to be manually operated to attach the blade to and detach the blade from the blade holder and comprising a connector to engage the connector of the blade. The connection system is configured to protect against accidental release of the blade from the blade holder when the blade-retaining base is impacted.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade comprises a connector to connect the blade to the blade holder. The blade holder comprises a blade-retaining base configured to retain the blade, a support extending upwardly from the blade-retaining base, and a connection system configured to be manually operated to attach the blade to and detach the blade from the blade holder and comprising a connector to engage the connector of the blade. The connector of the blade holder is configured to exert an upward force on the connector of the blade while the connector of the blade holder moves relative to the blade toward a front end of the blade holder when the blade-retaining base is impacted.

In accordance with another aspect of this disclosure, there is provided a skate for skating on ice. The skate comprises a skate boot configured to receive a foot of a user, a blade for engaging the ice, and a blade holder below the skate boot and holding the blade. The blade comprises a connector to connect the blade to the blade holder.

The blade holder comprises a blade-retaining base configured to retain the blade, a support extending upwardly from the blade-retaining base, and a connection system configured to be manually operated to attach the blade to and detach the blade from the blade holder and comprising a connector to engage the connector of the blade. The connector of the blade holder is configured to avoid pushing downward on the connector of the blade while the connector of the blade holder moves relative to the blade when the blade-retaining base is impacted.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade comprises a connector to connect the blade to the blade holder. The blade holder comprises a blade-retaining base configured to retain the blade, a support extending upwardly from the blade-retaining base, and a connection system configured to be manually operated to attach the blade to and detach the blade from the blade holder and comprising a connector to engage the connector of the blade. The connector of the blade holder is configured to exert an upward force on the connector of the blade while the connector of the blade holder moves relative to the blade toward a front end of the blade holder when the blade-retaining base is impacted.

In accordance with another aspect of this disclosure, there is provided a skate for skating on ice. The skate comprises a skate boot configured to receive a foot of a user, a blade for engaging the ice, and a blade holder below the skate boot and holding the blade. The blade comprises a connector to connect the blade to the blade holder. The blade holder comprises a blade-retaining base configured to retain the blade, a support extending upwardly from the blade-retaining base, and a connection system configured to be manually operated to attach the blade to and detach the blade from the blade holder and comprising a connector to engage the connector of the blade. The connector of the blade holder comprises walls that face one another and define a void to receive the connector of the blade. A given one of the walls of the connector of the blade holder remains spaced from the connector of the blade while the connector of the blade holder moves relative to the blade when the blade-retaining base is impacted.

In accordance with another aspect of this disclosure, there is provided a blade holder for a skate for skating on ice. The skate comprises a skate boot configured to receive a foot of a user above the blade holder. The blade holder is configured to hold a blade for engaging the ice. The blade comprises a connector to connect the blade to the blade holder. The blade holder comprises a blade-retaining base configured to retain the blade, a support extending upwardly from the blade-retaining base, and a connection system configured to be manually operated to attach the blade to and detach the blade from the blade holder and comprising a connector to engage the connector of the blade. The connector of the blade holder is configured to exert an upward force on the connector of the blade while the connector of the blade holder moves relative to the blade toward a front end of the blade holder when the blade-retaining base is impacted.

In accordance with another aspect of this disclosure, there is provided a skate for skating on ice. The skate comprises a skate boot configured to receive a foot of a user, a blade for engaging the ice, and a blade holder below the skate boot and holding the blade. The blade comprises a connector to connect the blade to the blade holder. The blade holder comprises a blade-retaining base configured to retain the blade, a support extending upwardly from the blade-retaining base, and a connection system configured to be manually operated to attach the blade to and detach the blade from the blade holder and comprising a connector to engage the connector of the blade. The connector of the blade holder is configured to exert an upward force on the connector of the blade while the connector of the blade holder moves relative to the blade toward a front end of the blade holder when the blade-retaining base is impacted.

These and other aspects of this disclosure will now become apparent to those of ordinary skill in the art upon review of a description of embodiments that follows in conjunction with accompanying drawings.

### BRIEF DESCRIPTION OF DRAWINGS

A detailed description of embodiments is provided below, by way of example only, with reference to drawings annexed hereto, in which:

FIG. 1 is an embodiment of a skate for a user;

FIG. 2 is an exploded view of the skate;

FIGS. 3 to 6 are various views of a shell of a skate boot of the skate;

FIG. 7 is a side view of the skate boot, a blade holder and a blade of the skate;

FIG. 8 shows an embodiment wherein at least part of the skate boot is injection-molded;

FIG. 9 is a perspective view of a tongue of the skate boot;

FIG. 10 is a side view of the blade;

FIG. 11 is a front view of the blade in a blade-receiving slot of the blade holder;

FIGS. 12 and 13 are bottom views of the blade-receiving slot of the blade holder without the blade and with the blade, respectively;

FIGS. 14 to 16 are a side view, a top view and a front view of the blade holder;

FIGS. 17A and 17B show tests for measuring lateral rigidity;

FIGS. 17C and 17D show measurements of lateral rigidity at different locations of the blade holder or the blade holder holding the blade measured using tests of FIGS. 17A and 17B;

FIG. 18A shows another test for measuring lateral rigidity;

FIG. 18B shows measurements of lateral rigidity at different locations of the blade holder holding the blade measured using the test of FIG. 18A;

FIG. 18C shows measurements of lateral rigidity at different locations of a variant of the blade holder holding the blade measured using the test of FIG. 18A;

FIG. 19A shows a test for measuring heightwise rigidity;

FIG. 19B shows measurements of heightwise rigidity at different locations of the blade holder;

FIG. 20 shows a test for measuring a torsional rigidity of the blade holder;

FIG. 21 shows measurements of torsional rigidity of the blade holder with and without the blade;

FIGS. 22 to 24 show an embodiment of a connection system to attach the blade to and detach the blade from the blade holder of the skate;

FIGS. 25 and 26 show a cross-section of part of the connection system of the blade holder in a locked position and in an unlocked position, respectively;

FIGS. 27 to 37 show variants of the connection system;

FIGS. 38 and 39 show an embodiment of the blade holder and the blade comprising visible interlocking elements;

FIGS. 40 to 42 show other variants of the blade holder and the blade;

FIG. 43 shows a variant of the blade holder and the blade wherein the blade holder comprises a single visible interlocking element and the blade comprises a corresponding interlocking element;

FIG. 44 shows a variant of the blade holder and the blade wherein the blade holder comprises at least two different interlocking elements and the blade comprises at least two different interlocking elements;

FIGS. 45 to 47 show another variant of the blade holder and the blade wherein the blade comprises an interlocking part and the blade holder comprises an interlocking part configured to align with the interlocking part of the blade in a lateral direction of the blade holder;

FIGS. 48A to 54 show other variants of the blade holder and the blade wherein the interlocking elements of the blade comprise recesses having a width less than a thickness of the blade;

FIG. 55 shows another variant of the blade holder and the blade wherein the blade holder comprises an electronic control mechanism;

FIGS. 56 to 60 show variants of the blade holder with a portion that is integrally formed with a body of the skate boot;

FIGS. 61 to 65 show examples of a lattice;

FIGS. 66 to 69 show variants of attachment of the blade to the blade holder;

FIGS. 70 to 78 show other embodiments of the blade holder and the blade;

FIGS. 79 to 81 show other embodiments of the blade holder and the blade; and

FIGS. 82 and 83 are side and front views of a right foot of the user with an integument of the foot shown in dotted lines and bones shown in solid lines.

In the drawings, embodiments are illustrated by way of example. It is to be expressly understood that the description and drawings are only for purposes of illustration and as an aid to understanding and are not intended to be and should not be limitative.

### DETAILED DESCRIPTION OF EMBODIMENTS

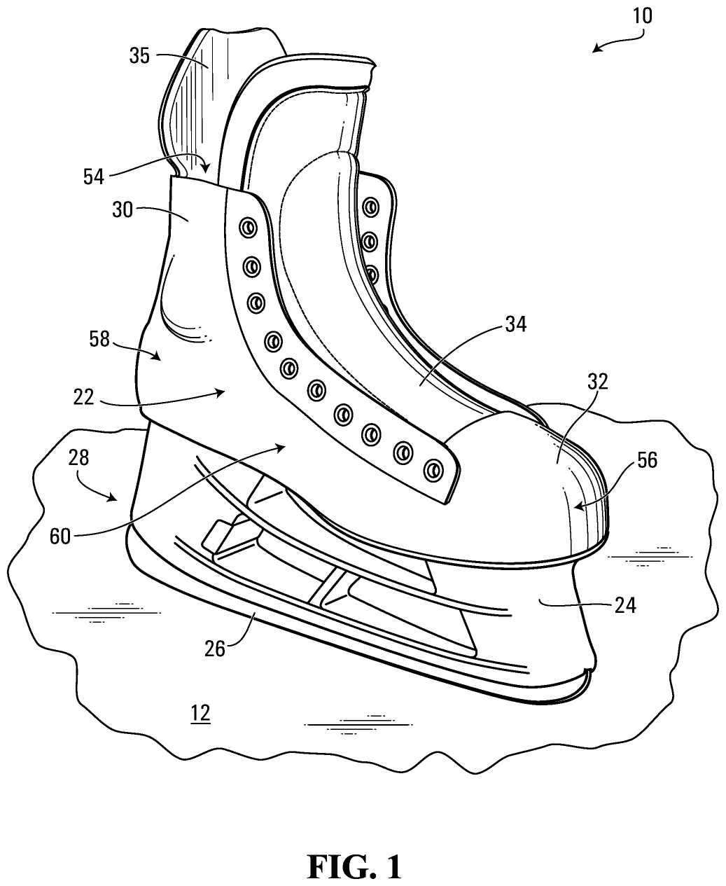

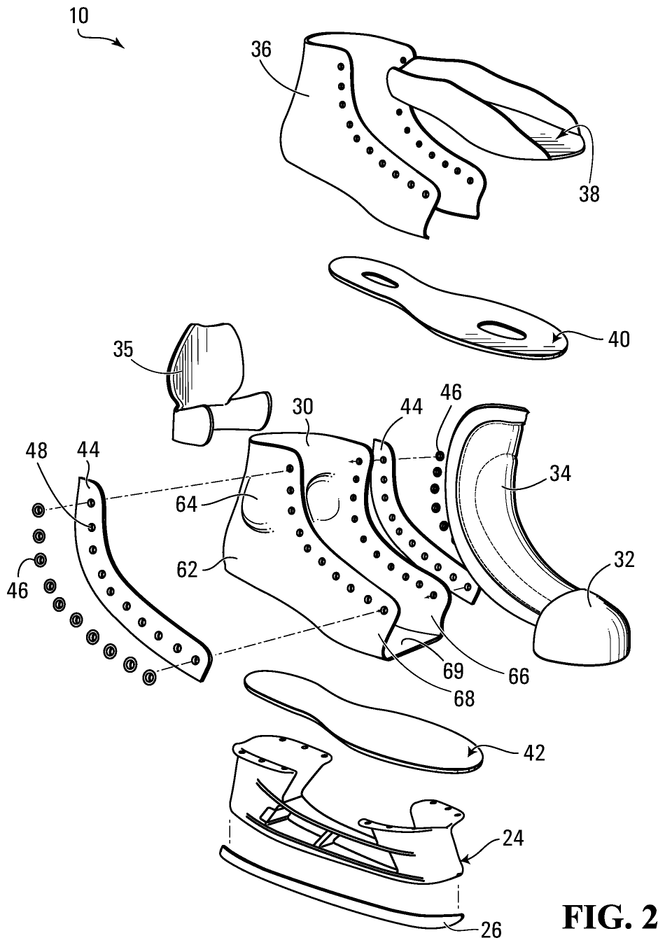

FIGS. 1 and 2 show an embodiment of a skate 10 for a user to skate on ice 12. In this embodiment, the skate 10 is a hockey skate for the user who is a hockey user playing hockey on the ice 12. The skate 10 comprises a skate boot 22 for receiving a foot 11 of the user, a blade 26 for contacting the ice 12, and a blade holder 24 between the skate boot 22 and the blade 26 for holding the blade 26. The skate 10 has a longitudinal direction, a lateral (i.e., widthwise) direction, and a heightwise direction, so that each of the skate boot 22, the blade 26, and the blade holder 24 similarly has a longitudinal direction, a lateral direction, and a heightwise direction.

In this embodiment, as further discussed below, the blade holder 24 and/or the blade 26 may be designed to: improve skating, including speed, power, agility (e.g., turning), and/or other performance aspects of the user while skating, such as by providing enhanced stiffness characteristics of the blade holder 24 (e.g., an improved stiffness profile in the longitudinal direction of the blade holder 24, better torsional stiffness of the blade holder 24, etc.); facilitate replacement or other installation and/or removal of the blade 26 (e.g., by allowing toolless installation and removal of the blade 26 from the blade holder 24 while protecting against accidental release of the blade 26 from the blade holder 24 upon the blade holder 24 and/or the blade 26 being impacted in use); enhance retention of the blade 26 by the blade holder 24; improve an appearance of the blade 26 and/or the blade holder 24 (e.g., at an interface of the blade 26 with the blade holder 24); and/or otherwise enhance the skate 10.

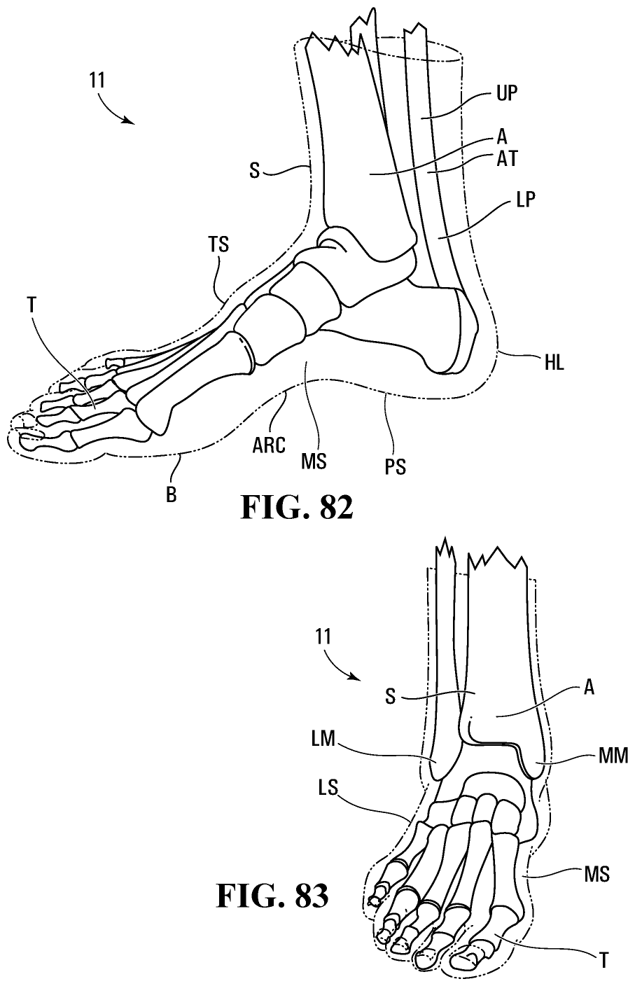

The skate boot 22 includes a cavity 54 for receiving the user's foot 11. With additional reference to FIGS. 82 and 83, the user's foot 11 includes toes T, a ball B, an arch ARC, a plantar surface PS, a top surface TS, a medial side MS, and a lateral side LS. The top surface TS of the user's foot 11 is continuous with a lower portion of a shin S of the user. In addition, the user has a heel HL, an Achilles tendon AT, and an ankle A having a medial malleolus MM and a lateral malleolus LM that is at a lower position than the medial malleolus MM. The Achilles tendon AT has an upper part UP and a lower part LP projecting outwardly with relation to the upper part UP and merging with the heel HL. A forefoot of the user includes the toes T and the ball B, a hindfoot of the user includes the heel HL, and a midfoot of the user is between the forefoot and the hindfoot.

The skate boot 22 comprises a front portion 56 for receiving the toes T of the user, a rear portion 58 for receiving the heel HL and at least part of the Achilles tendon AT and the ankle A of the user, and an intermediate portion 60 between the front portion 56 and the rear portion 58.

More particularly, in this embodiment, the skate boot 22 comprises a body 30, a toe cap 32, a tongue 34, a tendon guard 35, a liner 36, a footbed 38, and an insole 40. The skate boot 22 also comprises lace members 44 (sometimes referred to as “facings”) and eyelets 46 extending through (e.g., punched into) the lace members 44, the body 30 and the liner 36 vis-à-vis apertures 48 in order to receive a lace for tying the skate 10. In some embodiments, the skate boot 22 may not comprise any lace members and the eyelets 46 may extend directly through the body 30 and the liner 36 via the apertures 48.

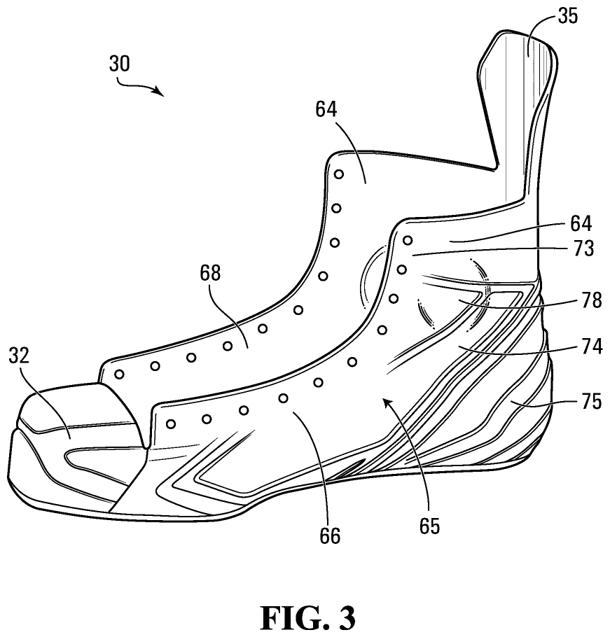

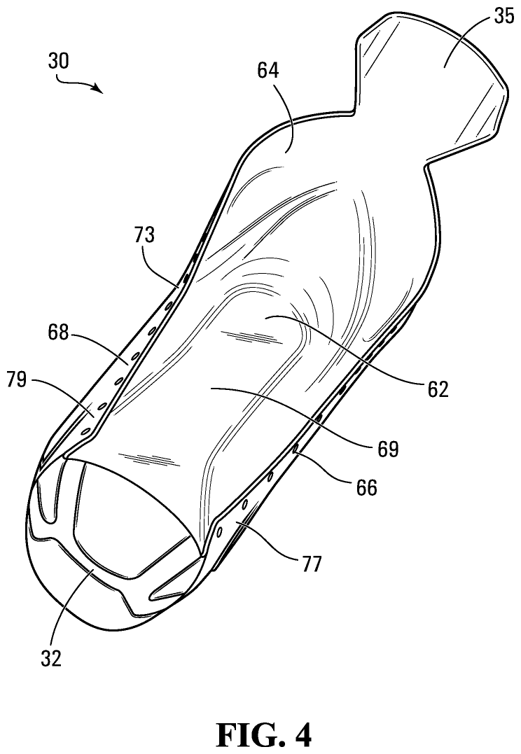

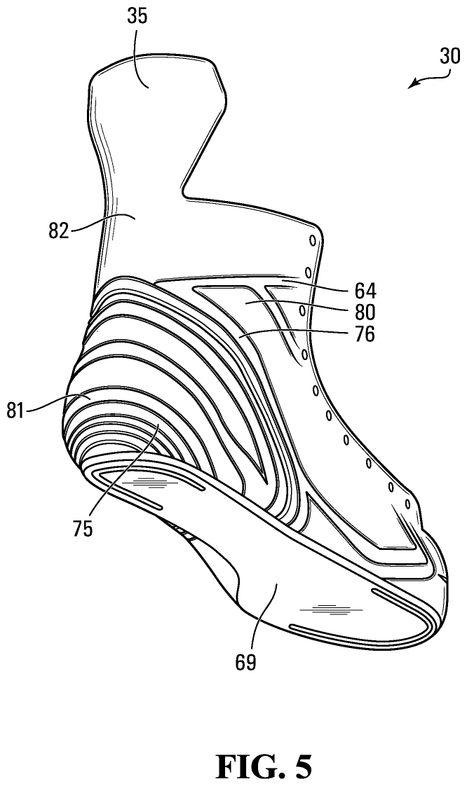

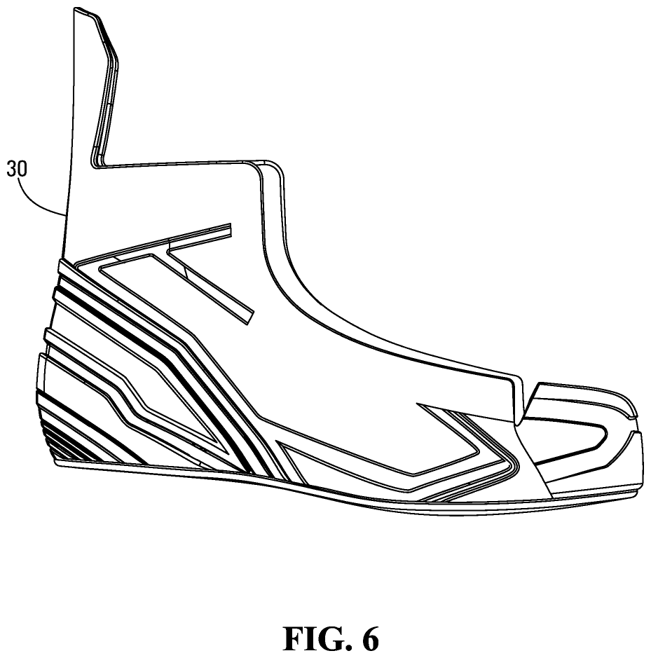

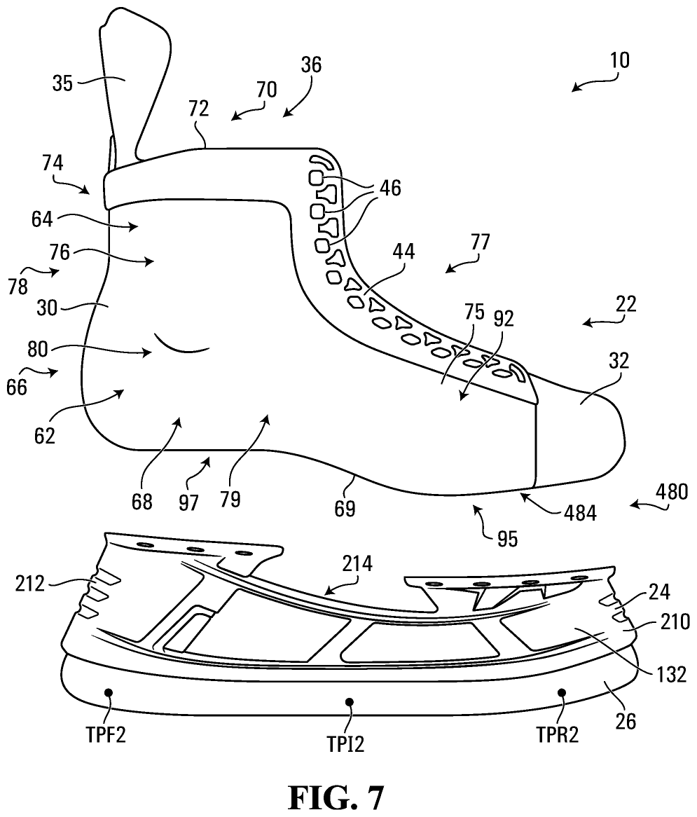

The body 30 of the skate boot 22 imparts strength and structural integrity to the skate 10 to support the user's foot 11. More particularly, in this embodiment, as shown in FIGS. 3 to 6, the body 30 of the skate boot 22, which will be referred to as a “shell”, comprises a heel portion 62 for receiving the heel HL of the user, an ankle portion 64 for receiving the ankle A of the user, medial and lateral side portions 66, 68 for respectively facing the medial and lateral sides MS, LS of the user's foot 11, and a sole portion 69 for facing the plantar surface PS of the user's foot 11. The shell 30 thus includes a quarter 75 which comprises a medial quarter part 77, a lateral quarter part 79, and a heel counter 81. The medial and lateral side portions 66, 68 include upper edges 70, 72 which, in this embodiment, constitute upper edges of the lace members 44. The heel portion 62 may be formed such that it is substantially cup-shaped for following the contour of the heel HL of the user. The ankle portion 64 comprises medial and lateral ankle sides 74, 76. The medial ankle side 74 has a medial depression 78 for receiving the medial malleolus MM of the user and the lateral ankle side 76 has a lateral depression 80 for receiving the lateral malleolus LM of the user. The lateral depression 80 is located slightly lower than the medial depression 78 for conforming to the morphology of the user's foot 11. The ankle portion 64 further comprises a rear portion 82 facing the lower part LP of the Achilles tendon AT of the user.

The shell 30 comprises a synthetic material 92 that makes up at least a substantial part (i.e., a substantial part or an entirety) of the shell 30. In this embodiment, the synthetic material 92 is a polymeric material. For example, in some embodiments, the polymeric material 92 may include polyurethane, polypropylene, or any other suitable polymer. In some cases, the polymeric material 92 may be a foam. For instance, in some cases, the polymeric material 92 may include a polyurethane foam, an ethylene-vinyl acetate (EVA) foam, or any other suitable foam. The polymeric material 92 may include any other suitable polymer in other embodiments (e.g., nylon, polyester, vinyl, polyvinyl chloride, an ionomer resin (e.g., Surlyn®), styrene-butadiene copolymer (e.g., K-Resin®) etc.). In some examples of implementation, the polymeric material 92 may be a polymer-matrix composite material (e.g., in which fibers are embedded in a polymer matrix). For instance, in some embodiments, the polymeric material 92 may comprise a self-reinforced polymer composite, such as self-reinforced polypropylene composite (e.g., Curv®). The synthetic material 92 may be implemented in any other suitable way in other embodiments (e.g., other types of polymers, other types of composite material, etc.).

In this embodiment, the synthetic material 92 of the shell 30 is molded material. That is, the synthetic material 92 of the shell 30 is formed by a molding process in a mold. A shape of the synthetic material 92 of the shell 30 is thus a molded shape imparted during the molding process.

For example, in some embodiments, the synthetic material 92 of the shell 30 may be thermoformed material. For instance, a sheet of the synthetic material 92 may be heated (e.g., in an oven) until it reaches a pliable forming temperature. The sheet of synthetic material 92 is then formed via a mold to have a shape of the shell 30.

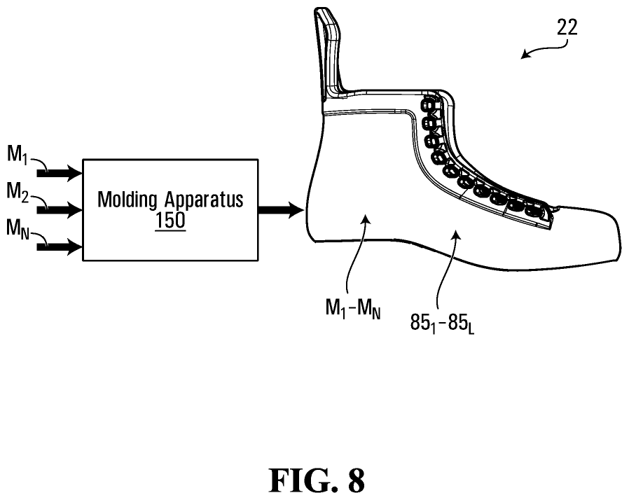

In other embodiments, the synthetic material 92 of the shell 30 may be molded in any other suitable way. For instance, the synthetic material 92 of shell 30 may be molded into the shape of the shell 30 by flowing in a molding apparatus during a molding process (e.g., injection molding). For example, as shown in FIG. 8, in some embodiments, the shell 30 may comprise a plurality of materials M₁-M_{N}, which includes the synthetic material 92, that are molded into the shape of the shell 30 by flowing in a molding apparatus during a molding process. The materials M₁-M_{N} are different from one another, such as by having different chemistries and/or exhibiting substantially different values of one or more material properties (e.g., density, modulus of elasticity, hardness, etc.). In this example, the materials M₁-M_{N} are arranged such that the shell 30 comprises a plurality of layers 851-85L which are made of respective ones of the materials M₁-M_{N}. This may allow the skate 10 to have useful performance characteristics (e.g., reduced weight, proper fit and comfort, etc.) while being more cost-effectively manufactured. For instance, in some embodiments, the shell 30 and/or other parts of the skate boot 22 and/or at least part of the blade holder 24 may be implemented as described in U.S. Provisional Patent Applications 63/031,259 and 62/816,465, U.S. patent application Ser. No. 17/289,851 and International Patent Applications PCT/CA2021/050727 and PCT/CA2019/051531, which are incorporated by reference herein.

The liner 36 of the skate boot 22 is affixed to an inner surface of the shell 30 and comprises an inner surface 96 for facing the heel HL and medial and lateral sides MS, LS of the user's foot 11 and ankle A in use. For instance, the liner 36 may be made of a soft material (e.g., a fabric made of NYLON® fibers or any other suitable fabric). The footbed 38 is mounted inside the shell 30 and comprises an upper surface 106 for receiving the plantar surface PS of the user's foot 11 and a wall 108 projecting upwardly from the upper surface 106 to partially cup the heel HL and extend up to a medial line of the user's foot 11. The insole 40 has an upper surface 25 for facing the plantar surface PS of the user's foot 11 and a lower surface 23 on which the shell 30 may be affixed.

The toe cap 32 of the skate boot 22 is configured to face and protect the toes T of the user's foot 11. In some embodiments, the toe cap 32 may be manufactured separately from and fastened to the shell 30. In other embodiments, at least part (i.e., part or all) of the toe cap 32 may be formed integrally with the shell 30 and can thus be referred to as a toe portion of the shell 30.

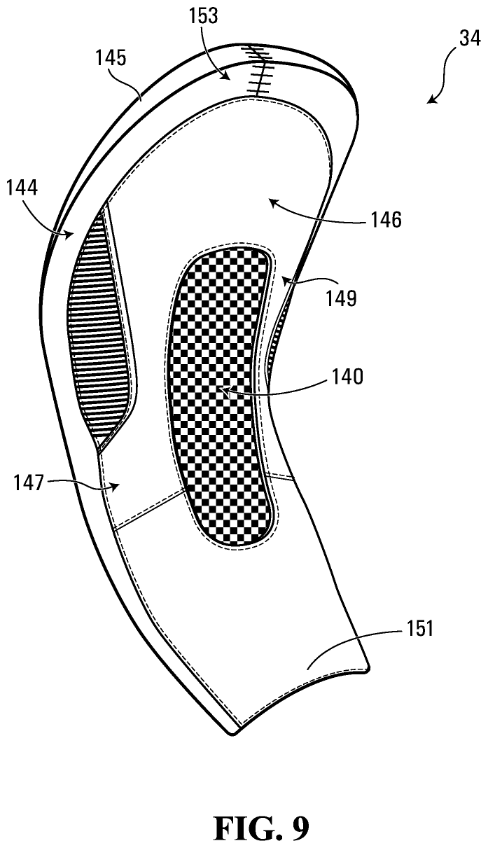

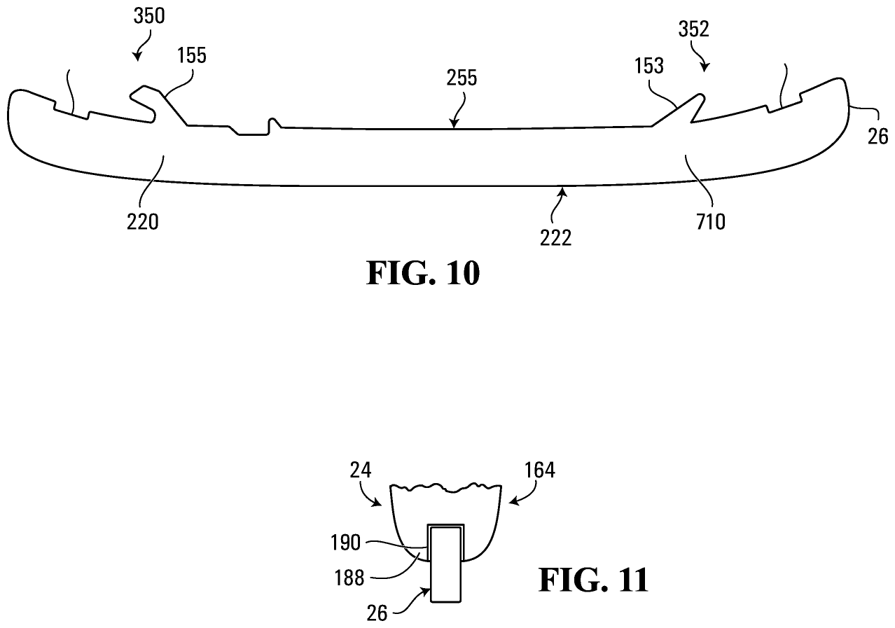

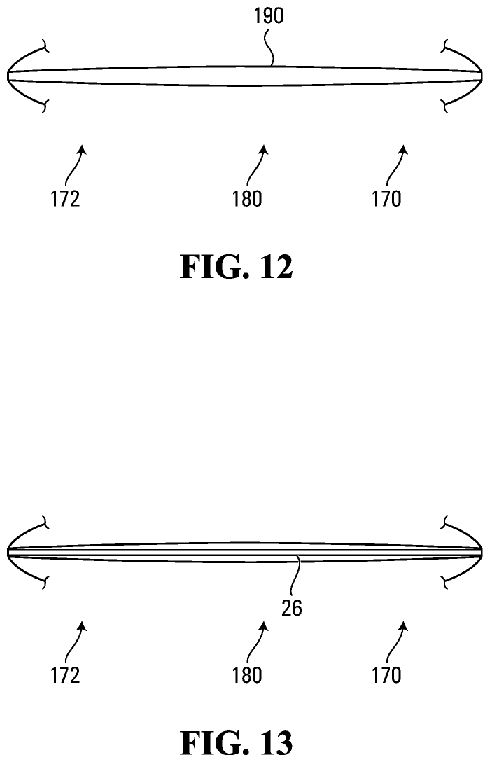

The tongue 34 extends upwardly and rearwardly from the toe cap 32 for overlapping the top surface TS of the user's foot 11. In this embodiment, as shown in FIG. 9, the tongue 34 comprises a core 140 defining a section of the tongue 34 with increased rigidity, a padding member (not shown) for absorbing impacts to the tongue 34, a peripheral member 144 for at least partially defining a periphery 145 of the tongue 34, and a cover member 146 configured to at least partially define a front surface of the tongue 34. The tongue 34 defines a lateral portion 147 overlying a lateral portion of the user's foot 11 and a medial portion 149 overlying a medial portion of the user's foot 11. The tongue 34 also defines a distal end portion 151 for affixing to the toe cap 32 (e.g., via stitching) and a proximal end portion 153 that is nearest to the user's shin S.

The tendon guard 35 extends upwardly from the rear portion 82 of the ankle portion 64 of the shell 30 in order to protect the user's Achilles tendon AT. In some embodiments, the tendon guard 35 may be a separate component from the shell 30 such that the tendon guard 35 is fastened to the shell 30 via a mechanical fastener (e.g., via stitching, stapling, a screw, etc.) or in any other suitable way. In other embodiments, at least part (i.e., part or all) of the tendon guard 35 may be integrally formed with the shell 30 of the skate boot 22.

The skate boot 22 may be constructed in any other suitable way in other embodiments. For example, in other embodiments, various components of the skate boot 22 mentioned above may be configured differently or omitted and/or the skate boot 22 may comprise any other components that may be made of any other suitable materials and/or using any other suitable processes.

The blade 26 comprises an ice-contacting material 220 including an ice-contacting surface 222 for sliding on the ice 12 while the user skates. In this embodiment, the ice-contacting material 220 is a metallic material (e.g., stainless steel). The ice-contacting material 220 may be any other suitable material in other embodiments. The blade 26 also comprises a top surface 262 opposite to the ice-contacting surface 222 and spaced therefrom in a heightwise direction of the blade 26, and side surfaces 264, 266 that are opposite one another and spaced apart in a thickness-wise direction of the blade 26.

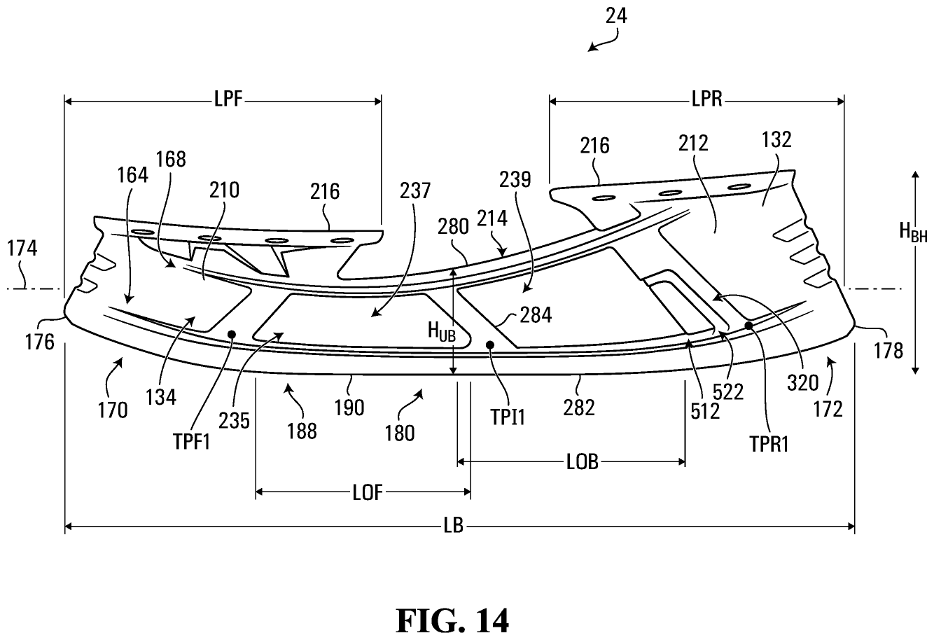

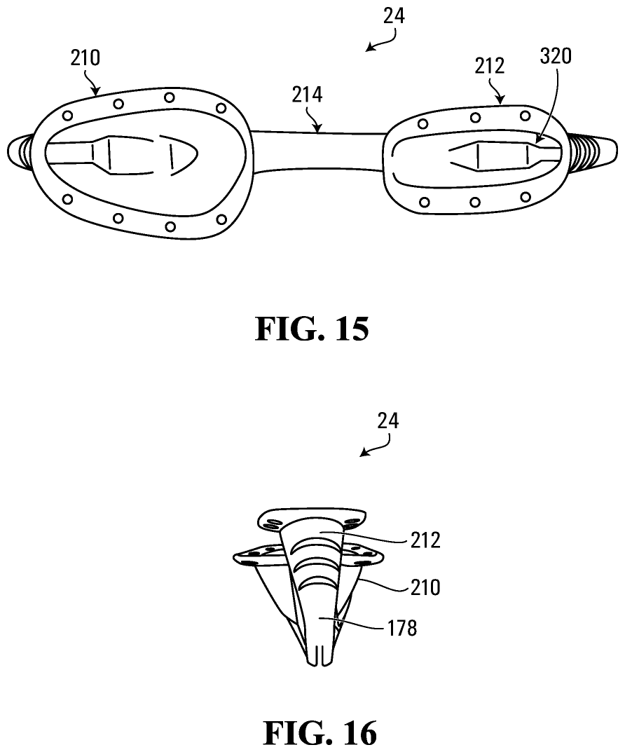

The blade holder 24 is configured to hold the blade 26 and transfer forces exerted by the user's foot 11 in the skate boot 22 towards the blade 26 and the ice 12. In this embodiment, with additional reference to FIGS. 14 to 16, the blade holder 24 comprises a body 132 including a lower portion 162 comprising a blade-retaining base 164 that retains the blade 26 and an upper portion 166 comprising a support 168 that extends upwardly from the blade-retaining base 164 towards the skate boot 22 to interconnect the blade holder 24 and the skate boot 22. A front portion 170 of the blade holder 24 and a rear portion 172 of the blade holder 24 define a longitudinal axis 174 of the blade holder 24. The front portion 170 of the blade holder 24 includes a frontmost point 176 of the blade holder 24 and extends beneath and along the user's forefoot in use, while the rear portion 172 of the blade holder 24 includes a rearmost point 178 of the blade holder 24 and extends beneath and along the user's hindfoot in use. An intermediate portion 180 of the blade holder 24 is located between the front and rear portions 170, 172 of the blade holder 24 and extends beneath and along the user's midfoot in use. The blade holder 24 comprises a medial side 182 and a lateral side 184 that are opposite one another.

The blade-retaining base 164 of the blade holder 24 is elongated in the longitudinal direction of the blade holder 24 and is configured to retain the blade 26 such that the blade 26 extends along a bottom portion 186 of the blade-retaining base 164 to contact the ice 12. To that end, the blade-retaining base 164 comprises a blade-retention portion 188 to face and retain the blade 26. In this embodiment, the blade-retention portion 188 comprises a recess 190, which can be referred to as a “blade-receiving slot”, extending from the front portion 170 to the rear portion 172 of the blade holder 24 in which an upper portion of the blade 26 is disposed. The blade-retaining base 164 comprises a bottom surface 242 of the blade holder 24 and internal surfaces 244 defining the blade-receiving slot 190. The blade-retaining base 164 may be configured in any other suitable way in other embodiments.

In this embodiment, the blade-receiving slot 190 may be wider in the intermediate portion 180 of the blade-retaining base 164 than in the front portion 170 of the blade-retaining base 164 and in the rear portion 172 of the blade-retaining base 164. For instance, in this embodiment, the blade-receiving slot 190 may be wider between a front pillar 210 and a rear pillar 212 than beneath the front pillar 210 and beneath the rear pillar 212. In some examples, this configuration of the blade-receiving slot 190 may allow the blade 26 to bend laterally when the user turns on the ice 12, providing a circular, parabolic or other curved feature to the blade 26 and facilitating turns of the user.

The support 168 of the blade holder 24 is configured for supporting the skate boot 22 above the blade-retaining base 164 and transmit forces to and from the blade-retaining base 164 during skating. In this embodiment, the support 168 comprises a front pillar 210 and a rear pillar 212 which are spaced from one another in the longitudinal direction of the blade holder 24 and extend upwardly from the blade-retaining base 164 respectively towards a front sole part 95 and a rear sole part 97 of the skate boot 22. The front pillar 210, which can be referred to as a front “pedestal” or “post”, extends towards the front portion 56 of the skate boot 22 and the rear pillar 212, which can be referred to as a rear “pedestal” or “post”, extends towards the rear portion 58 of the skate boot 22. The front portion 170 of the blade holder 24 includes the front pillar 210, and the rear portion 172 of the blade holder 24 includes the rear pillar 212. The blade-retaining base 164 extends from the front pillar 210 to the rear pillar 212.

In this embodiment, the blade holder 24 comprises a bridge 214 interconnecting the front pillar 210 and the rear pillar 212. The intermediate portion 180 of the blade holder 24 includes at least part of the bridge 214. More particularly, in this embodiment, the bridge 214 comprise an upper longitudinal member 280 extending from the front pillar 210 to the rear pillar 212, a lower longitudinal member 282 extending from the front pillar 210 to the rear pillar 212, and a cross member 284 extending from the upper longitudinal member 280 to the lower longitudinal member 282. In this example, the blade-retaining base 164 includes the lower longitudinal member 282. The bridge 214 comprises a void 235 between the upper longitudinal member 280 and the lower longitudinal member 282. In this example, the void 235 includes openings 237, 239 spaced apart by the cross member 284.

More specifically, in this embodiment, the cross member 284 of the bridge 214 is elongated. In this example, the cross member 284 of the bridge 214 is elongated and inclined relative to the upper and lower longitudinal members 280, 282 of the bridge 214, so that it extends obliquely to the upper and lower longitudinal members 280, 282 of the bridge 214. In this case, the cross member 284 of the bridge 214 extends downwardly and rearwardly from the upper longitudinal member 280 of the bridge 214 to the lower longitudinal member 282 of the bridge 214.

Also, in this embodiment, the cross member 284 of the bridge 214 is a sole structure extending from the upper longitudinal member 280 of the bridge 214 to the lower longitudinal member 282 of the bridge 214 between the front and rear pillars 210, 212. That is, the blade holder 24 is free of (i.e., is without) any structure extending from the upper longitudinal member 280 of the bridge 214 to the lower longitudinal member 282 of the bridge 214 between the front and rear pillars 210, 212 other than the cross member 284 of the bridge 214. The opening 237 thus extends from the front pillar 210 to the cross member 284 of the bridge 214, while the opening 239 extends from the rear pillar 212 to the cross member 284 of the bridge 214.

In this embodiment, dimensions LPF, LPR of the front and rear pillars 210, 212 in the longitudinal direction of the blade holder 24 may be relatively large. For instance, in this embodiment, a sum of the dimension LPF of the front pillar 210 and the dimension LPR of the rear pillar 212 in the longitudinal direction of the blade holder 24 may correspond to a majority of a length LB of the blade holder 24. For example, each of the dimensions LPF, LPR of the pillars 210, 212 in the longitudinal direction of the blade holder 24 may be at least one quarter of the length LB of the blade-holder 24, in some embodiments may be greater than one quarter of the length LB of the blade-holder 24, and in some embodiments may be even larger relatively.

In this embodiment, dimensions LOF, LOR of the openings 237, 239 in the longitudinal direction of the blade holder 24 may be relatively large. For instance, in this embodiment, a sum of the dimension LOF of the front opening 237 and the dimension LOR of the rear opening 239 in the longitudinal direction of the blade holder 24 may correspond to a majority of the length LB of the blade holder 24. For example, each of the dimensions LOF, LOR of the openings 237, 239 in the longitudinal direction of the blade holder 24 may be at least one quarter of the length LB of the blade-holder 24, in some embodiments may be greater than one quarter of the length LB of the blade-holder 24, and in some embodiments may be even larger relatively.

In this embodiment, rigidity (i.e., stiffness) characteristics of the blade holder 24 may be enhanced. This may help to improve speed, power, agility (e.g., turning), and/or other performance aspects of the user while he/she skates.

For example, in this embodiment, a rigidity profile (i.e., a variation in rigidity) of the blade holder 24 in the longitudinal direction of the blade holder 24 may be enhanced.

Notably, in this embodiment, a lateral rigidity of the blade holder 24 (i.e., a resistance to deformation of the blade holder 24 when subject to a lateral force, which is a force exerted in the lateral direction of the blade holder 24) varies in the longitudinal direction of the blade holder 24, e.g., in order to increase agility, skating performances during turns and/or power transferred during skating strides.

For instance, in this embodiment, the blade holder 24 is stiffer (i.e., more rigid) in the lateral direction of the blade holder 24 at each of the front portion 170 of the blade holder 24 and the rear portion 172 of the blade holder 24 than at the intermediate portion 180 of the blade holder 24. Thus, in this embodiment, the lateral rigidity of the blade holder 24 at the intermediate portion 180 of the blade holder 24 is lower than the lateral rigidity of the blade holder 24 at the front portion 170 of the blade holder 24 and lower than the lateral rigidity of the blade holder 24 at the rear portion 172 of the blade holder 24.

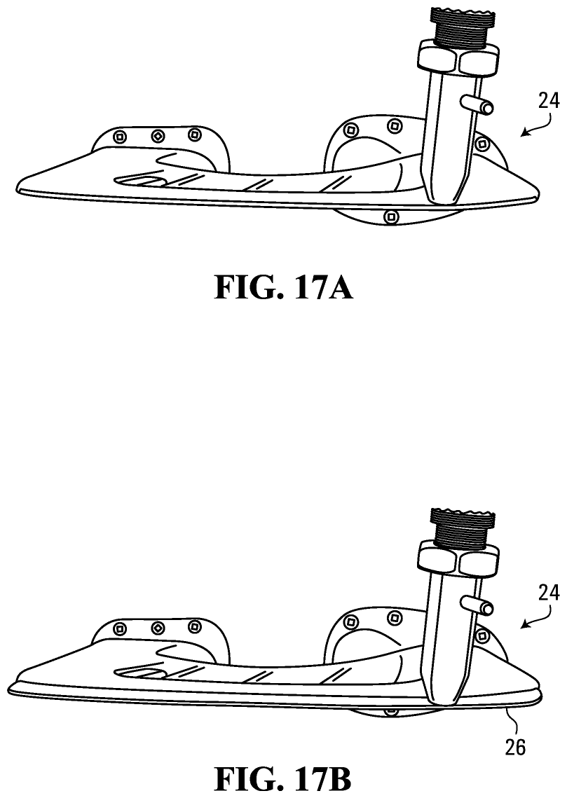

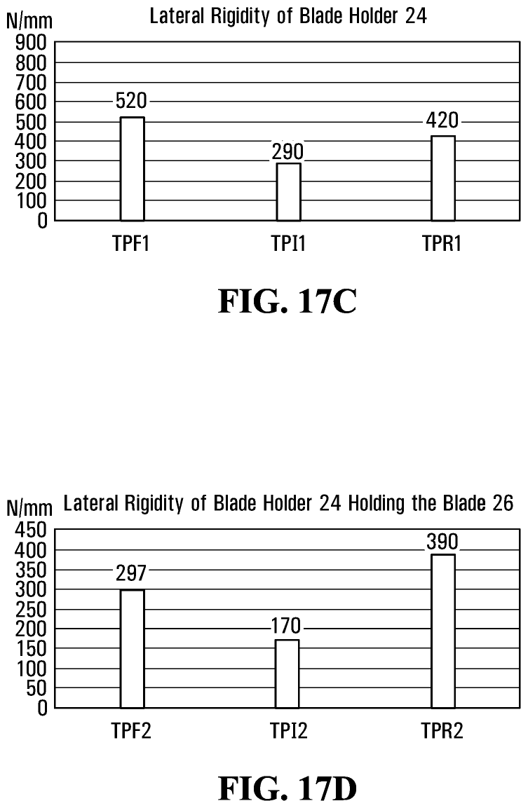

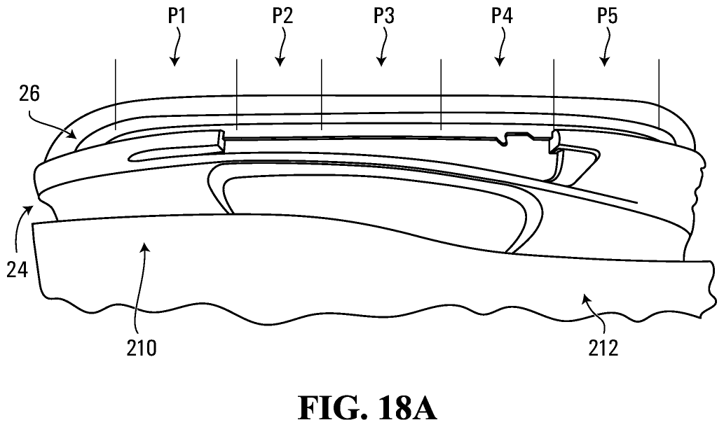

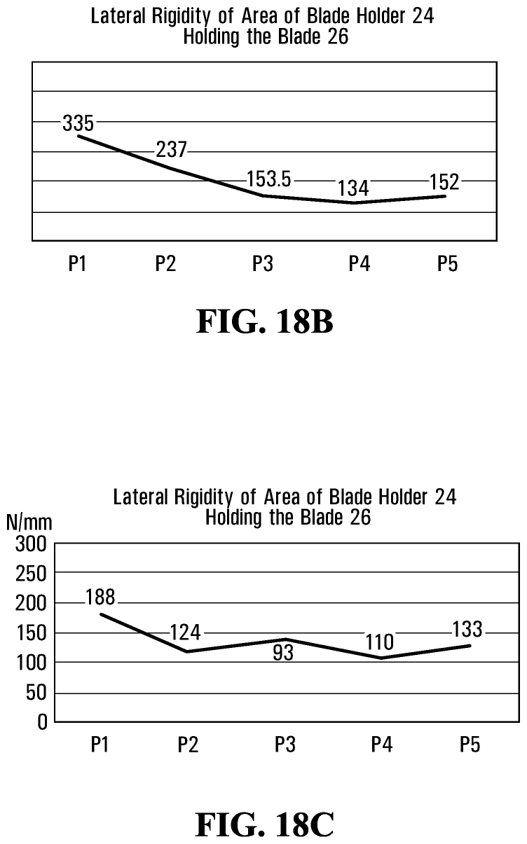

To measure the lateral rigidity of the blade holder 24 at a given point of the blade holder 24, a test can be performed to fix the blade holder 24 (e.g., by fastening the blade holder 24 to a jig), apply a lateral force at the given point of the blade holder 24 (i.e., a force exerted in the lateral direction of the blade holder 24 at the given point of the blade holder 24) to cause a specified lateral deflection of the given point of the blade holder 24 (i.e., increase the lateral force until it produces a specified deflection of the given point of the blade holder 24 in the lateral direction of the blade holder 24), and calculate the lateral rigidity of the blade holder 24 at the given point of the blade holder 24 as a quotient of the lateral force and the specified lateral deflection (e.g., in N/mm). For instance, an example of this in some embodiments is shown in FIGS. 17A and 17C.

For example, some embodiments, the specified lateral deflection may be about 2 mm. In this embodiment, the lateral force may be applied to the specific point such that a displacement speed of the given point is at a pre-determined value. In some embodiments, the pre-determined speed may be between 1 mm/min and 600 mm/min, in some embodiments between 50 mm/min and 300 mm/min, and in some embodiments about 150 mm/min. The force may be applied to the given point by any suitable device. For example, in this embodiment, a spherical pin having a diameter of about 17 mm may be used to apply force to the given point of the blade holder 24.

In this embodiment, to determine the lateral rigidity of the blade holder 24 at the front portion 170 of the blade holder 24, the test may be performed at the given point TPF1. The given point TPF1 may be located anywhere in the front portion 170 of the blade holder 24. For instance, in this embodiment, the point TPF1 may be disposed in a lower rear region of the front pillar 210.

In this embodiment, to determine the lateral rigidity of the blade holder 24 at the rear portion 172 of the blade holder 24, the test may be performed at the given point TPR1. The given point TPR1 may be located anywhere in the rear portion 172 of the blade holder 24. For instance, in this embodiment, the point TPR1 may be disposed in a lower front region of the rear pillar 212.

In this embodiment, to determine the lateral rigidity of the blade holder 24 at the intermediate portion 180 of the blade holder 24, the test may be performed at the given point TPI1. The given point TPI1 may be located anywhere in the intermediate portion 180 of the blade holder 24. For instance, in this embodiment, the point TPI1 may be disposed at or proximate to a mid-point of the bridge 214 of the blade holder 24.

In some embodiments, a ratio of the lateral rigidity of the blade holder 24 at the front portion 170 over the lateral rigidity of the blade holder 24 at the rear portion 172 may be no more than 2, in some embodiments no more than 1.5, in some embodiments no more than 1.25, and in some embodiments even less (e.g., no more than 1.1). In this embodiment, also, in order to increase agility and/or power transferred during skating strides, the lateral rigidity of the blade holder 24 may be within certain values. For instance, in some embodiments, the lateral rigidity of the blade holder 24 at the front portion 170 may be between 400 N/mm and 800 N/mm, in some embodiments between 450 N/mm and 600 N/mm, and in some embodiments may be about 520 N/mm, while the lateral rigidity of the blade holder 24 at the rear portion 172 may be between 100 N/mm and 500 N/mm, in some embodiments between 300 N/mm and 450 N/mm, and in some embodiments may be about 420 N/mm.

In this embodiment, the lateral rigidity of the blade holder 24 holding the blade 26 at the intermediate portion 180 of the blade holder 24 holding the blade 26 is lower than the lateral rigidity of the blade holder 24 holding the blade 26 at the front portion 170 of the blade holder 24 holding the blade 26 and lower than the lateral rigidity of the blade holder 24 holding the blade 26 at the rear portion 172 of the blade holder 24, which may help generating more power during skating strides and/or increasing agility. In particular, the lateral rigidity profile of the blade holder 24 may be configured to facilitate resilient lateral deformation of the blade 26 into a circular, parabolic or other curvature during turns of the skater, which may help achieve tighter turning (e.g., with smaller radii of curvature of the blade 26). The blade holder 24 holding the blade 26 is a combination (i.e., an assembly) of the blade holder 24 and the blade 26 (i.e., the blade holder 24 and the blade 26 together) as they would be in use on the ice.

For instance, in some embodiments, a ratio of the lateral rigidity of the blade holder 24 holding the blade 26 at the front portion 170 of the blade holder 24 over the lateral rigidity of the blade holder 24 holding the blade 26 at the intermediate portion 180 of the blade holder 24 may be at least 1.5, in some embodiments at least 2, in some embodiments at least 3, and in some embodiments even more (e.g., 4 or more), and a ratio of the lateral rigidity of the blade holder 24 holding the blade 26 at the rear portion 172 of the blade holder 24 over the lateral rigidity of the blade holder 24 holding the blade 26 at the intermediate portion 180 of the blade holder 24 may be at least 1.2, in some embodiments at least 1.5, in some embodiments at least 2, and in some embodiments even more (e.g., 2.5 or more).

To measure the lateral rigidity of the blade holder 24 holding the blade 26 at a given point of the blade holder 24 holding the blade 26 (i.e., a given point of the blade holder 24 or blade 26), a test can be performed to fix the blade holder 24 holding the blade 26 (e.g., by fastening the blade holder 24 holding the blade 26 to a jig), apply a lateral force at the given point of the blade holder 24 holding the blade 26 (i.e., a force exerted in the lateral direction of the blade holder 24 at the given point of the blade holder 24 or blade 26) to cause a specified lateral deflection of the given point of the blade holder 24 holding the blade 26 (i.e., increase the lateral force until it produces a specified deflection of the given point of the blade holder 24 or blade 26 in the lateral direction of the blade holder 24), and calculate the lateral rigidity of the blade holder 24 holding the blade 26 at the given point of the blade holder 24 holding the blade 26 as a quotient of the lateral force and the specified lateral deflection (e.g., in N/mm). For instance, an example of this in some embodiments is shown in FIGS. 17B and 17D.

For example, in some embodiments, the specified deflection may be about 2 mm. In this embodiment, the lateral force may be applied to the specific point such that a displacement speed of the given point is at a pre-determined value. In some embodiments, the pre-determined speed may be between 1 mm/min and 600 mm/min, in some embodiments between 50 mm/min and 300 mm/min, and in some embodiments about 150 mm/min. The force may be applied to the given point by any suitable device. For example, in this embodiment, a spherical pin having a diameter of about 17 mm may be used to apply force to the given point of the blade holder 24.

In this embodiment, to determine the lateral rigidity of the blade holder 24 holding the blade 26 at the front portion 170 of the blade holder 24, the test may be performed at the given point TPF2. In this embodiment, the point TPF2 may be disposed in a region of the blade 26 that is in line with a center of the front pillar 210 in the longitudinal direction of the blade 26.

In this embodiment, to determine lateral rigidity of the blade holder 24 holding the blade 26 at the rear portion 172 of the blade holder 24, the test may be performed at the given point TPR2. In this embodiment, the point TPR2 may be disposed in a region of the blade 26 that is in line with a center of the rear pillar 212 in the longitudinal direction of the blade 26

In this embodiment, to determine lateral rigidity of the blade holder 24 holding the blade 26 at the intermediate portion 180 of the blade holder 24, the test may be performed at the given point TPI2. In this embodiment, the point TPI2 may be disposed at or proximate to a mid-point of the blade 26 in the longitudinal direction of the blade 26.

In some embodiments, a ratio of the lateral rigidity of the blade holder 24 holding the blade 26 at the front portion 170 over the lateral rigidity of the blade holder 24 holding the blade 26 at the rear portion 172 may be no more than 3, in some embodiments no more than 2, in some embodiments no more than 1.5, in some embodiments no more than 1.25, and in some embodiments even less (e.g., no more than 1.1). In some cases, the lateral rigidity of the blade holder 24 holding the blade 26 at the front portion 170 may be even lower than the lateral rigidity of the blade holder 24 holding the blade 26 at the rear portion 172. In this embodiment, also, in order to increase agility and/or power transferred during skating strides, the lateral rigidity of the blade holder 24 may need to be within certain values. For instance, in some embodiments, the lateral rigidity of the blade holder 24 at the front portion 170 may be between 100 N/mm and 500 N/mm, in some embodiments between 125 N/mm and 200 N/mm, and in some embodiments may be about 150 N/mm, while the lateral rigidity of the blade holder 24 at the rear portion 172 may be between 100 N/mm and 200 N/mm, and in some embodiments may be about 195 N/mm.

In this embodiment, the lateral rigidity of the blade holder 24 holding the blade 26 at a given point of the blade holder 24 holding the blade 26 may be observed over regions of the blade 26 rather than over points. For example, the lateral rigidity of the blade holder 24 holding the blade 26 may be observed over five regions P1, P2, P3, P4, P5 distributed longitudinally along the blade 26, wherein P1 is a front region of the blade 26 (e.g., between 0 mm and 27 mm from a front end of the blade 26), P2 is adjacent to P1 towards the rear of the blade (e.g., between 27 mm and 78 mm from the front end of the blade 26), P3 is adjacent to P2 towards the rear of the blade (e.g., between 78 mm and 129 mm from the front end of the blade 26), P4 is adjacent to P3 towards the rear of the blade (e.g., between 129 mm and 180 mm from the front end of the blade 26), and P5 is a rearmost region of the blade 26 (e.g., between 180 mm and 231 mm from the front end of the blade 26).

In this embodiment, the specified deflection of 2 mm is used, the lateral force is applied to the given region such that a displacement speed of the given region is at about 150 mm/min, and the force is applied to the given region of the blade 26 by a flat rectangular surface of a block having a width of 11 mm and a length of 51 mm.

The lateral rigidity profile of the blade holder 24 holding the blade 26 may be configured to improve agility of the skater and power generated by the skater on ice during skating strides. In particular, the lateral rigidity profile of the blade holder 24 may be configured to facilitate a resilient lateral deformation of the blade 26 into a circular, parabolic or other curvature during turns of the skater. As a result, a radius of curvature of the blade 26 in the lateral direction of the blade holder 24 during turns of the skater may be decreased, facilitating the turn and increasing the agility of the skater.

For instance, in this embodiment, the lateral rigidity of the blade holder 24 holding the blade 26 observed over the region P4 may be lower than the lateral rigidity of the blade holder 24 holding the blade 26 observed over the regions P1, P2 and P5; the lateral rigidity of the blade holder 24 holding the blade 26 observed over the frontmost region P1 may be greater than the lateral rigidity of the blade holder 24 holding the blade 26 observed over the region P2, which may be greater than the lateral rigidity of the blade holder 24 holding the blade 26 observed over the central region P3. The lateral rigidity of the blade holder 24 holding the blade 26 observed around the region P4 reaches a minimum before increasing towards the lateral rigidity of the blade holder 24 holding the blade 26 over the rearmost region P5. As such, the profile of the lateral rigidity of the blade holder 24 holding the blade 26 may be U-shaped or V-shaped along the longitudinal direction of the blade 26 and a minimum of the lateral rigidity profile may be located between a longitudinal midpoint of the blade holder 24 and the rear pillar 212 of the blade holder 24. For instance, in some embodiments, a ratio: of (i) a difference between the largest lateral rigidity of the blade holder 24 holding the blade 26 observed along the blade 26 and the lowest lateral rigidity of the blade holder 24 holding the blade 26 observed along the blade 26 over (ii) the largest lateral rigidity of the blade holder 24 holding the blade 26 observed along the blade 26 may be no more than 75%, in some embodiments no more than 70%, in some embodiments no more than 60%, in some embodiments no more than 50%, and in some embodiments even less (e.g., less than 50%).

In other embodiments, the lateral rigidity of the blade holder 24 holding the blade 26 observed over the central region P3 may be lower than the lateral rigidity of the blade holder 24 holding the blade 26 observed over the regions P1, P2, P4 and P5; the lateral rigidity of the blade holder 24 holding the blade 26 observed over the frontmost region P1 may be greater than the lateral rigidity of the blade holder 24 holding the blade 26 observed over the rearmost region P5, which may be greater than the lateral rigidity of the blade holder 24 holding the blade 26 observed over the region P2 and P4. As such, the profile of the lateral rigidity of the blade holder 24 holding the blade 26 may be U-shaped or V-shaped along the longitudinal direction of the blade 26 and a minimum of the lateral rigidity profile may be located at the longitudinal midpoint of the blade holder 24.

In order to allow and facilitate a resilient lateral deformation of the blade 26 into a circular, parabolic or other curvature in the lateral direction of the blade holder 24 during turns of the skater, the lateral rigidity of the blade holder 24 holding the blade 26 observed over the rearmost region P5 may be increased relative to the lowest lateral rigidity of the blade holder 24 holding the blade 26 observed along the blade 26. For instance, in some embodiments, the lateral rigidity of the blade holder 24 holding the blade 26 observed over the rearmost region P5 may be greater than the lowest lateral rigidity of the blade holder 24 holding the blade 26 observed along the blade 26, and a ratio: of (i) a difference between the lateral rigidity of the blade holder 24 holding the blade 26 observed over the rearmost region P5 and the lowest lateral rigidity of the blade holder 24 holding the blade 26 observed along the blade 26 over (ii) the lateral rigidity of the blade holder 24 holding the blade 26 observed over the rearmost region P5 may be at least 1%, in some embodiments at least 5%, in some embodiments at least 10%, and in some embodiments even more (e.g., at least 15%).

In this embodiment, a heightwise rigidity of the blade holder 24 (i.e., a resistance to deformation of the blade holder 24 when subject to a heightwise force, which is a force exerted in the heightwise direction of the blade holder 24) varies in the longitudinal direction of the blade holder 24, e.g., in order to increase agility and/or power transferred during skating strides.

For instance, in this embodiment, the blade holder 24 is stiffer (i.e., more rigid) in the heightwise direction of the blade holder 24 at each of the front portion 170 of the blade holder 24 and the rear portion 172 of the blade holder 24 than at the intermediate portion 180 of the blade holder 24. Thus, in this embodiment, the heightwise rigidity of the blade holder 24 at the intermediate portion 180 of the blade holder 24 is lower than the heightwise rigidity of the blade holder 24 at the front portion 170 of the blade holder 24 and lower than the heightwise rigidity of the blade holder 24 at the rear portion 172 of the blade holder 24.

In this embodiment, the heightwise rigidity of the blade holder 24 holding the blade 26 at the intermediate portion 180 of the blade holder 24 holding the blade 26 is lower than the heightwise rigidity of the blade holder 24 holding the blade 26 at the front portion 170 of the blade holder 24 holding the blade 26 and lower than the heightwise rigidity of the blade holder 24 holding the blade 26 at the rear portion 172 of the blade holder 24, which may help generating more power during skating strides.

For instance, in some embodiments, a ratio of the heightwise rigidity of the blade holder 24 holding the blade 26 at the front portion 170 of the blade holder 24 over the heightwise rigidity of the blade holder 24 holding the blade 26 at the intermediate portion 180 of the blade holder 24 may be at least 1.5, in some embodiments at least 2, in some embodiments at least 2.5, and in some embodiments even more (e.g., at least 3), and a ratio of the heightwise rigidity of the blade holder 24 holding the blade 26 at the rear portion 172 of the blade holder 24 over the heightwise rigidity of the blade holder 24 holding the blade 26 at the intermediate portion 180 of the blade holder 24 may be at least 1.5, in some embodiments at least 2, in some embodiments at least 2.5, and in some embodiments even more (e.g., at least 3).

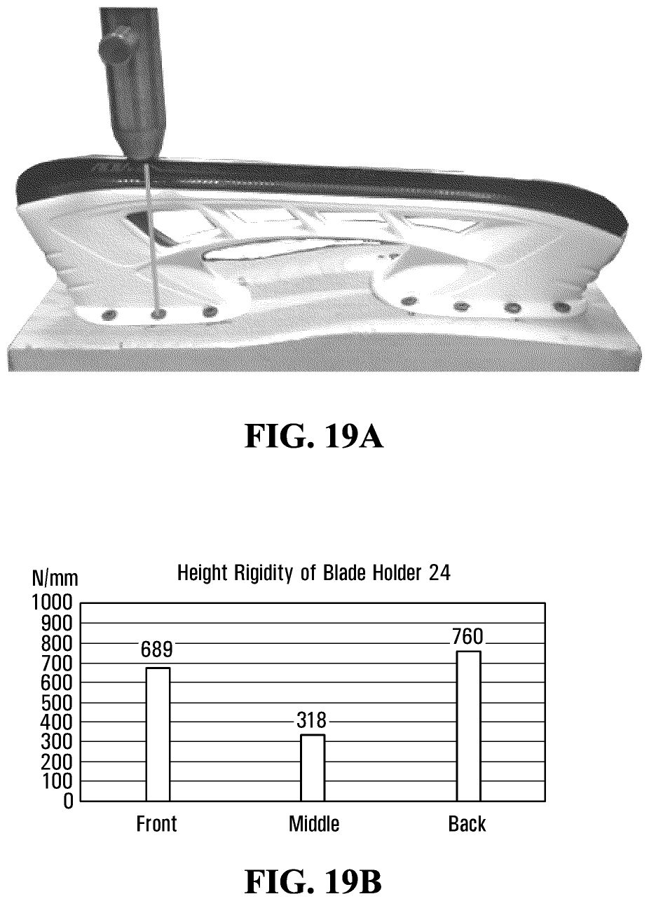

To measure the heightwise rigidity of the blade holder 24 holding the blade 26 at a given point of the blade holder 24 holding the blade 26 (i.e., a given point of the blade holder 24 or blade 26), a test can be performed to fix the blade holder 24 holding the blade 26 (e.g., by fastening the blade holder 24 holding the blade 26 to a jig), apply a compressive force in the heightwise direction the given point of the blade holder 24 holding the blade 26 (i.e., a force exerted in the heightwise direction of the blade holder 24 at the given point of the blade holder 24 or blade 26) to cause a specified heightwise deflection of the given point of the blade holder 24 holding the blade 26 (i.e., increase the heightwise force until it produces a specified deflection of the given point of the blade holder 24 or blade 26 in the heightwise direction of the blade holder 24), and calculate the heightwise rigidity of the blade holder 24 holding the blade 26 at the given point of the blade holder 24 holding the blade 26 as a quotient of the heightwise force and the specified heightwise deflection (e.g., in N/mm). For instance, an example of this in some embodiments is shown in FIG. 19A.

For example, in some embodiments, the specified deflection may be about 2 mm. In this embodiment, the heightwise force may be applied to the specific point such that a displacement speed of the given point is at a pre-determined value. In some embodiments, the pre-determined speed may be between 1 mm/min and 600 mm/min, in some embodiments between 50 mm/min and 300 mm/min, and in some embodiments about 150 mm/min. The force may be applied to the given point by any suitable device. For example, in this embodiment, a spherical pin having a diameter of about 17 mm may be used to apply force to the given point of the blade holder 24.

In this embodiment, to determine the heightwise rigidity of the blade holder 24 holding the blade 26 at the front portion 170 of the blade holder 24, the test may be performed at the given point TPF2; to determine heightwise rigidity of the blade holder 24 holding the blade 26 at the rear portion 172 of the blade holder 24, the test may be performed at the given point TPR2; and to determine heightwise rigidity of the blade holder 24 holding the blade 26 at the intermediate portion 180 of the blade holder 24, the test may be performed at the given point TPI2.

In some embodiments, a ratio of the heightwise rigidity of the blade holder 24 holding the blade 26 at the front portion 170 over the heightwise rigidity of the blade holder 24 holding the blade 26 at the rear portion 172 may be no more than 3, in some embodiments no more than 2, in some embodiments no more than 1.5, in some embodiments no more than 1.25, and in some embodiments even less (e.g., no more than 1.1). In some cases, the heightwise rigidity of the blade holder 24 holding the blade 26 at the front portion 170 may be even lower than the heightwise rigidity of the blade holder 24 holding the blade 26 at the rear portion 172. In this embodiment, also, in order to increase agility and/or power transferred during skating strides, the heightwise rigidity of the blade holder 24 may need to be within certain values. For instance, in some embodiments, the heightwise rigidity of the blade holder 24 at the front portion 170 may be between 500 N/mm and 1000 N/mm, in some embodiments between 600 N/mm and 800 N/mm, and in some embodiments may be about 700 N/mm, while the heightwise rigidity of the blade holder 24 at the rear portion 172 may be between 200 N/mm and 500 N/mm, in some embodiments between 250 N/mm and 400 N/mm, and in some embodiments may be about 300 N/mm, and the heightwise rigidity of the blade holder 24 at the rear portion 172 may be between 500 N/mm and 1000 N/mm, in some embodiments between 600 N/mm and 800 N/mm, and in some embodiments may be about 750 N/mm.

In this embodiment, a torsional rigidity of the blade holder 24 around the longitudinal axis of the blade holder 24, with and/or without the blade 26 may be increased, e.g., in order to increase stability, agility and/or power transferred during skating strides.

For instance, in this embodiment, the lateral rigidity profile of the blade holder 24 may help with agility by facilitating turns through a resilient lateral deformation of the blade 26 in the blade holder's lateral direction, while the torsional rigidity of the blade holder 24 may enhance stability and dynamism. As an example, during a turn, the rear pillar 212 and the upper longitudinal member 280 of the bridge 214 of the blade holder 24 may rotate, such that rotation of the rear pillar 212 may induce a lateral deformation of the lower longitudinal member 282 and the blade 26, which enhances agility and tighter turning through a smaller radius of curvature of the blade 26. Upon completing the turn, for stability, the torsional rigidity of the blade holder 24, which may be increased by the upper longitudinal member 280 of the bridge 214, can help bring back the blade holder 24 and the blade 26 into their respective original pre-turning shapes faster (e.g., akin to a rotational spring-back effect of the upper longitudinal member 280 of the bridge 214).

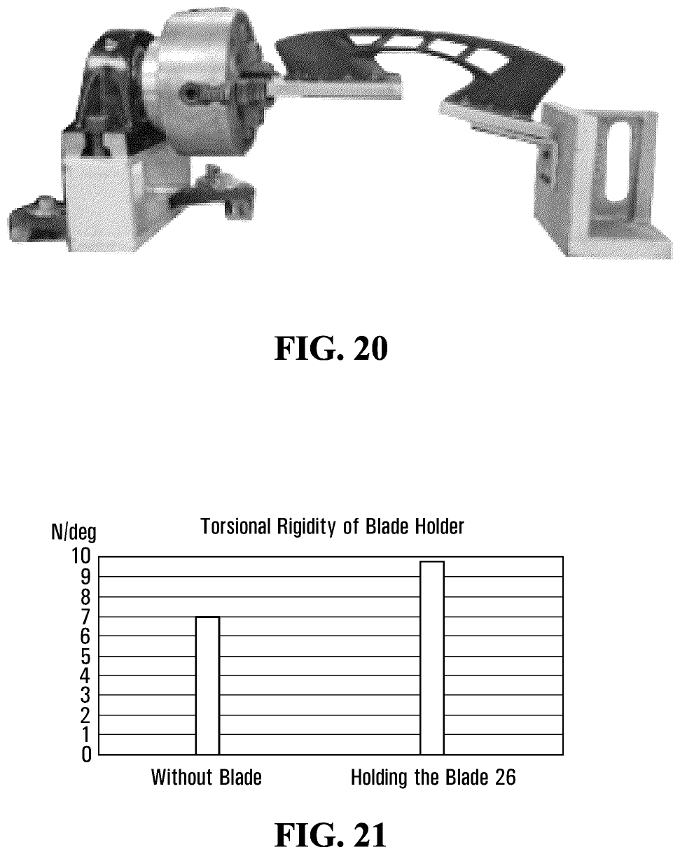

To measure the torsional rigidity of the blade holder 24, a test can be performed to fix the blade holder 24 (e.g., by fastening a given one of the front pillar 210 and the rear pillar 212 of the blade holder 24 to a jig and mounting the other remaining one of the front pillar 210 and the rear pillar 212 of the blade holder 24 to a torque mandrel), apply a torsional force at the given point of the blade holder 24 (i.e., a force exerted in a tangential direction at an offset from a fastening axis (e.g., with the jig and the mandrel)) to cause a specified deflection of the given point of the blade holder 24 (i.e., increase the torsional force until it produces a specified deflection of the given point of the blade holder 24 in the torsional direction of the blade holder 24), and calculate the torsional rigidity of the blade holder 24 at the given point of the blade holder 24 as a quotient of the force applied and the torsional deflection (e.g., in N per mm of displacement of the given point or in N per degree of torsion). For instance, an example of this in some embodiments is shown in FIGS. 20 and 21.

For example, some embodiments, the specified deflection may be about 10 mm at an offset of 150 mm from the mandrel axis (e.g., resulting in an angular displacement of about 3.82 degrees). In this embodiment, the torsional force may be applied to the specific point such that a displacement speed of the given point is at a pre-determined value. In some embodiments, the pre-determined speed may be between 1 mm/min and 300 mm/min, in some embodiments between 25 mm/min and 150 mm/min, and in some embodiments about 50 mm/min. The force may be applied to the given point by any suitable device.

In some embodiments, a ratio of the torsional rigidity of the blade holder 24 holding the blade 26 over the torsional rigidity of the blade holder 24 alone (i.e., without the blade 26) may be at least 2, in some embodiments at least 2.2, and in some embodiments even more (e.g., at least 2.5). For instance, in some embodiments, the torsional rigidity of the blade holder 24 alone (i.e., without the blade 26) may be at least 1 N/mm, in some embodiments at least 1.5 N/mm, in some embodiments at least 2 N/mm, and in some embodiments even more (e.g., more than 2 N/mm). In some embodiments, the torsional rigidity of the blade holder 24 holding the blade 26 attached may be at least 2 N/mm, in some embodiments at least 3 N/mm, in some embodiments at least 4 N/mm, and in some embodiments even more (e.g., at least 4.5 N/mm).

In torsion deformation units, in some embodiments, the torsional rigidity of the blade holder 24 alone (i.e., without the blade 26) may be at least 3 N/degree, in some embodiments at least 4 N/degree, in some embodiments at least 5 N/degree, in some embodiments at least 6 N/degree, in some embodiments at least 7 N/degree, and in some embodiments even more (e.g., more than 7 N/degree). In some embodiments, the torsional rigidity of the blade holder 24 holding the blade 26 attached may be at least 5 N/degree, in some embodiments at least 6 N/degree, in some embodiments at least 7 N/degree, in some embodiments at least 8 N/degree, in some embodiments at least 9 N/degree, and in some embodiments even more (e.g., at least 10 N/degree).

This may be achieved in any suitable way. For instance, in this embodiment, the upper longitudinal member 280 of the bridge 214 of the blade holder 24 may be located relatively high. For example, in some embodiments, a ratio of a height HUB of the upper longitudinal member 280 of the bridge 214 relative to a bottom of the blade holder 24 over a total height HBH of the blade holder 24 may be at least 40%, in some embodiments at least 50%, in some embodiments at least 60%, in some embodiments at least 70%, and in some embodiments even more (e.g., at least 75%, at least 80%, at least 90%).

The skate boot 22 and the support 168 of the blade holder 24 may be affixed to one another in any suitable way. For example, in this embodiment, the front and rear pillars 210, 212 are fastened to the skate boot 22 by fasteners (e.g., rivets, screws, bolts). In this example, each of the front and rear pillars 210, 212 comprises a flange 216 including a plurality of apertures 218 to receive respective ones of the fasteners that fasten the blade holder 24 to the skate boot 22. The support 168 may be affixed to the skate boot 22 in any other suitable manner in other embodiments (e.g., by an adhesive, by being at least partly integrally formed with the skate boot 22, etc.).

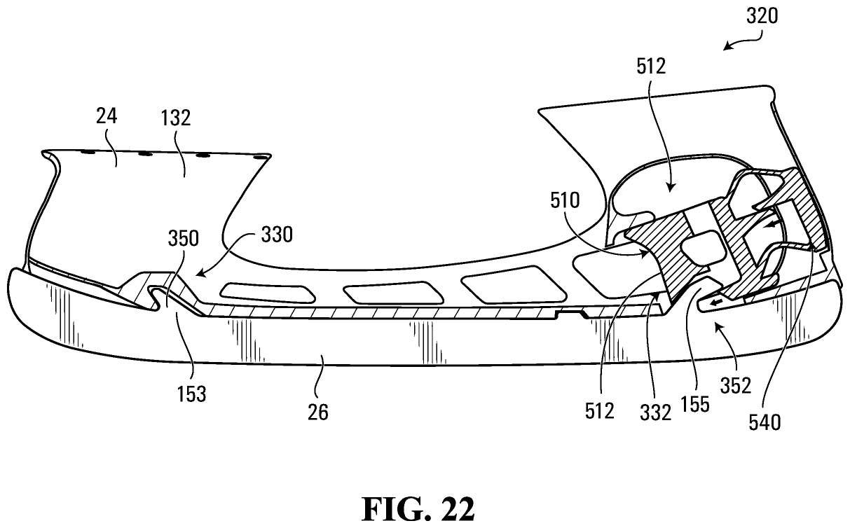

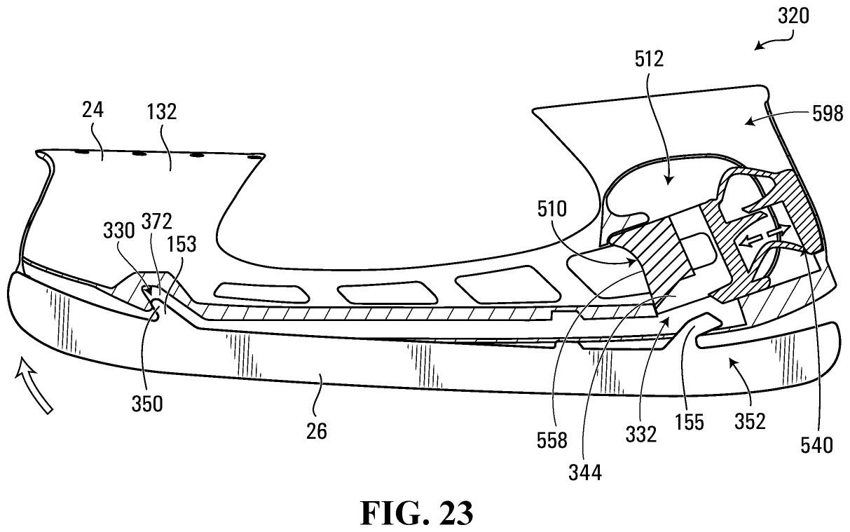

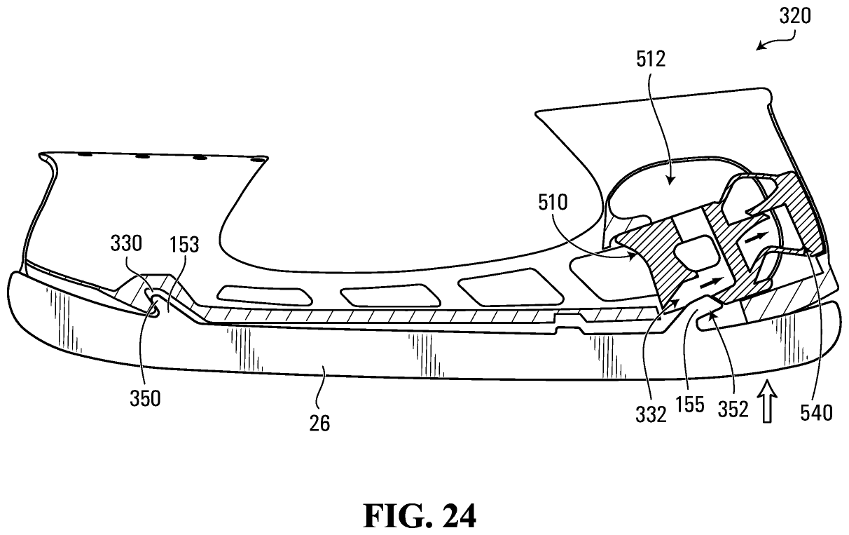

In this embodiment, with additional reference to FIGS. 22 to 24, the blade holder 24 comprises a connection system 320 configured to attach the blade 26 to and detach the blade 26 from the blade holder 24. The connection system 320 facilitates installation and removal of the blade 26, such as for replacement of the blade 26, assemblage of the skate 10, and/or other purposes.

More particularly, in this embodiment, the connection system 320 of the blade holder 24 is a manual connection system configured to be manually operated (i.e., engaged by at least one hand, such as one or more fingers of the user or another individual) to attach the blade 26 to and detach the blade 26 from the blade holder 24. In that sense, the manual connection system 320 may be viewed as a quick-connect system that allows the blade 26 to be attached to and detached from the blade holder 24 quickly and easily.

Notably, in this embodiment, the connection system 320 of the blade holder 24 is configured to attach the blade 26 to and detach the blade 26 from the blade holder 24 without using a screwdriver when the blade 26 is positioned in the blade holder 24. In this example, the connection system 320 is configured to attach the blade 26 to and detach the blade 26 from the blade holder 24 screwlessly (i.e., without using any screws) when the blade 26 is positioned in the blade holder 24. It is noted that although the connection system 320 is configured to attach the blade 26 to and detach the blade 26 from the blade holder 24 screwlessly, the connection system 320 may comprise screws that are not used (i.e. manipulated) for attachment or detachment of the blade 26. Thus, in this embodiment, the connection system 320 is configured to attach the blade 26 to and detach the blade 26 from the blade holder 24 without using a screwdriver and screwlessly when the blade 26 is positioned in the longitudinal recess 190 of the blade holder 24.

In this example, the connection system 320 of the blade holder 24 is configured to attach the blade 26 to and detach the blade 26 from the blade holder 24 toollessly (i.e., without using any tool) when the blade 26 is positioned in the blade holder 24. That is, the blade 24 is attachable to and detachable from the blade holder 24 manually without using any tool (i.e., a screwdriver or any other tool). Thus, in this example, the connection system 320 is configured to attach the blade 26 to and detach the blade 26 from the blade holder 24 toollessly when the blade 26 is positioned in the longitudinal recess 190 of the blade holder 24.

In this embodiment, the connection system 320 of the blade holder 24 comprises a plurality of connectors 330, 332 to attach the blade 26 to and detach the blade 26 from the blade holder 24. The blade 26 comprises a plurality of connectors 350, 352 configured to engage respective ones of the connectors 330, 332 of the connection system 320 of the blade holder 24 to be attached to and detached from the blade holder 24. The connectors 330, 332 of the connection system 320 of the blade holder 24 are spaced apart in the longitudinal direction of the blade holder 10, and so are the connectors 350, 352 of the blade 26.

More particularly, in this embodiment, the connectors 350, 352 of the blade 26 comprise hooks 153, 155 that project upwardly from the top surface 262 of the blade 26. In this example, the hook 153 is a front hook and the hook 155 is a rear hook. The connectors 350, 352 of the blade 26 may be implemented in any other suitable way in other embodiments.

Also, in this embodiment, the connection system 320 of the blade holder 24 comprises a plurality of manual controls 510, 520 configured to be manually operated to attach the blade 26 to and detach the blade 26 from the blade holder 24.

More specifically, in this embodiment, the manual control 510 comprises an actuator 512 manually actuatable to release the blade 26 from the blade holder 24, and the manual control 520 comprises a lock 522 manually movable between a locked position in which the actuator 512 is precluded from releasing the blade 26 from the blade holder 24 and an unlocked position in which the actuator 512 is operable to release the blade 26 from the blade holder 24. For instance, the actuator 512 may comprise a trigger 518.

In this embodiment, the connection system 320 of the blade holder 24 comprises a biasing element 540 which biases the actuator 512 towards the front portion 170 of the blade holder 24. The biasing element 540 can resiliently deform, i.e., change from an initial shape to a changed shape when subjected to a force and recover its initial shape once the force ceases. In this example, the biasing element 540 comprises a resilient polymeric member. The biasing element 540 may comprise a spring (e.g., a coil spring) or any other resilient object in other examples. To attach the blade 26 to the blade holder 24, the front hook 153 is first positioned within a void 372 (e.g., a recess or hole) of the connector 330 of the blade holder 24. The rear hook 155 can then be pushed upwardly into a void 344 (e.g., a recess or hole) of the connector 332 of the blade holder 24, thereby causing the biasing element 540 to resiliently deform (e.g., bend, deflect, compress, or otherwise change from its initial shape to its changed shape) and the actuator 512 to move rearwardly. The rear hook 155 will eventually reach a position which will allow the biasing element 540 to urge the actuator 512 towards the front portion 170 of the blade holder 24 as it recovers its initial shape, thereby locking the blade 26 in place. The blade 26 can be removed by pushing against a finger-actuating surface 558 of the actuator 512 to resiliently deform the biasing element 540 in order to release the rear hook 155 from the void 344 of the blade holder 24. The quick-connect system 320 may be configured in any other suitable way in other embodiments.

In this example, the actuator 512 and the lock 522 of the blade holder 24 are configured to be manually moved differently relative to the body 132 of the blade holder 24. More particularly, in this example, the actuator 512 and the lock 522 of the blade holder 24 are configured to be manually moved in different directions relative to the body 132 of the blade holder 24 that are transverse to one another. For instance, in this example, the actuator 512 is configured to be moved in the longitudinal direction of the blade holder 24, while the lock 522 is configured to be moved transversally to the longitudinal direction of the blade holder 24.

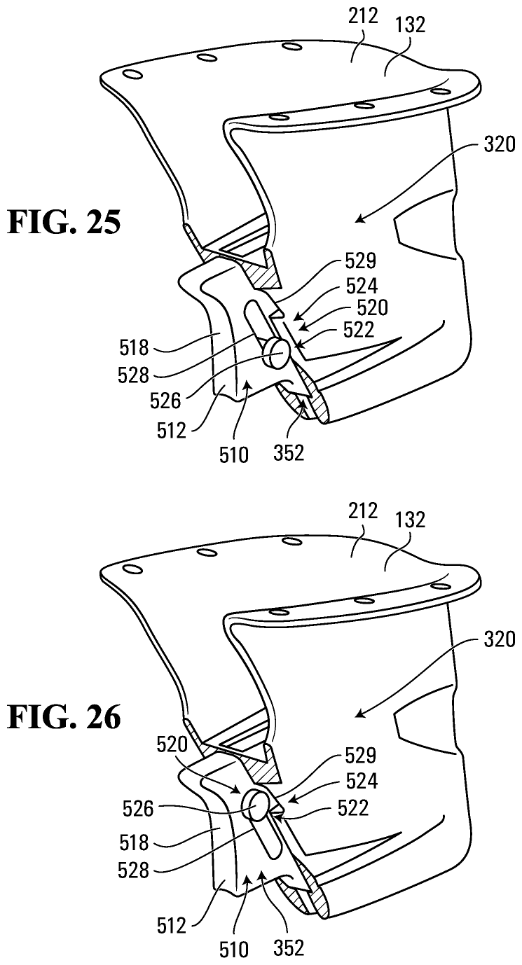

For instance, in this embodiment, as shown in FIGS. 25 and 26, the lock 522 may be configured to be manually moved in a heightwise direction of the blade holder 24. For instance, the lock 522 may be carried on the actuator 512 and may comprise a catch 524 that is movable relative to the trigger 518 to engage the body 132 of the blade holder 24 in the locked position and/or the trigger 518 of the actuator 512 and disengage the body 132 of the blade holder 24 and/or the trigger 518 of the actuator 512 in the unlocked position

In this embodiment, the catch 524 may be movable in the heightwise direction of the blade holder. In this example, the catch 524 may comprise a slider 526 that is translatable relative to the trigger 518 in the heightwise direction of the blade holder 24. The slider 526 may be disposed in a groove 528 extending in the heightwise direction of the blade holder, may project laterally and may be is slidable along the groove 524 in a locking position or unlocked position. When the slider 526 is positioned in the unlocked position, the slider 526 may be aligned with a notch 529 of the body 132 of the blade holder 24 allowing the actuator 512 to move in the longitudinal direction of the blade holder 24. As such, when the slider 526 is positioned in the unlocked position, the actuator 512 may be operable to release the blade 26 from the blade holder 24. When the slider 526 is positioned in the locked position, the lock 522 may hinder movement of the actuator 512 in the longitudinal direction of the blade holder 24, precluding the actuator 512 from releasing the blade 26 from the blade holder 24 and thus practically locking the blade 26 into place.

The blade holder 24 may be configured to protect against accidental release of the blade 26 from the blade-retaining base 164 when the blade-retaining base 164 is impacted (e.g., by a flying puck, by a board of the ice, by a goal post, by a skate of another player, etc.). Notably, in some embodiments, when the blade-retaining base 164 is impacted in use, in some cases, inertia may cause the connector 332 of the blade holder 24 to move relative to the blade 26 (and relative to the body 132 of the blade holder 24), and this could in some cases create a potential for the blade 26 to be accidentally released from the blade holder 24 (e.g., as the connector 332 of the blade holder 24 could push on the connector 352 of the blade 26 in ways tending to release the blade 26 from the blade holder 24). In some embodiments, the blade holder 24 may therefore be designed to protect against accidental release of the blade 26 from the blade-retaining base 164 when the blade-retaining base 164 is impacted.

More specifically, in some embodiments, the blade holder 24 is configured to protect against accidental release of the blade 26 from the blade-retaining base 164 when a rear end of the blade-retaining base 164 is impacted. More specifically, in some embodiments, the blade holder 24 is configured to protect against accidental release of the blade 26 from the blade-retaining base 164 when the rear end of the blade-retaining base 164 is impacted with an impact force exerted towards a front end of the blade holder 24. For instance, in some embodiments, the blade holder 24 may be configured to protect against accidental release of the blade 26 from the blade-retaining base 164 when the blade-retaining base 164 is impacted with an impact force of at least 10 Joules, in some embodiments at least 60 Joules, in some embodiments at least 100 Joules, and in some embodiments even more.

For example, in some embodiments, the lock 522 may protect the blade holder 24 from accidentally releasing the blade 26 when the blade-retaining base 164 is impacted, as discussed above. Thus, in some embodiments, the lock 522 may protect the blade holder 24 against accidental release of the blade 26 from the blade-retaining base 164 when the rear end of the blade-retaining base 164 is impacted, such as with an impact force exerted towards the front end of the blade holder 24.

The connection system 320 of the blade holder 24 may be connected to the body 132 of the blade holder 24 in any suitable way. In this embodiment, the connector 332 of the connection system 320 of the blade holder 24 may be received in a rear cavity 598 of the body 132 of the blade holder 24.

The connection system 320 of the blade holder 24 may be implemented in various other ways in other embodiments. For example, in some embodiments, the connection system 320 of the blade holder 24 may be implemented as described in International Patent Application No. PCT/CA2019/051531 filed on Oct. 29, 2019 and incorporated by reference herein.

The skate 10, including the blade holder 24 and/or the blade 26, may be implemented in various other ways in other embodiments.

For example, in some embodiments, the body 132 of the blade holder 24 may include a plurality of materials 134 that are different and distributed in the longitudinal direction of the blade holder 24. For instance, the intermediate portion 180 of the blade holder 24, between the front and rear portions 170, 172 of blade holder 24 in the longitudinal direction of the blade holder 24, may comprise a first one of the materials 134 that is absent or less present in the front and rear portions 170, 172 of blade holder 24, and/or the front and rear portions 170, 172 of blade holder 24 may comprise a second one of the materials 134 that is absent or less present in the intermediate portion 180 of the blade holder 24.

Respective ones of the materials 134 of the body 132 may differ in stiffness. More specifically, the first one of the materials 134 of the body 132 may be less stiff than the second one of the materials 134 of the body 132 of the blade holder 24.

In some embodiments, the materials 134 may also be distributed in the heightwise direction of the blade holder 24. For instance, the first one of the materials 134 of the body 132 may be disposed lower than the second one of the materials 134 in the heightwise direction of the blade holder. For example, the first one of the materials 134 of the body 132 may be disposed in the blade-retaining base 164 and/or the second one of the materials 134 of the body 132 may be disposed in the support 168 of the blade holder 24.

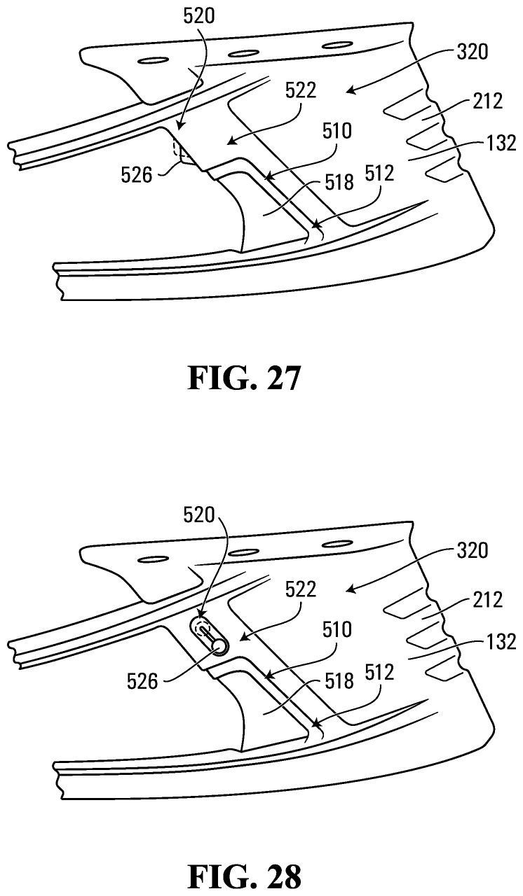

As another example, in some embodiments, as shown in FIGS. 27 to 37, the lock 522 of the connection system 320 of the blade holder 24 may be implemented in various other ways.

For example, as shown in FIGS. 27 and 28, the lock 522 may be spaced from the actuator 512. For instance, the slider 526 may be located on the body 132 of the blade holder 24 and may face a front side, a medial side or a lateral side of the blade holder 24.

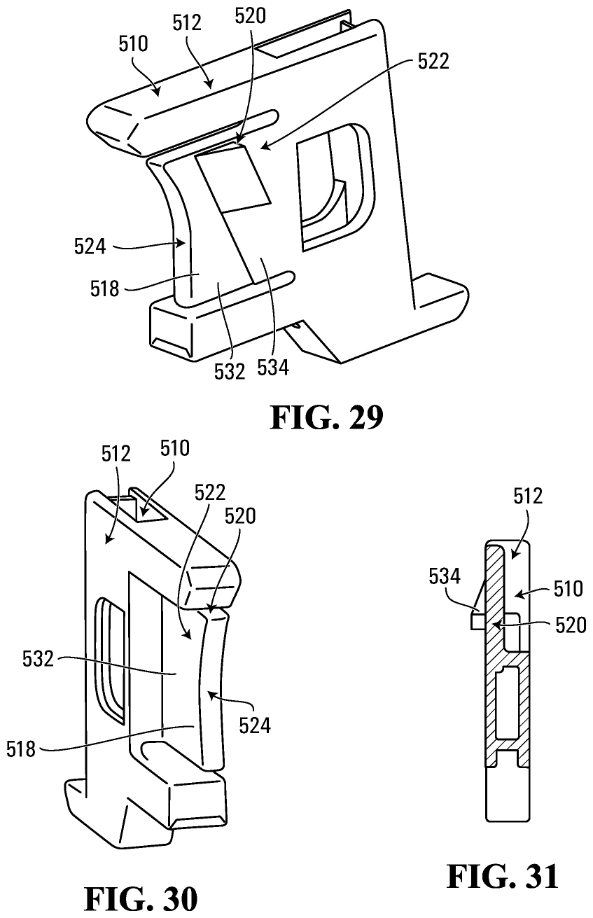

As another example, as shown in FIGS. 29 to 31, the lock 522 may be carried on the actuator 512 and may comprise the catch 524 that is resiliently flexible to move between the locked position and the unlocked position. More specifically, in this embodiment, the catch 524 comprises a flexible lamella 532 and a stopper 534 projecting from the flexible lamella 532 in the lateral direction of the blade holder 24. At rest, the lock 522 may be in the locked position and there may be an overlap between a lateral position of the stopper 534 and the body 132 of the blade holder 24 such that the lock 522 may hinder movement of the actuator 512 in the longitudinal direction of the blade holder 24, precluding the actuator 512 from releasing the blade 26 from the blade holder 24 and thus practically locking the blade 26 into place. When a user applies a lateral force on the catch 524, the lamella 532 may deform, such that there is no overlap between a lateral position of the stopper 534 and the body 132 of the blade holder 24, and the lock does not hinder movement of the actuator 512 in the longitudinal direction of the blade holder 24, allowing the blade 26 to be released from the blade holder 24. As such, the lock 522 may be in an unlocked position when the flexible lamella is subject to a lateral force, and in order to attach and/or detach the blade 26 to and from the blade holder 24, a combination of forces in the lateral direction of the blade holder 24 and in the longitudinal direction of the blade holder 24 may be required.

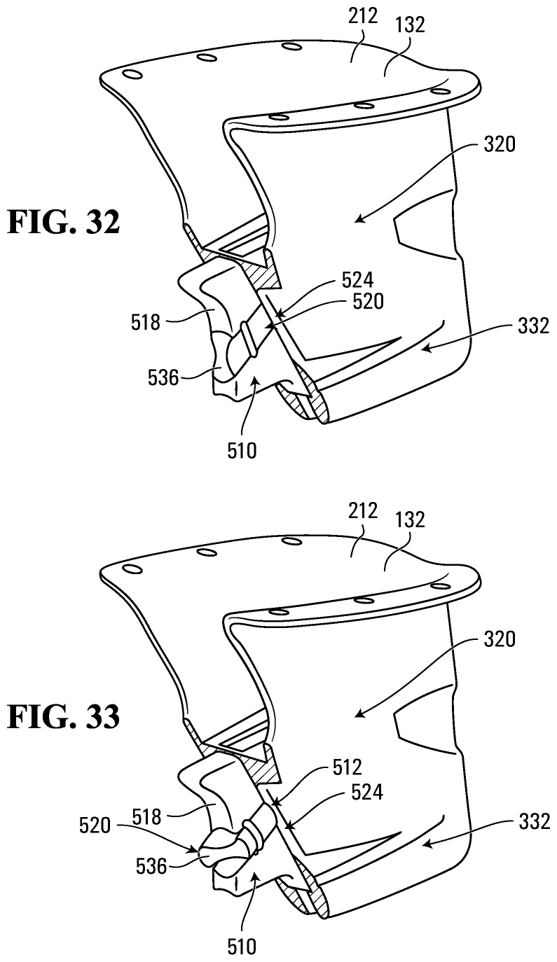

As another example, as shown in FIGS. 32 and 33, the lock 522 may be carried on the actuator 512 and may comprise the catch 524 that is rotatable relative to the trigger 518. In this embodiment, the catch 524 comprises a rod 536 constituting a swivel stopper. The swivel stopper 536 may be rectangular or oblong and may be manually rotatable relative to the trigger 518 about an axis extending at least partly in the longitudinal direction of the blade holder 24. When the swivel stopper 536 is rotated in a locked position, the swivel stopper 536 may engage a surface of the body 132 of the blade holder 24 and the lock 522 may hinder movement of the actuator 512 in the longitudinal direction of the blade holder 24, precluding the actuator 512 from releasing the blade 26 from the blade holder 24 and thus practically locking the blade 26 into place. When the swivel stopper 536 is rotated in the unlocked position, the swivel stopper 536 may not engage the body 132 of the blade holder 24 and the actuator 512 may be free to move relative to the body 132 of the blade holder 24, thus allowing attachment and/or removal of the blade 26 to and from the body 132 of the blade holder 24.

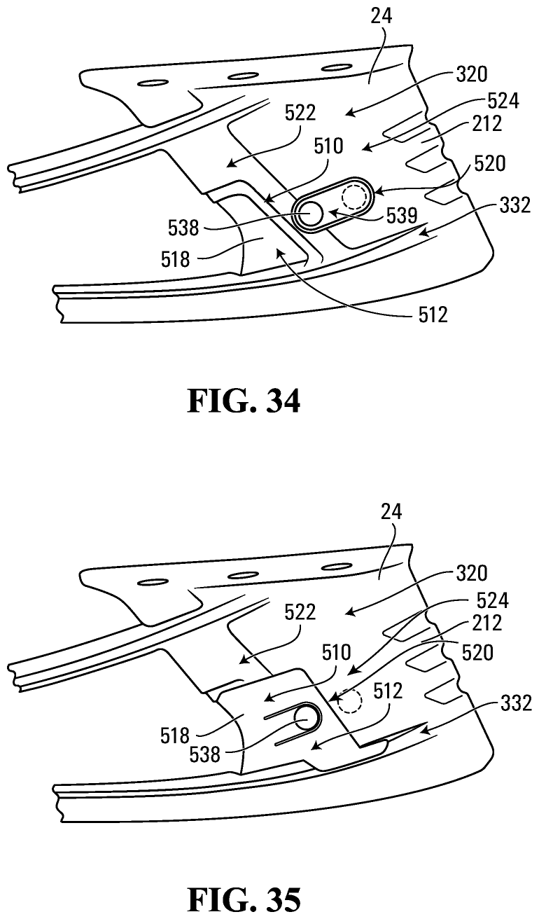

As another example, as shown in FIGS. 34 and 35, the lock 522 may be carried on the actuator 512 and may comprise the catch 524 comprising a pushbutton 538. The body 132 of the blade holder 24 may comprise an opening 539 having a shape which fits with the pushbutton 538 when the actuator 512 is at rest. As such, at rest, the pushbutton 538 may engage the body 132 of the blade holder 24 at the opening 539, locking the actuator 512 into place. To move the lock 522 in the unlocked position, the user may push the pushbutton 538 and resiliently deform pushbutton 538 so that pushbutton 538 does not engage the body 132 of the blade holder 24 at the opening 239. The actuator 512 and the lock 522 may then me translatable relative to the body 132 of the blade holder, allowing attachment and/or removal of the blade 26 to and from the body 132 of the blade holder 24, and when the actuator 512 is put to rest, the pushbutton 538 may snap in to engage the body 132 of the blade holder 24 at the opening 539, locking the actuator 512 into place.

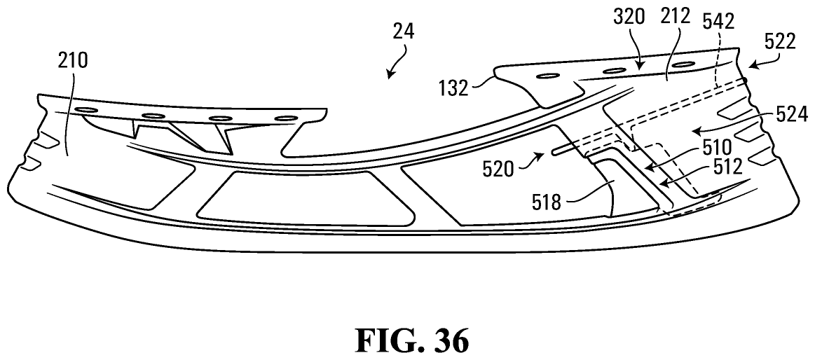

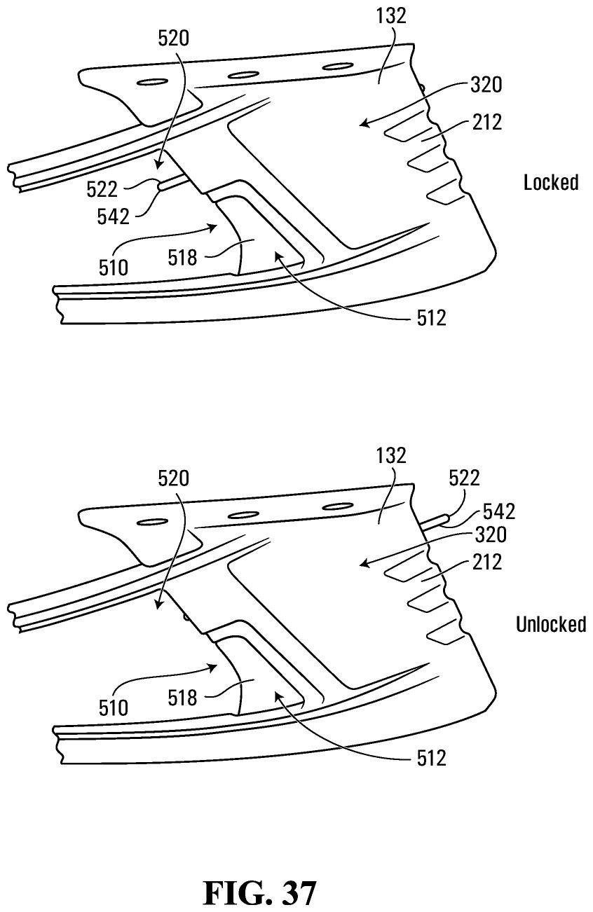

As another example, as shown in FIGS. 36 and 37, the lock 522 may be carried on the actuator 512 and may comprise the catch 524 and a rod 542 that is translatable relative to the trigger 518 in the longitudinal direction of the blade holder 24. The rod 542 of the lock 522 may protrude on either side of the rear pillar 212 of the blade holder, indicating whether the lock 522 is in the locked position or in the unlocked position, and may be manually operable by simply pushing on a protruding end of the rod 542 to change the position of the lock 122. The catch 524 may be any suitable catch and may be, for instance, a ball catch. The rod 542 may comprise a projection or a protrusion 544 engaging the actuator 512 and hindering it from moving relative to the body 132 of the blade holder 132 when the lock 522 is in the locked position. When the lock 522 is in the unlocked position, the rod 542 may free the actuator 512, allowing it to move relative to the body 132 of the blade holder 24, thus allowing attachment and/or removal of the blade 26 to and from the body 132 of the blade holder 24.

In other embodiments, the blade holder 24 may be configured to protect against accidental release of the blade 26 from the blade holder 24 (e.g., prevent the blade 26 form being accidentally released from the blade holder 24) when the blade-retaining base 164 is impacted (e.g., by a flying puck, by a board of the ice, by a goal post, by a skate of another player, etc.) in various other ways.

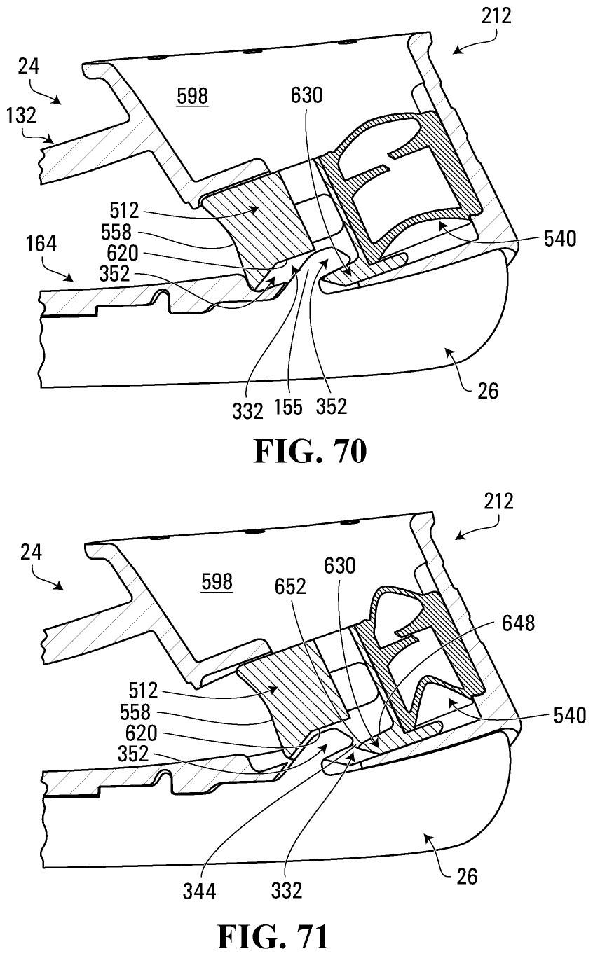

For example, in some embodiments, with additional reference to FIGS. 70 to 72, the connector 332 of the blade holder 24 may implement a self-locking function to keep the blade 26 in the blade holder 24 when the blade-retaining base 164 is impacted. Thus, in these embodiments, the blade holder 24 is free of (i.e., does not have) any lock, such as the lock 522 discussed above, manually movable between locked and unlocked positions.

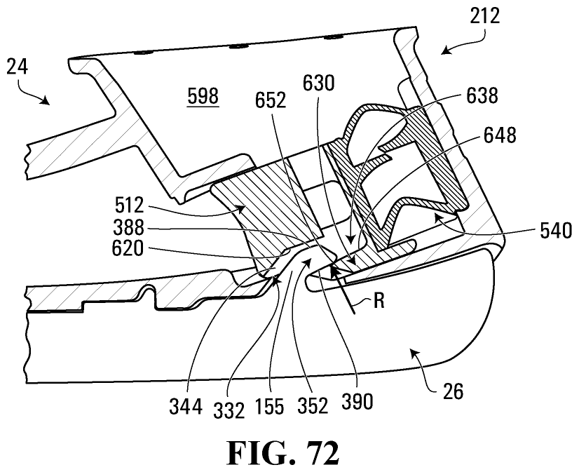

In this example: FIG. 70 shows a situation in which the blade 26 is connected to the blade holder 24 and in use (e.g., during skating) so that the blade 26 is secured to the blade holder 24 and there is no impact on the blade-retaining base 164; FIG. 71 shows a situation in which the blade 26 is to be removed from the blade holder 24 by manually actuating the actuator 512, in this case by pushing on the finger-actuating surface 558 of the actuator 512 to move the connector 332 of the blade holder 24 rearwardly and resiliently compress the biasing element 540 in order to release the rear hook 155 from the void 344 of the blade holder 24; and FIG. 72 shows a situation in which the blade-retaining base 164 is impacted (e.g., at a rear end of the blade-retaining base 164), thereby causing the connector 332 of the blade holder 24 to move relative to the blade 26 (and relative to the body 132 of the blade holder 24) due to inertia (e.g., by initially moving rearwardly and resiliently compressing the biasing element 540 and then moving forwardly as the biasing element 540 expands back).

In this embodiment, the connector 332 of the blade holder 24 is configured to avoid pushing on the connector 352 of the blade 26 in a way tending to release the blade 26 from the blade holder 24 while the connector 332 of the blade holder 24 moves relative to the blade 26 (and relative to the body 132 of the blade holder 24) when the blade-retaining base 164 is impacted (i.e., due to inertia). For instance, in this embodiment, the connector 332 of the blade holder 24 is configured to avoid pushing downward on the connector 352 of the blade 26 while the connector 332 of the blade holder 24 moves relative to the blade 26 when the blade-retaining base 164 is impacted.

More particularly, in this embodiment, the connector 332 of the blade holder 24 comprises walls 620, 630 that face one another, define the void 344 therebetween to receive the connector 352 of the blade 26, and are configured to protect against accidental release of the blade 26 from the blade holder 24 when the blade-retaining base 164 is impacted. In this example, a given one of the walls 620, 630 of the connector 332 of the blade holder 24 remains spaced from (i.e., does not contact) the connector 352 of the blade 26 while the connector 332 of the blade holder 24 moves relative to the blade 26 when the blade-retaining base 164 is impacted. More specifically, in this example, the wall 620 is an internal wall of the connector 332 of the blade holder 24, the wall 630 is a bottom wall of the connector 332 of the blade holder 24, and the internal wall 620 of the connector 332 of the blade holder 24 remains spaced from (i.e., does not contact) the connector 352 of the blade 26 while the connector 332 of the blade holder 24 moves relative to the blade 26 when the blade-retaining base 164 is impacted. The internal wall 620 of the connector 332 of the blade holder 24 therefore avoids pushing on the connector 352 of the blade 26 while the connector 332 of the blade holder 24 moves relative to the blade 26 when the blade-retaining base 164 is impacted.

Also, in this embodiment, the connector 332 of the blade holder 24 is configured to block the connector 352 of the blade 26 while the connector 332 of the blade holder 24 moves relative to the blade 26 when the blade-retaining base 164 is impacted. In this example, the connector 332 of the blade holder 24 is configured to block the connector 352 of the blade 26 while the connector 332 of the blade holder 24 moves relative to the blade 26 toward the front end of the blade holder 24 when the blade-retaining base 164 is impacted. This creates an interference that can further help to avoid accidental release of the blade 26 from the blade holder 24 when the blade-retaining base 164 is impacted.

More specifically, in this embodiment, the connector 332 of the blade holder 24 is configured to start exerting a retaining force R on the connector 352 of the blade 26 tending to retain the blade 26 in the blade holder 24 while the connector 332 of the blade holder 24 moves relative to the blade 26 when the blade-retaining base 164 is impacted. In this case, the connector 332 of the blade holder 24 is configured to start exerting the retaining force R while the connector 332 of the blade holder 24 moves relative to the blade 26 toward the front end of the blade holder 24 when the blade-retaining base 164 is impacted.

In this example, the retaining force R is oriented upwardly, i.e., toward the upper portion 166 of the blade holder 24, such that the connector 332 of the blade holder 24 exerts the upward force R on the connector 352 of the blade 26. In this case, the connector 332 of the blade holder 24 is configured to contact an underside 645 of the connector 352 of the blade 26 while the connector 332 of the blade holder 24 moves relative to the blade 26 when the blade-retaining base 164 is impacted. The upward force R is thus exerted on the underside 645 of the connector 352 of the blade 26.

In this embodiment, the connector 352 of the blade 26 comprises an upper surface 388 and a lower surface 390, and the bottom wall 630 of the connector 332 of the blade holder 24 contacts the lower surface 390 of the connector 352 of the blade 26 while the connector 332 of the blade holder 24 moves relative to the blade 26 when the blade-retaining base 164 is impacted. More particularly, in this embodiment, the bottom wall 630 of the connector 332 of the blade holder 24 comprises an upper surface 638 configured to contact the lower surface 390 of the connector 352 of the blade 26 and including a first portion 648 configured to contact the lower surface 390 of the connector 352 of the blade 26 while the connector 332 of the blade holder 24 is fixed relative to the blade 26 and a second portion 652 configured to contact the lower surface 390 of the connector 352 of the blade 26 while the connector 332 of the blade holder 24 moves relative to the blade 26 when the blade-retaining base 164 is impacted. In this example, the second portion 652 of the upper surface 638 of the bottom wall 630 of the connector 332 of the blade holder 24 is transverse (e.g., slightly angled relative) to the first portion 648 of the bottom wall 630 of the connector 332 of the blade holder 24.

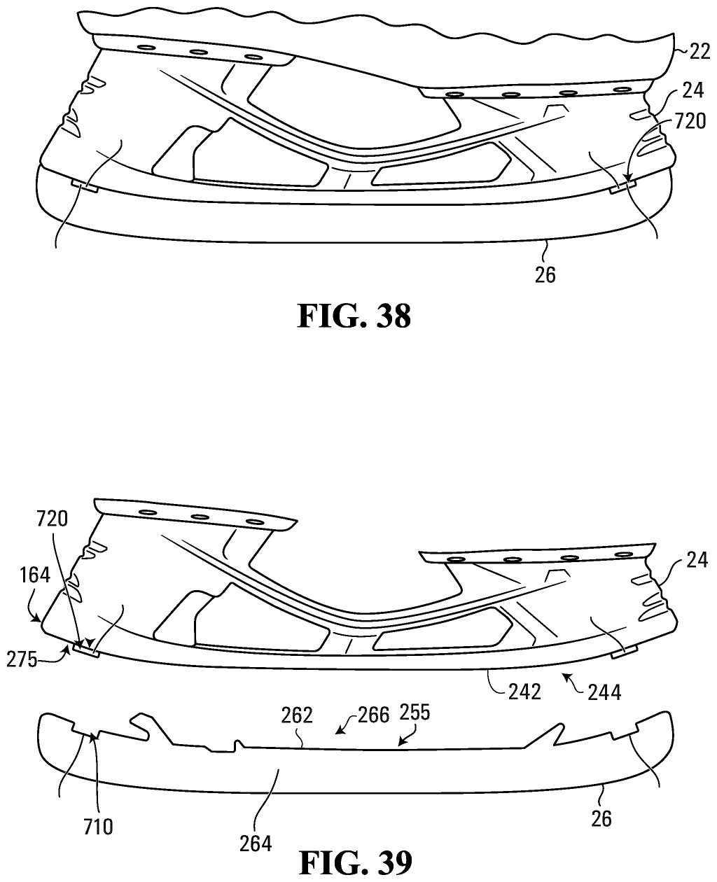

In some embodiments, as shown in FIGS. 38 and 39, the blade 26 comprises an interlocking part 710, the blade-retaining base 164 of the blade holder 24 comprises an interlocking part 720, and the interlocking part 710 of the blade 26 and the interlocking part 720 of the blade-retaining base 164 of the blade holder 24 are configured to interlock when the blade holder 24 holds the blade 26. The interlocking part 710 of the blade 26 and the interlocking part 720 of the blade-retaining base 164 of the blade holder 24 are configured to interlock by comprising interlocking elements (i.e., complementary, or male/female, formations) that include one or more voids (i.e., recesses, openings, and/or other hollow portions) and one or more projections (e.g., protrusions, pegs, and/or other projecting portions) extending into the one or more voids. This may help to enhance retention of the blade 26 in the blade holder 24 (e.g., when the blade holder 24 is impacted by a puck, stick, etc. during play).

Also, in some embodiments, the interlocking part 710 of the blade 26 and/or the interlocking part 720 of the blade holder 24 may be at least partly visible when the blade holder 24 holds the blade 26 (e.g., and is viewed in the lateral direction of the blade holder 24, i.e., in a side view of the blade holder 24 holding the blade 26, and/or in the longitudinal direction of the blade holder 24, i.e., in an end view (a front end view or rear end view) of the blade holder 24 holding the blade 26). That is, at least a portion of the interlocking part 710 of the blade 26 and/or at least a portion of the interlocking part 720 of the blade holder 24 (i.e., at least part of their interlocking elements) may be visible when the blade holder 24 holds the blade 26 (e.g., and is viewed in the lateral direction of the blade holder 24, i.e., in a side view of the blade holder 24 holding the blade 26, and/or in the longitudinal direction of the blade holder 24, i.e., in an end view (a front end view or rear end view) of the blade holder 24 holding the blade 26). Thus, in these embodiments, one or more interlocking elements of the blade 26 and/or the blade holder 24 may be at least partly visible when the blade holder 24 holds the blade 26, i.e., they may be one or more visible elements.

In this embodiment, the interlocking part 710 of the blade 26 is located in an upper region 255 of the blade 26, while the interlocking part 720 of the blade-retaining base 164 of the blade holder 24 is located in a lower region 275 of the blade-retaining base 164 of the blade holder 24.

More particularly, in this embodiment, the interlocking part 710 of the blade 26 comprises interlocking elements 380 that extend from at least one of the top surface 262 of the blade 26 and one or more of the side surfaces 264, 266 of the blade 26, while the interlocking part 720 of the blade-retaining base 164 of the blade holder 24 comprises interlocking elements 382 that extend from at least one of the bottom surface 242 of the blade holder 24 and the internal surfaces 242 defining the blade-receiving slot 190.

In this embodiment, the interlocking elements 382 of the blade holder 24 are configured to align with corresponding ones of the interlocking elements 380 of the blade 26 in the longitudinal direction of the blade holder 24, and the interlocking elements 380 of the blade 26 and the interlocking elements 382 of the blade holder 24 are at least partly visible when the blade holder 24 holds the blade 26 and is viewed in the lateral direction of the blade holder 24.

More specifically, in this embodiment, the interlocking elements 380 of the blade 26 are recesses, and the interlocking elements 382 of the blade-retaining base 164 of the blade holder 24 are projections configured to fit into corresponding ones of the recesses 380 of the blade 26. In this example, the recesses 380 of the blade 26 extend downwardly from the top surface 262 of the blade 26, while the projections 382 of the blade-receiving base 164 of the blade holder 24 project downwardly from the bottom surface 242 of the blade holder 24.

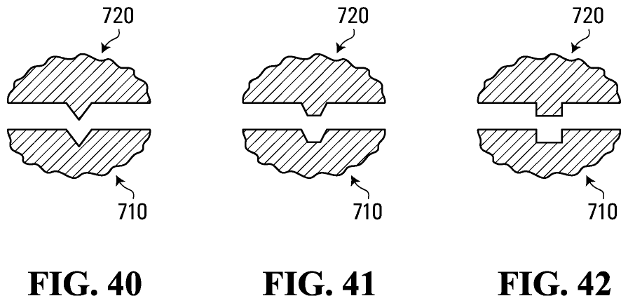

The recesses 380 of the blade 26 and/or the projections 382 of the blade holder 24 may have any suitable shape. For instance, in this embodiment, the recesses 380 of the blade 26 and the projections 382 of the blade holder 24 are generally rectangular. In other embodiments, as shown in FIGS. 40 to 42, the recesses 380 of the blade 26 and/or the projections 382 of the blade holder 24 may have a triangular shape, a trapezoidal shape, a square shape, or any other suitable polygonal or nonpolygonal (e.g., curved) shape. Also, in some embodiments, respective ones of the recesses 380 of the blade 26 may differ in shape, respective ones of the projections 382 of the blade holder 24 may differ in shape, and/or a given one of the recesses 380 of the blade 26 and a given one of the projections 382 of the blade holder 24 that extends into the given one of the recesses 380 of the blade 26 may have different shapes.

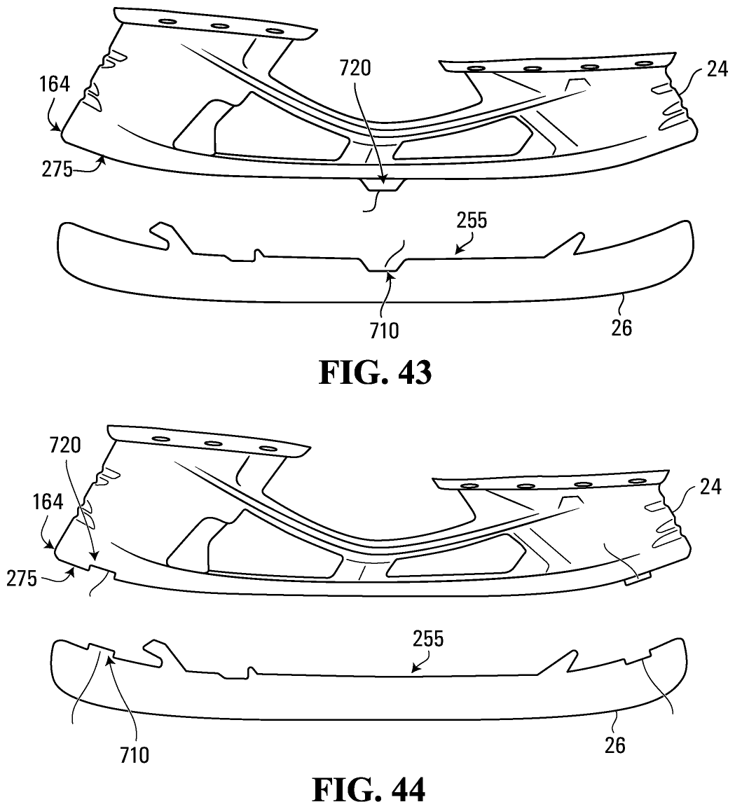

Furthermore, the interlocking parts 710, 720 of the blade 26 and the blade holder 24 may have any suitable number of interlocking elements 380, 382 and may be located at any suitable location on the blade holder 24 and the blade 26. For instance, in some embodiments, as shown in FIG. 43, the interlocking parts 710, 720 of the blade 26 and the blade holder 24 may have a single pair of interlocking elements 380, 382 disposed at or near a longitudinal center of the blade holder 24 and the blade 26.

In some embodiments, some of the interlocking elements 382 of the blade holder 24 may be recesses and some the interlocking elements 380 of the blade 26 may be projections projecting upwardly from the top surface 262 of the blade 26 and configured to fit into respecting ones of these recesses of the blade holder 24. For instance, in some embodiments, as shown in FIG. 44, the interlocking elements 380 of the blade 26 and the interlocking elements 382 of the blade holder 24 include recesses and projections.

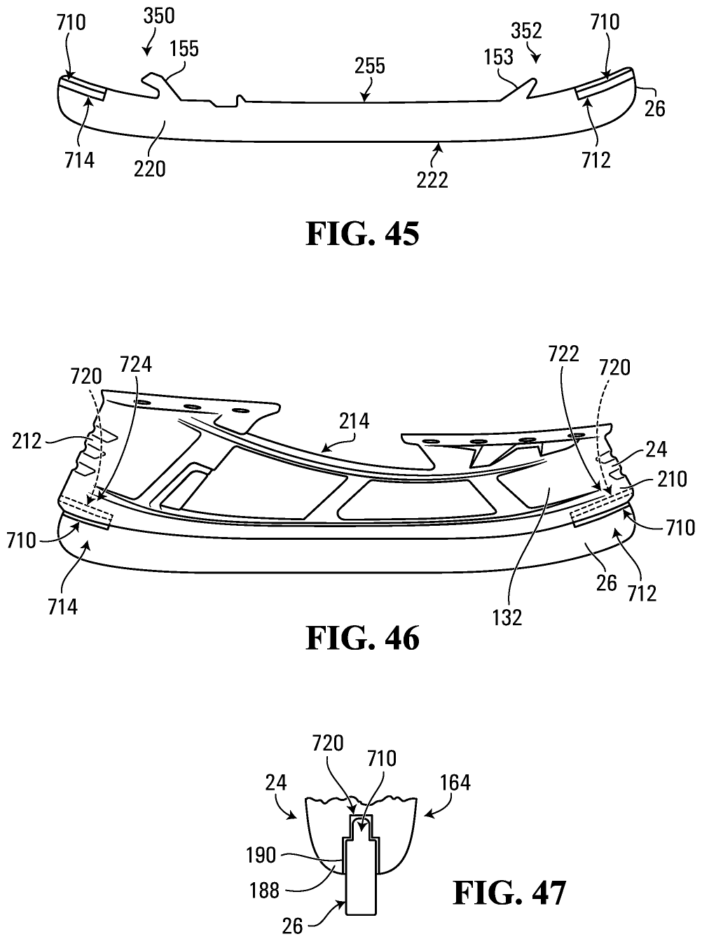

In other embodiments, such as shown in FIGS. 45 to 47, the interlocking part 720 of the blade holder 24 may be configured to align with the interlocking part 710 of the blade 26 in the lateral direction of the blade holder 24, and the interlocking part 710 of the blade 26 and the interlocking part 720 of the blade holder 24 may be visible when the blade holder 24 holds the blade 26 and is viewed in the longitudinal direction of the blade holder 24.

More particularly, in this embodiment, the interlocking part 710 of the blade 26 is disposed in at least one of a front end portion 712 and a rear end portion 714 of the blade 26, the interlocking part 720 of the blade holder 24 is disposed in at least one of a front end portion 722 and a rear end portion 724 of the blade holder 24, and the interlocking part 710 of the blade 26 and the interlocking part 720 of the blade holder 24 are visible when the blade holder 24 holds the blade 26 and is viewed in the longitudinal direction of the blade holder 24, so that the interlocking part 710 of the blade 26 and the interlocking part 720 of the blade holder 24 are visible at the front end and/or the rear end of the blade holder 24.

For example, in this embodiment, the interlocking part 710 of the blade 26 may include a reduction in thickness (e.g., tapering) upwardly of the upper region 255 of the blade 26 in at least one of the front end portion 712 and the rear end portion 714 of the blade 26, while the interlocking part 720 of the blade holder 24 may include a reduction in width (e.g., tapering) upwardly of the blade-receiving slot 190 of the blade holder 24 in at least one of the front end portion 722 and the rear end portion 724 of the blade holder 24.

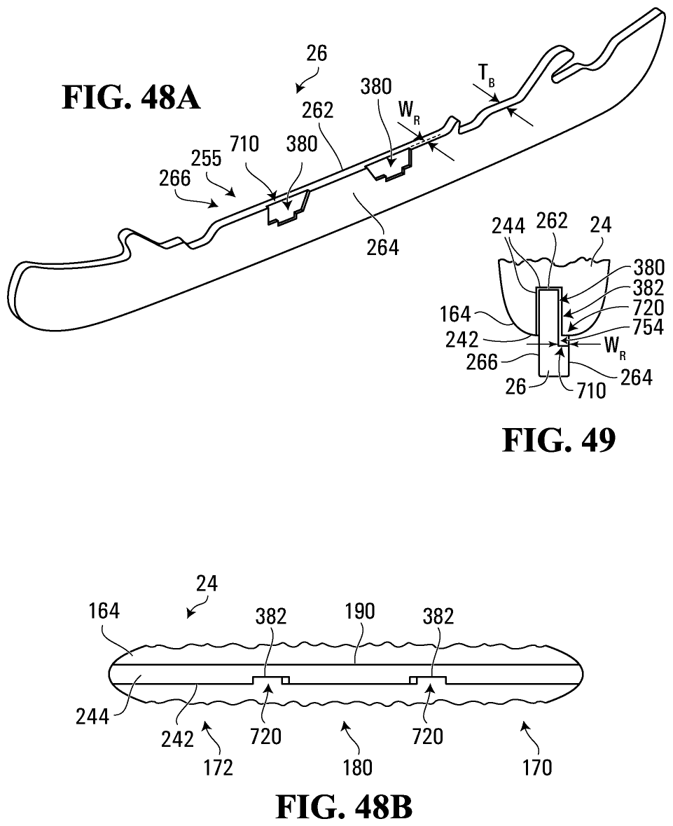

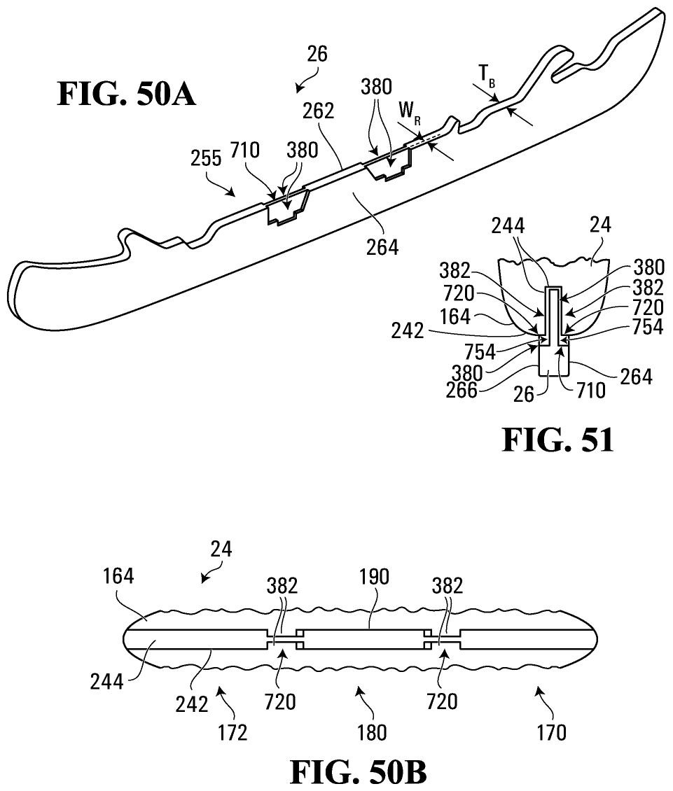

In some embodiments, as shown in FIGS. 48A to 51, the recesses 380 of the blade 26 extend laterally from one or both of the side surfaces 264, 266 of the blade 26, while the projections 382 of the blade-receiving base 164 of the blade holder 24 project laterally from the internal surfaces 244 defining the blade-receiving slot 190. The projections 382 of the blade holder 24 are configured to extend into corresponding ones of the recesses 380 of the blade 26.

More particularly, in this embodiment, each of the recesses 380 of the blade 26 extends downwardly from the top surface 262 of the blade 26 and laterally from one of the side surfaces 264, 266 of the blade 26 without reaching an opposite one of the side surfaces 264, 266 of the blade 26, i.e., can be viewed as a “blind” hole. A width W_{R} of each of the recesses 380 of the blade 26 in the thickness-wise direction of the blade 26 is therefore less than a thickness T_{B} of the blade 26. For example, in some embodiments, the width W_{R} of each of the recesses 380 of the blade 26 in the thickness-wise direction of the blade 26 may be less than half, in some cases less than one-third, in some cases less than one-quarter, and in some cases an even smaller proportion of the thickness T_{B} of the blade 26.

A length L_{R} of each of the recesses 380 of the blade 26 in the longitudinal direction of the blade 26 may have any suitable value. For example, in some embodiments, the length L_{R} of each of the recesses 380 of the blade 26 may correspond to at least one-tenth, in some cases at least one-quarter, in some cases at least one-third, and in some cases at least a majority of a length of the blade 26. Similarly, a length L_{P} of each of the projections 382 of the blade-receiving base 164 of the blade holder 24 in the longitudinal direction of the blade holder 24 may have any suitable value. For instance, in some embodiments, the length L_{P} of each of the projections 382 of the blade-receiving base 164 of the blade holder 24 may correspond to at least one-tenth, in some cases at least one-quarter, in some cases at least one-third, and in some cases at least a majority of the length of the blade holder 24.

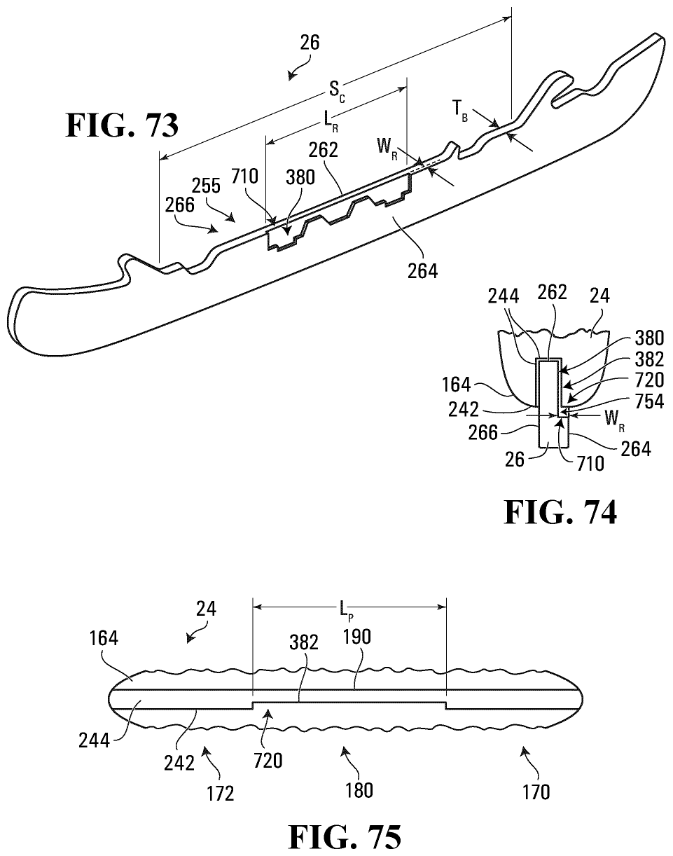

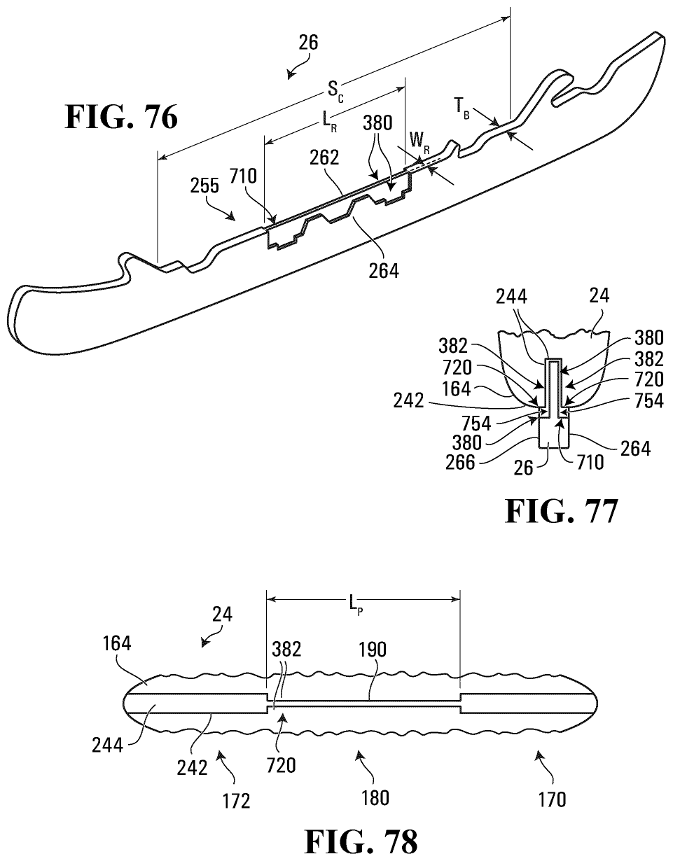

For example, in some embodiments, as shown in FIGS. 73 to 78, each of the recesses 380 of the blade 26 may occupy a substantial part of the length of the blade 26. For instance, in some embodiments, each of the recesses 380 of the blade 26 may occupy at least one-quarter, in some cases at least one-third, in some cases at least a majority, and in some cases a totality of a spacing S_{C} of the connectors 350, 352 of the blade 26 (e.g., which in this embodiment respectively comprise the hooks 153, 155) in the longitudinal direction of the blade 26. Thus, in some embodiments, the length L_{R} of each of the recesses 380 of the blade 26 may correspond to at least one-quarter, in some cases at least one-third, in some cases at least the majority, and in some cases the totality of the spacing S_{C} of the connectors 350, 352 of the blade 26 in the longitudinal direction of the blade 26. This may help to reduce weight of the blade 26 and/or facilitate bending of the blade 26 laterally when the user turns on the ice 12 to providing a circular, parabolic or other curved feature to the blade 26 that enhances turns of the user.

In this example, the recesses 380 of the blade 26 are at least partly visible when the blade holder 24 holds the blade 26 and is viewed in the lateral direction of the blade holder 24. More specifically, in this embodiment, the recesses 380 of the blade 26 extend lower than the blade holder 24 when the blade holder 24 holds the blade 26, so that lower portions 754 of the recesses 380 of the blade 26 are visible when the blade holder 24 holds the blade 26. The lower portions 754 of the recesses 380 of the blade 26 are thus unoccupied by the projections 382 of the blade-receiving base 164 of the blade holder 24 when the blade holder 24 holds the blade 26. In some embodiments, this may help to reduce weight of the blade 26 and/or facilitate bending of the blade 26 laterally when the user turns on the ice 12 to providing a circular, parabolic or other curved feature to the blade 26 that enhances turns of the user.

In other examples, the recesses 380 of the blade 26 are not visible when the blade holder 24 holds the blade 26 and is viewed in the lateral direction of the blade holder 24. In such embodiments, the recesses 380 of the blade 26 do not extend lower than the blade holder 24 when the blade holder 24 holds the blade 26.

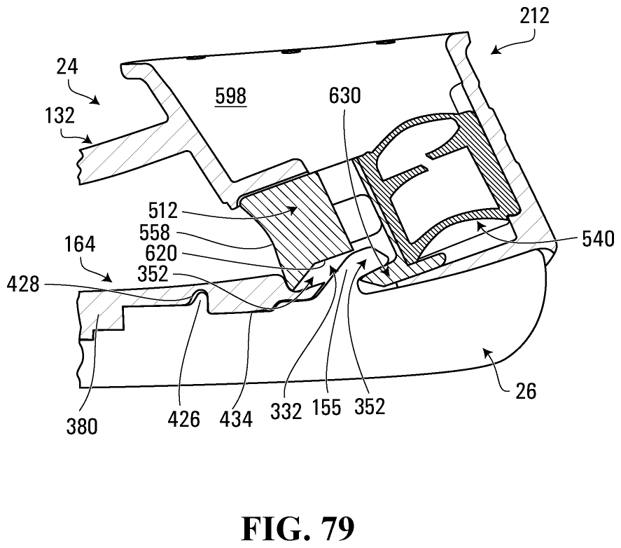

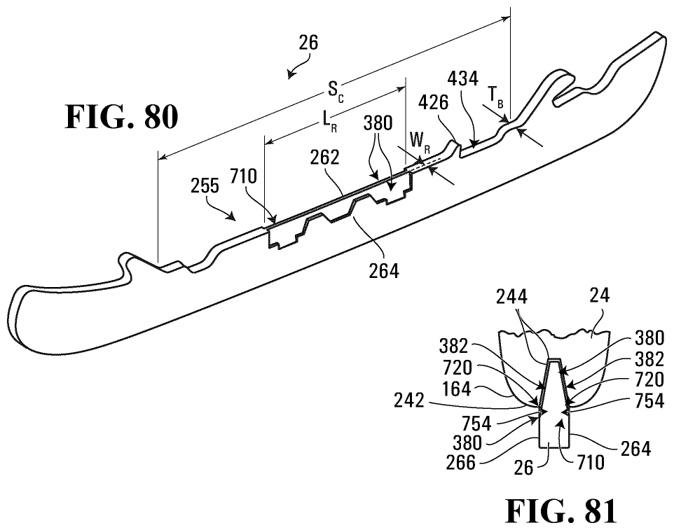

In some embodiments, as shown in FIGS. 79 to 81, the blade 26 may comprise a projection 426 projecting upwardly from the top surface 262 of the blade 26, located between and shorter than the front and rear hooks 153, 155, and configured to be received in a recess 428 extending upwardly in the blade-receiving slot 190 of the blade holder 24 to help retain the blade 26 in place within the blade-receiving slot 190. Also, in this embodiment, the projection 426, which can be referred to as “tooth”, is disposed between the rear hook 155 and the recesses 380 of the blade 26 that extend laterally from the side surfaces 264, 266 of the blade 26. More particularly, in this embodiment, the tooth 426 is disposed between the recesses 380 of the blade 26 that extend laterally from the side surfaces 264, 266 of the blade 26 and a recess 434 of the blade 26 that extends downwardly from the top surface 262 of the blade 26 and is configured to receive a portion 466 of the blade holder 24 when the blade 26 is held by the blade holder 24. In this example, the recess 434 of the blade 26 may extend for at least a majority of a spacing of the tooth 426 and the rear hook 155 in the longitudinal direction of the blade 26.

Also, in some embodiments, the recesses 380 of the blade 26 that extend laterally from the side surfaces 264, 266 of the blade 26 may vary in depth in the heightwise direction of the blade 26. For example, in this embodiment, the recesses 380 of the blade 26 that extend laterally from the side surfaces 264, 266 of the blade 26 may decrease in depth downwardly in the heightwise direction of the blade 26, so that the blade 26 tapers upwardly between them.

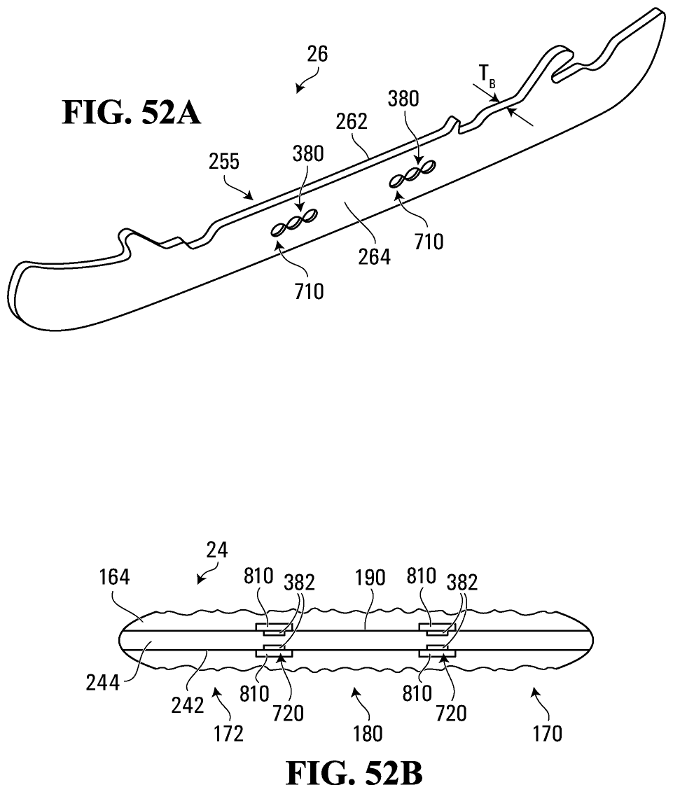

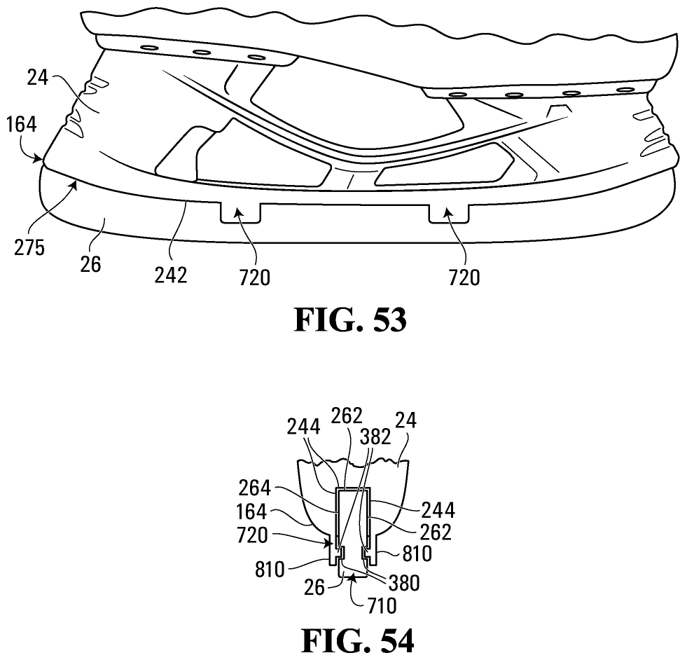

In some embodiments, as shown in FIGS. 52A to 54, a given one of the recesses 380 of the blade 26 may extend laterally from one of the side surfaces 264, 266 of the blade 26 and be spaced apart from the top surface 262 of the blade 26, while a given one of the projections 382 of the blade-receiving base 164 of the blade holder 24 may project laterally from a downward extension 810 of the blade holder 24 that extends downwardly from the bottom surface 242 of the blade holder 24. The given one of projections 382 of the blade holder 24 on the downward extension 810 of the blade holder 24 is configured to extend into the given one of the recesses 380 of the blade 26 as the downward extension 810 of the blade holder 24 overlaps the given one of the recesses 380 of the blade 26. The downward extension 810 of the blade holder 24 may be resiliently deflectable to allow insertion and removal of the blade 26 to and from the blade holder 24 such that the given one of projections 382 of the blade holder 24 on the downward extension 810 of the blade holder 24 may clip into the given one of the recesses 380 of the blade 26 as the blade 26 is inserted into the blade holder 24 and unclip from the given one of the recesses 380 of the blade 26 as the blade 26 is removed from the blade holder 24.

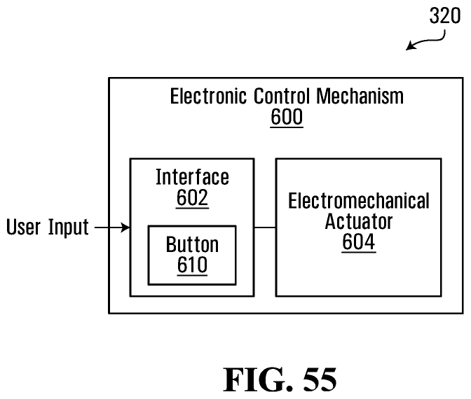

In some embodiments, as shown in FIG. 55, the manual controls 510, 520 of the connection system 320 of the blade holder 24 may include an electronic control mechanism 600. The electronic control mechanism 600 may comprise an interface 602 and an electromechanical actuator 604 coupled to the interface 602. The interface 602 may be manually and toollessly operable. For instance, in some embodiments, the interface 602 may comprise a button 610 that can be pressed upon to activate the actuator 604, e.g., to attach the blade 26 to the blade holder 24, to release the blade 26 from the blade holder 24, to lock the connection system 320, to unlock the connection system 320, etc.

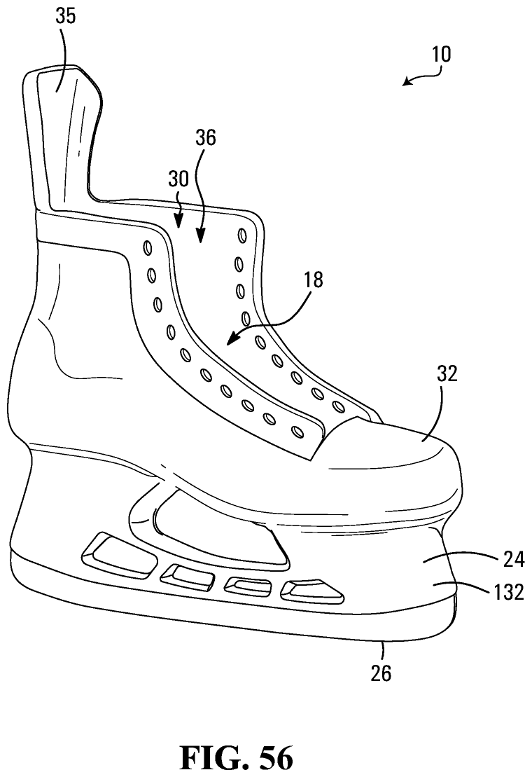

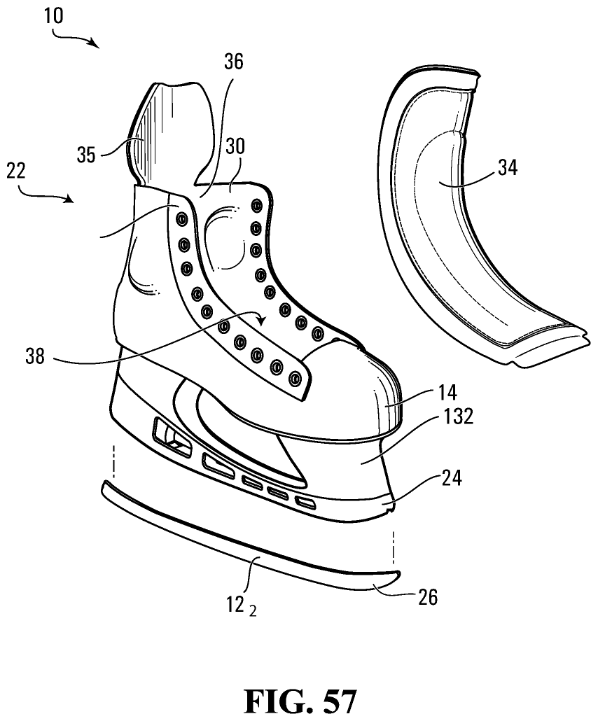

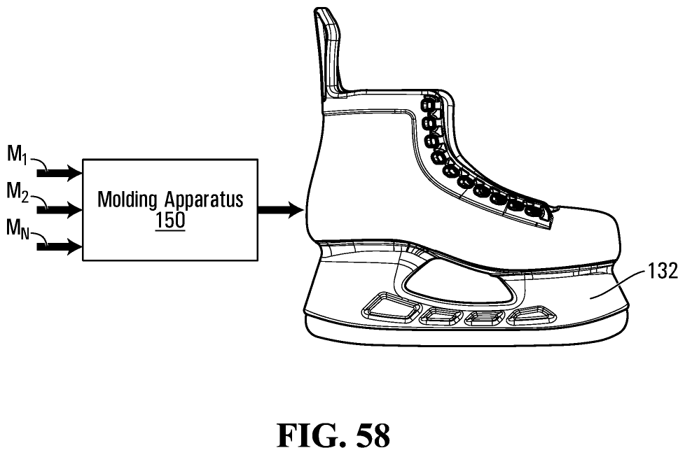

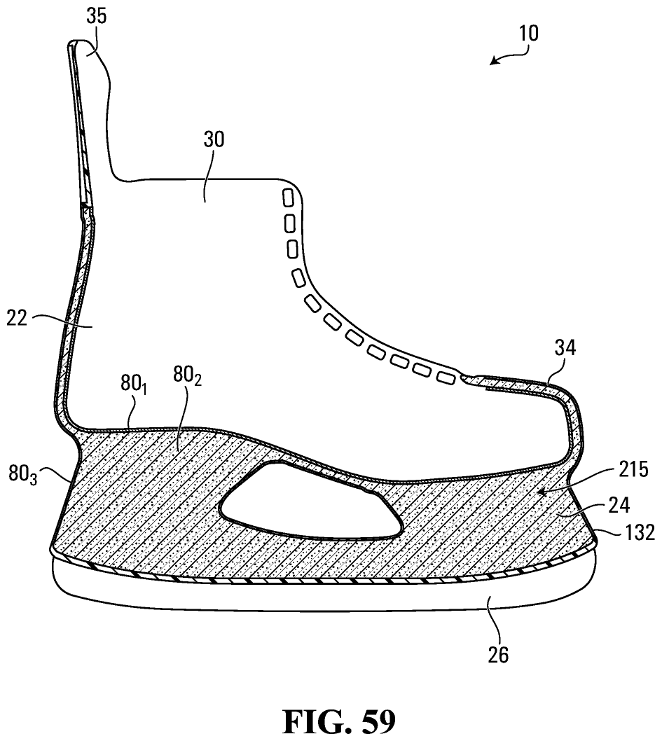

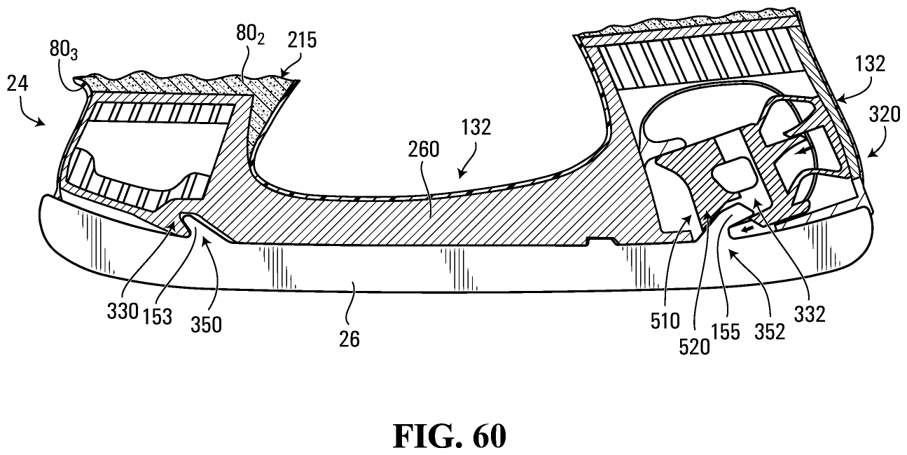

Although in the embodiments described above the skate boot 22 and the support 168 of the blade holder 24 may be fastened to one another, in some embodiments, as shown in FIGS. 56 to 60, at least part (i.e., part or all) of the body 132 of the blade holder 24 may be integrally formed with the shell 30 of the skate boot 22. That is, at least part of the body 132 of the blade holder 24 and the shell 30 of the skate boot 22 constitute a monolithic one-piece structure. The body 132 of the blade holder 24 thus comprises an integrally-formed portion 215 that is integrally formed with the shell 30 of the skate boot 22 such that the portion 215 of the body 132 of the blade holder 34 and the shell 30 of the skate boot 22 are formed together as one-piece in the molding apparatus 150 during the molding process.

In this embodiment, at least a majority (i.e., a majority or an entirety) of the body 132 of the blade holder 24 may be integrally formed with shell 30 of the skate boot 22. That is, the integrally-formed portion 215 of the body 132 of the blade holder 24 may be a major portion or the entirety of the body 132 of the blade holder 24. In this embodiment, an entirety of the body 132 of the blade holder 24 is integrally formed with the shell 30 of the skate boot 22.

For instance, in some embodiments, the body 132 of the blade holder 24 and the shell 30 of the skate boot may be formed simultaneously during an injection-molding process.

In this embodiment, the body 132 of the blade holder 24 comprises a core 260 which may be manufactured prior to the molding of the skate boot 22 and the integrally-formed portion 215 of the body 132 of the blade holder 24 and wuit6yjiuhich may be placed in the mold used during the molding process of the skate boot 22 and the integrally-formed portion 215 of the body 132 of the blade holder 24, such that the skate boot 22 and the integrally-formed portion 215 of the body 132 of the blade holder 24 are overmolded onto the core 260. This may, for instance, allow use of materials that could not be used during the molding process of the skate boot 22; reduce geometric tolerances and increase standardisation of the skate boot 22, increase stiffness of the blade holder 24, reduce energy losses during skating, etc.

In some embodiments, the blade holder 24 may comprise a 3D-printed component. For instance, in this embodiment, the core 260 may be a 3D-printed frame supporting the blade holder 24. In some cases, the 3D-printed frame 260 may comprise a lattice 340.

For example, in this embodiment, the lattice 340 is additively-manufactured such that the 3D-printed frame 260 may have an open structure. The lattice 340 can be designed and 3D-printed to impart properties and functions of the 3D-printed frame 260, such as those discussed above, while helping to minimize its weight.

The lattice 40 comprises a framework of structural members 341₁-341_{E} that intersect one another. In some embodiments, the structural members 341₁-341_{E} may be arranged in a regular arrangement repeating over the lattice 340. In some cases, the lattice 340 may be viewed as made up of unit cells 332₁-332_{C} each including a subset of the structural members 341₁-341_{E} that forms the regular arrangement repeating over the lattice 340. Each of these unit cells 332₁-332_{C} can be viewed as having a voxel, which refers to a notional three-dimensional space that it occupies. In other embodiments, the structural members 341₁-341_{E} may be arranged in different arrangements over the lattice 340 (e.g., which do not necessarily repeat over the lattice 340, do not necessarily define unit cells, etc.).

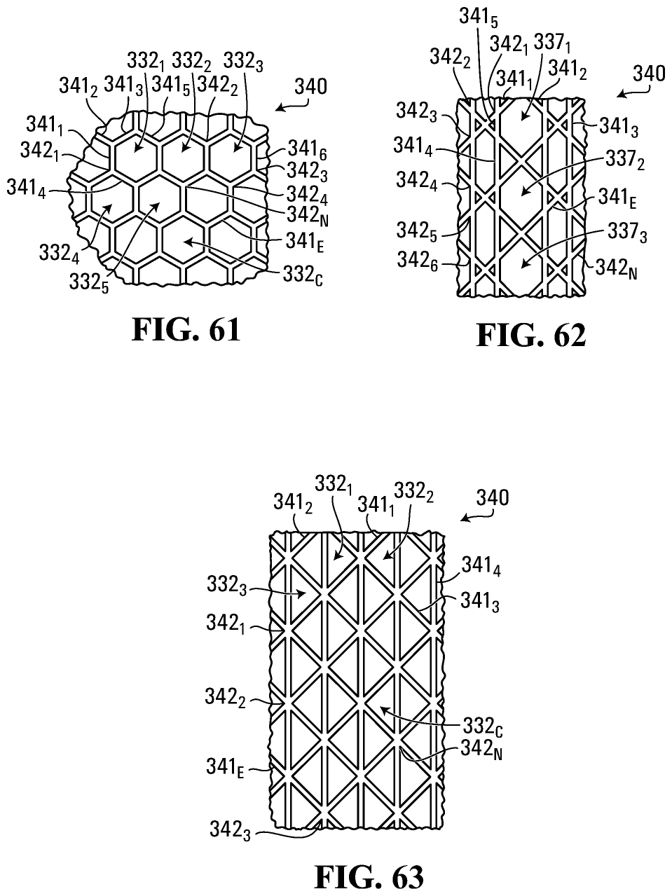

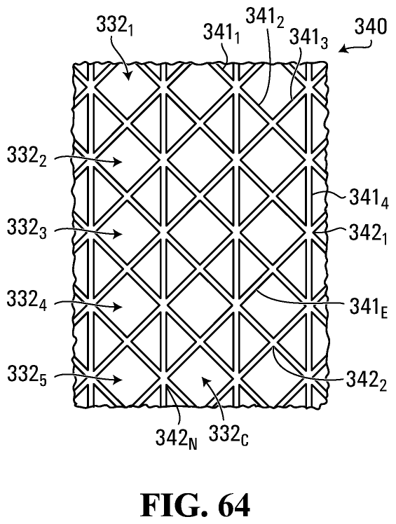

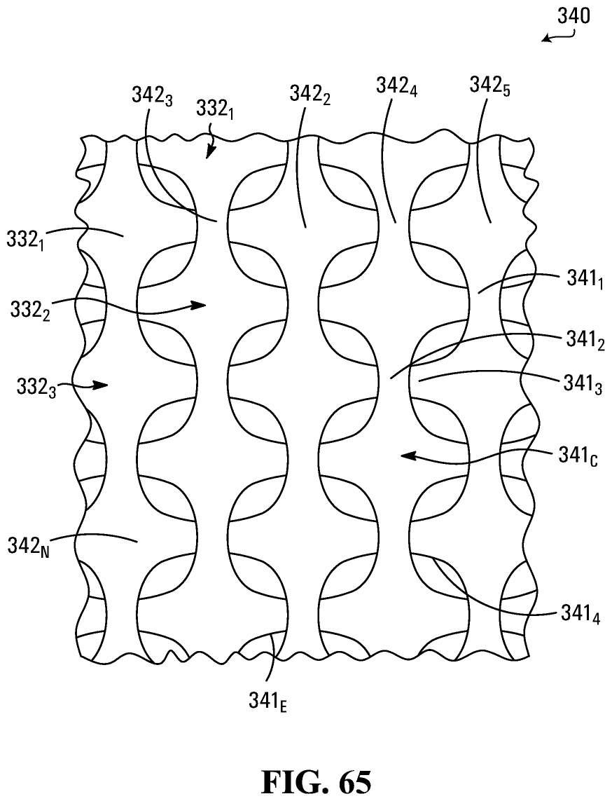

Examples of framework for the lattice 340 are shown in FIGS. 61 to 65. In some embodiments, the framework of the lattice 340 may define a hollow lattice having a lattice pattern that is observable in exploded view. In other embodiments, the framework of the lattice 340 may not be hollow or observable in exploded view. It is further noted that some lattices are not hollow or observable in exploded view while they have a lattice pattern that is similar to a lattice pattern of hollow lattices—in other words, in some embodiments, the lattice pattern of hollow lattices may be used to form a non-hollow lattice.

The lattice 340, including its structural members 341₁-341_{E}, may be configured in any suitable manner. For instance, in some embodiments, the shell 30 and/or other parts of the skate boot 22 and/or at least part of the blade holder 24 may be implemented as described in U.S. Provisional Patent Application 62/910,0012 filed on Oct. 3, 2019 and International Patent Application PCT/CA2020/050684 filed on May 21, 2020, which are incorporated by reference herein

In this embodiment, layers of material 802, 803 molded over the 3D-printed frame 260 may entirely cover the 3D-printed frame 260 such as to constitute a covering of the 3D-printed frame 260.

As another example, in some embodiments, one or more other components (e.g., the toe cap 32, the tendon guard 35, the lace members 44, the tongue 34, the footbed 38, etc.) of the skate boot 22 may be molded integrally with the shell 30 in the molding apparatus 150 during the molding process. The shell 30 and these one or more other components of the skate boot 22 may thus constitute a monolithic one-piece structure. For instance, in this embodiment, the toe cap 32, the tendon guard 35, and the lace members 44 are molded integrally with the shell 30 in the molding apparatus 150 during the molding process.

In other embodiments, the blade holder 24 may retain the blade 26 in any other suitable way. For example, in some embodiments, the blade 26 may be permanently affixed to the blade holder 24 (i.e., not intended to be detached and removed from the blade holder 24). For example, as shown in FIG. 69, the blade 26 and the blade-retaining base 164 of the blade holder 24 may be mechanically interlocked via an interlocking portion 234 of one of the blade-retaining base 164 and the blade 26 that extends into an interlocking void 236 of the other one of the blade-retaining base 164 and the blade 26. For instance, in some cases, the blade 26 can be positioned in a mold used for molding the blade holder 24 such that, during molding, the interlocking portion 234 of the blade-retaining base 164 flows into the interlocking void 236 of the blade 26 (i.e., the blade holder 24 is overmolded onto the blade 26). For example, in some embodiments, the blade 26 may be attached to the blade holder 24 during the molding process by including the blade 26 in a given mold 154; such that the blade holder 24 overmolds the blade 26 during the molding process. For instance, the mold 154ᵢ may be designed specifically to hold the blade 26 during the molding process prior to the forming of the intermediate subshell 852.

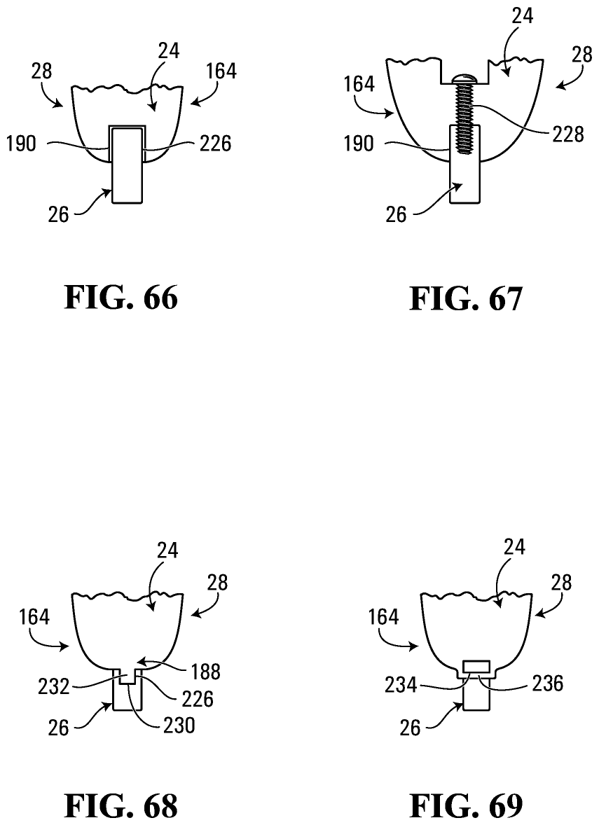

In some embodiments, as shown in FIGS. 66 to 68, the blade holder 24 may retain the blade 26 using an adhesive 226 and/or one or more fasteners 228. For instance, in some embodiments, as shown in FIG. 66, the recess 190 of the blade holder 24 may receive the upper portion of the blade 26 that is retained by the adhesive 226. The adhesive 226 may be an epoxy-based adhesive, a polyurethane-based adhesive, or any suitable adhesive. In some embodiments, instead of or in addition to using an adhesive, as shown in FIG. 67, the recess 190 of the blade holder 24 may receive the upper part of the blade 26 that is retained by the one or more fasteners 228. Each fastener 228 may be a rivet, a screw, a bolt, or any other suitable mechanical fastener. In some embodiments, the blade holder 24 may retain the blade 26 via a press fit. For example, as shown in FIG. 68, the recess 190 of the blade holder 24 may be configured (e.g., sized) such as to enter into a press fit with the blade 26. More particularly, in this example of implementation, the blade 26 comprises an elastomeric coating 237 including an elastomeric material (e.g., polyurethane, rubber, or any other suitable elastomeric material) that forms at least part of an outer surface of the blade 26. The elastomeric coating 237 has a greater friction coefficient than the ice-contacting material 220 of the blade 26 when interacting with the blade holder 24 such as to improve retention of the blade 26 by the blade holder 24 in a press fit. Alternatively or additionally, in some embodiments, as shown in FIG. 69, the blade-retention portion 188 of the blade holder 24 may extend into a recess 230 of the upper part of the blade 26 to retain the blade 26 using the adhesive 226 and/or the one or more fasteners 228. For instance, in some cases, the blade-retention portion 188 of the blade holder 24 may comprise a projection 232 extending into the recess 230 of the blade 26.

In some embodiments, a material of the skate 10, such as of the skate boot 22 (e.g., of the shell 30, the toe cap 32, etc.), of the blade holder 24 or the blade 26, may be a composite material. For example, the composite material may be a fiber-matrix composite material that comprises a matrix in which fibers are embedded. The matrix may include any suitable polymeric resin, such as a thermosetting polymeric material (e.g., polyester, vinyl ester, vinyl ether, polyurethane, epoxy, cyanate ester, etc.), a thermoplastic polymeric material (e.g., polyethylene, polyurethane, polypropylene, acrylic resin, polyether ether ketone, polyethylene terephthalate, polyvinyl chloride, polymethyl methacrylate, polycarbonate, acrylonitrile butadiene styrene, nylon, polyimide, polysulfone, polyamide-imide, self-reinforcing polyphenylene, etc.), or a hybrid thermosetting-thermoplastic polymeric material. The fibers may be made of any suitable material such as carbon fibers, polymeric fibers such as aramid fibers, boron fibers, glass fibers, ceramic fibers, etc.

Although in embodiments considered above the skate 10 is designed for playing ice hockey on the ice 12, in other embodiments, the skate 10 may be constructed using principles described herein for other skating activities (e.g., recreational skating, figure skating, etc.).

In some embodiments, any feature of any embodiment described herein may be used in combination with any feature of any other embodiment described herein.

Certain additional elements that may be needed for operation of certain embodiments have not been described or illustrated as they are assumed to be within the purview of those of ordinary skill in the art. Moreover, certain embodiments may be free of, may lack and/or may function without any element that is not specifically disclosed herein.

In describing embodiments, specific terminology has been resorted to for the sake of description but this is not intended to be limited to the specific terms so selected, and it is understood that each specific term comprises all equivalents.

In case of any discrepancy, inconsistency, or other difference between terms used herein and terms used in any document incorporated by reference herein, meanings of the terms used herein are to prevail and be used.

Although various embodiments have been illustrated, this was purposes of describing, but should not be limiting. Various modifications will become apparent to those ordinarily skilled.

1.-360. (canceled)

361. A blade for a skate for skating on ice, the skate comprising a skate boot configured to receive a foot of a user, the skate comprising a blade holder disposed below the skate boot and configured to hold the blade, the blade holder comprising a projection, the blade comprising:
an ice-contacting surface configured to engage the ice; and
a void configured to receive the projection of the blade holder.

362. The blade of claim 361, wherein the void of the blade extends from a side surface of the blade.

363. The blade of claim 362, wherein the void of the blade extends from a top surface of the blade.

364. The blade of claim 362, wherein the void of the blade is spaced apart from a top surface of the blade.

365. The blade of claim 361, wherein the void of the blade extends below a bottom surface of the blade holder when the blade holder holds the blade.

366. The blade of claim 361, wherein the void of the blade comprises a recess.

367. The blade of claim 361, wherein: the void of the blade is a first void of the blade; the projection of the blade holder is a first projection of the blade holder; the blade holder comprises a second projection spaced from the first projection of the blade holder; and the blade comprises a second void spaced from the first void of the blade and configured to receive the second projection of the blade holder.

368. The blade of claim 367, wherein the first void of the blade and the second void of the blade extend from at least one of side surfaces of the blade.

369. The blade of claim 368, wherein the first void of the blade and the second void of the blade extend from respective ones of the side surfaces of the blade.

370. The blade of claim 367, wherein the first void of the blade is a first recess of the blade and the second void of the blade is a second recess of the blade

371. The blade of claim 370, wherein the blade tapers upwardly between the first recess and the second recess.

372. The blade of claim 361, wherein the void varies in depth.

373. The blade of claim 361, wherein the void varies in depth in a heightwise direction of the blade.

374. The blade of claim 373, wherein the void decreases in depth downwardly in the heightwise direction of the blade.

375. The blade of claim 361, wherein the blade comprises a front connector and a rear connector spaced apart in a longitudinal direction of the blade holder and configured to engage respective connectors of a connection system of the blade holder to be attached to and detached from the blade holder.

376. The blade of claim 375, wherein the front connector and the rear connector of the blade are configured to be attached to and detached from the blade holder toollessly.

377. The blade of claim 375, wherein the front connector is a front hook and the rear connector is a rear hook; and the front hook and the rear hook project upwardly from a top surface of the blade.

378. The blade of claim 375, wherein the void is longitudinally between the front connector and the rear connector.

379. The blade of claim 375, wherein the blade comprises a projection projecting from a top surface of the blade in a heightwise direction of the blade and located between the front connector and the rear connector.

380. The blade of claim 379, wherein the void is located longitudinally between the front connector and the projection of the blade.

381. The blade of claim 379, wherein the projection of the blade is configured to help retain the blade in place within a blade-receiving slot of the blade holder.

382. The blade of claim 379, wherein the void is a first void, and the blade comprises a second void that extends downwardly from a top surface of the blade and is configured to receive a portion of the blade holder when the blade is held by the blade holder.

383. The blade of claim 382, wherein the second void extends for at least a majority of a spacing of the projection of the blade and the rear connector in the longitudinal direction of the blade.

384. The blade of claim 361, wherein the void of the blade is configured to interlock with the projection of the blade holder.

385. A skate comprising the blade of claim 361.

386. A blade for a skate for skating on ice, the skate comprising a skate boot configured to receive a foot of a user, the skate comprising a blade holder disposed below the skate boot and configured to hold the blade, the blade comprising:
an ice-contacting surface configured to engage the ice;
side surfaces opposite one another; and
a recess extending from a given one of the side surfaces of the blade.

387. The blade of claim 386, wherein the recess of the blade extends from a top surface of the blade.

388. The blade of claim 386, wherein the recess of the blade extends below a bottom surface of the blade holder when the blade holder holds the blade.

389. The blade of claim 386, wherein the blade holder comprises a projection and the recess of the blade is configured to receive the projection of the blade holder.

390. The blade of claim 389, wherein the recess of the blade is configured to interlock with the projection of the blade holder.

391. The blade of claim 386, wherein: the recess of the blade is a first recess of the blade; and the blade comprises a second recess spaced from the first recess of the blade.

392. The blade of claim 391, wherein: the blade holder comprises a first projection and a second projection spaced from the first projection; the first recess of the blade is configured to receive the first projection of the blade holder; and the second recess of the blade is configured to receive the second projection of the blade holder.

393. The blade of claim 391, wherein the second recess of the blade extends from another one of the side surfaces of the blade.

394. The blade of claim 391, wherein the second recess extends from the given one of the side surfaces of the blade.

395. The blade of claim 391, wherein the blade tapers upwardly between the first recess and the second recess.

396. The blade of claim 386, wherein the recess varies in depth.

397. The blade of claim 386, wherein the recess varies in depth in a heightwise direction of the blade.

398. The blade of claim 397, wherein the recess decreases in depth downwardly in the heightwise direction of the blade.

399. The blade of claim 386, wherein the blade comprises a front connector and a rear connector spaced apart in a longitudinal direction of the blade holder and configured to engage respective connectors of a connection system of the blade holder to be attached to and detached from the blade holder.

400. The blade of claim 399, wherein the front connector and the rear connector of the blade are configured to be attached to and detached from the blade holder toollessly.

401. The blade of claim 399, wherein the front connector is a front hook and the rear connector is a rear hook; and the front hook and the rear hook project upwardly from a top surface of the blade.

402. The blade of claim 399, wherein the recess is longitudinally between the front connector and the rear connector.

403. The blade of claim 399, wherein the blade comprises a projection projecting from a top surface of the blade in a heightwise direction of the blade and located between the front connector and the rear connector.

404. The blade of claim 403, wherein the recess is located longitudinally between the front connector and the projection of the blade.

405. The blade of claim 403, wherein the projection of the blade is configured to help retain the blade in place within a blade-receiving slot of the blade holder.

406. The blade of claim 403, wherein the blade comprises a void that extends downwardly from a top surface of the blade and is configured to receive a portion of the blade holder when the blade is held by the blade holder.

407. The blade of claim 406, wherein the void extends for at least a majority of a spacing of the projection of the blade and the rear connector in the longitudinal direction of the blade.

408. A skate comprising the blade of claim 386.

409. A method of attaching a blade for a skate for skating on ice to a blade holder of the skate, the skate comprising a skate boot configured to receive a foot of a user, the blade holder being disposed below the skate boot and configured to hold the blade, the blade holder comprising:
a blade-receiving slot extending in a longitudinal direction of the blade holder from a front portion of the blade holder to a rear portion of the blade holder and configured to face and retain the blade;
a first connector and a second connector spaced from one another in the longitudinal direction of the blade holder and configured to attach the blade to and detach the blade from the blade holder; and
a projection projecting laterally from one of internal surfaces defining the blade-receiving slot;
the blade comprising:
an ice-contacting surface configured to engage the ice;
side surfaces opposite one another;
a first hook and a rear hook spaced from one another in a longitudinal direction of the blade and configured to engage respectively the first connector and the second connector of the blade holder; and
a recess extending from one of the side surfaces of the blade, wherein the recess decreases in depth downwardly in a heightwise direction of the blade;
the method comprising:
positioning the first hook of the blade within the first connector of the blade holder;
pushing the second hook of the blade into the second connector of the blade holder and moving the recess of the blade toward the projection of the blade holder such that the projection of the blade holder extends into the recess of the blade; and
locking the blade in place.
